(19) United States
(12) Patent Application Publication
(10) Pub. No.: US 2004/0242770 A1
(43) Pub. Date: Dec. 2, 2004

(54) Covalent and non-covalent crosslinking of hydrophilic polymers and adhesive compositions prepared therewith

(76) Inventors: Mikhail M. Feldstein, Moscow (RU); Danir F. Bairamov, Moscow (RU); Nicolai A. Plate, Moscow (RU); Valery G. Kulchikhin, Moscow (RU); Parminder Singh, San Francisco, CA (US); Gary W. Cleary, Los Altos Hills, CA (US)

Correspondence Address: REED & EBERLE LLP, 800 MENLO AVENUE, SUITE 210, MENLO PARK, CA, 94025, US

(21) Appl. No.: 10/825,083

(22) Filed: Apr. 14, 2004

Related U.S. Application Data
(60) Provisional application No. 60/463,627, filed on Apr. 16, 2003.

(51) Int. Cl. C08G 63/91; C08F 22/38; C08F 20/70; C08F 120/54; C08F 20/56; C08F 126/06; C08F 2/00; C08F 226/06; C08F 120/56; C08F 120/70; C08F 26/00; C08F 26/06; C08G 63/48; C08F 20/54; C08F 216/12; C08F 236/00; C08F 222/38; C08F 226/02; C08F 8/00; C08F 220/54; C08F 16/12; C08F 118/02; C08F 220/70; C08F 116/12

(52) U.S. Cl. 525/54.3; 525/191; 526/258; 526/303.1; 526/319; 526/332

(57) ABSTRACT

A water-insoluble, hydrophilic adhesive polymer is provided, wherein the polymer is prepared by polymerization of a composition consisting of a hydrophilic monomer and a dual-function monomer that both (a) undergoes polymerization with the hydrophilic monomer and (b) provides crosslinks in the polymer product. Water-insoluble, hydrophilic adhesive polymer blends are also provided, which are free of covalent crosslinks. The polymers are useful in hydrogel and bioadhesive compositions, which find utility as drug delivery systems (e.g., topical, transdermal, transmucosal, iontophoretic), medical skin coverings, wound dressings and wound healing products, biomedical electrodes, and tooth whitening stripes.

### CROSS REFERENCE TO RELATED APPLICATIONS

This application claims priority under 35 U.S.C. § 119(e)(1) to U.S. Provisional Application Ser. No. 60/463,627 filed Apr. 16, 2003.

### TECHNICAL FIELD

This invention relates to hydrophilic adhesive polymers. More particularly, the invention relates to hydrogel and bioadhesive compositions containing one or more of the water-insoluble hydrophilic adhesive polymers, and methods of using these compositions in therapeutic applications such as drug delivery systems (e.g., topical, transdermal, transmucosal, iontophoretic), medical skin coverings, wound dressings and wound healing products, and biomedical electrodes, as well as in cosmeceutical applications such as tooth whitening products.

### BACKGROUND

Hydrophilic pressure-sensitive adhesives (PSAs) are used in a variety of pharmaceutical and cosmetic products, such as topical and transdermal drug delivery systems, wound dressings, face masks, bioadhesive films designed for buccal and mucosal administration, teeth whitening strips, and so on. A general distinctive feature of hydrophilic PSAs is that they typically adhere to wet biological substrates, while conventional hydrophobic (rubber-based) PSAs typically lose their adhesive properties when moistened.

The adhesive properties of PSAs will vary depending upon how and where the products are to be used. For transdermal drug delivery and topical applications, an adhesive patch, for instance, should provide high tack immediately upon use, and such tack should be maintained during the entire application period (from one day to one week). For buccal patches and teeth strips, it is often desirable to use elastic polymer films, which exhibit no adhesion towards dry surfaces, but are highly tacky when applied to hydrated, soft mucosal surfaces and/or moistened solid tissue surfaces such as teeth. For wound dressings and other various purposes, in order to avoid skin damage upon patch removal, either water-soluble adhesives or insoluble hydrogel adhesives, which lose their adhesion under swelling in a large amount of water, are preferred. Face masks and some tooth whitening products best utilize hydrophilic polymer compositions in the form of aqueous or ethanol-water solutions, which become dry after placement on a surface, thereby forming an insoluble, polymer film that adheres to the underlying tissue surface, but does not adhere to other surfaces.

Covalently crosslinked hydrogels can be prepared by a number of methods. Hydrogels can be synthesized in solution during the process of polymerizing hydrophilic monomers with appropriate crosslinkers. See, for example, U.S. Pat. No. 3,689,439 to Field et al.; U.S. Pat. No. 5,863,662 to Homby et al.; U.S. Pat. No. 4,873,299 to Nowakowsky et al.; U.S. Pat. No. 5,354,823 to Tseng et al.; U.S. Pat. No. 5,804,611 to Takoh et al.; U.S. Pat. No. 5,073,381 to Ivan et al.; and EP 371 421 to Sehm et al. When UV-radiation is used for covalent crosslinking, crosslinkers may not be required in order to produce hydrogels from relevant monomers. See U.S. Pat. No. 5,173,302 to Holmland et al.

Hydrogels can be prepared by the covalent crosslinking of hydrophilic polymers using suitable crosslinking agents (U.S. Pat. No. 3,721,657 to Seiderman), or in the absence of any crosslinkers. In the latter case, crosslinked hydrogels may be prepared by e-beam (U.S. Pat. No. 4,570,482 to Sieverding) or γ-irradiation of the hydrophilic polymers (U.S. Pat. Nos. 3,957,605 and 3,993,551 both to Assarson et al.). Moreover, a range of hydrophilic polymers (e.g., PVP) can be crosslinked in the course of their thermal annealing at high temperatures (Bairamov et al. (2001) Proceed. Intern. Symp. Control. Release Bioactive Mater. 28:5116).

Crosslinked hydrogels can also be synthesized by polymerizing hydrophilic monomers in the presence of a hydrophilic pre-polymer and suitable crosslinking agent. See U.S. Pat. No. 6,329,472 to Kim et al.

The majority of these methods, however, do not consider the adhesive properties of the crosslinked hydrogels. While the methods described in U.S. Pat. No. 4,750,482 to Sieverding, U.S. Pat. No. 5,173,302 to Holmland et al., and U.S. Pat. No. 5,073,381 to Ivan et al. pertain to adhesion, none of these references consider the conditions of the synthesis, which, as it has been determined herein, can be specifically selected and tailored to prepare particular adhesive hydrogels having specific adhesive properties of interest.

In order to effectively tailor the adhesive properties of polymer materials useful in pharmaceutical and cosmetic products, a design method has been developed based on molecular insight into mechanisms underlying the adhesive properties. As has been recently established, at a molecular level, the pressure-sensitive adhesion is due to coupling of two apparently incompatible types of molecular structures. This reveals that there is a fine balance between strong cohesive interaction energy and enhanced free volume. See, for example, Feldstein et al. (1999) Polym. Mater. Sci. Eng., 81:465-466; Feldstein et al., General approach to the molecular design of hydrophilic pressure-sensitive adhesives, Proceed. 25^{th} Annual Meeting Adhesion Soc. and 2^{nd} World Congress on Adhesion and Relative Phenomena, February 2002, Orlando, Fla., vol.1 (Oral Presentations), p. 292-294; and Chalykh et al. (2002) J. Adhesion 78(8):667-694.

The “free volume” property of the molecular structure of PSA polymers results in high tack at a macroscopic level and a liquid-like fluidity of the PSA material, which allows for a fast-forming adhesive bond. The “cohesive interaction energy” or “cohesion energy” property defines the cohesive toughness of the PSA polymer and provides the dissipation of detaching energy in the course of adhesive joint failure. Based on this finding, a general method for obtaining novel hydrophilic adhesives is described in U.S. Pat. No. 6,576,712 to Feldstein et al., which involves physically mixing non-adhesive, hydrophilic, high-molecular-weight polymers with appropriate short-chain plasticizers.

In various PSAs, different molecular structures provide proper amounts of cohesion energy and free volume, thereby defining the adhesive properties of the polymer materials. For instance, in acrylic PSAs, strong cohesive interaction energy is a result of mutual hydrophobic attraction of the alkyl radicals in side chains, whereas large free volume is due to either electrostatic repulsion of negatively charged carboxyl groups or a large volume of isoalkyl radicals in the side chains. In synthetic rubbers, a large free volume is obtained by adding high volume, low-density molecules of tackifying resins. In hydrophilic adhesives, when high molecular weight polyvinyl lactams (i.e. polyvinyl pyrrolidone (PVP) or polyvinyl caprolactame (PVCap)) are blended with the short-chain polyethylene glycol (PEG), as described in U.S. Pat. No. 6,576,712, high cohesive strength results from hydrogen bonding between, for example, PVP carbonyl groups and complementary terminal hydroxyls of PEG, while the large free volume is due to the location of reactive groups at both ends of the PEG chains.

A proper balance between high cohesion energy and large free volume, which is responsible for adhesive properties of polymer materials, is achieved by evaluating the various PSA properties. For instance, the ratio between cohesion energy and free volume defines the value of glass transition temperature, Tg, and elasticity modulus, E, of a polymer. Higher cohesion energy and lower free volume, results in higher values for both Tg and E. It is well recognized that all PSAs demonstrate a Tg in the range of about −55 to −30° C. and an E≈1-10⁵ Pa.

In U.S. Pat. No. 6,576,712, the hydrophilic polymers and plasticizer are capable of hydrogen bonding or electrostatic bonding to each other and are present in a ratio that optimizes key characteristics of the adhesive composition, such as adhesive strength, cohesive strength and hydrophilicity. The plasticizer has complementary reactive functional groups at both ends and when both terminal groups interact with complementary functional groups in the hydrophilic polymer, the plasticizer acts as a non-covalent crosslinker between the longer chains of hydrophilic polymer. In doing so, the plasticizer combines the plasticization effect with enhanced cohesive toughness of the PSA polymer blend. This molecular design method for tailoring new hydrophilic PSAs describes the adhesive capability of long-chain, high Tg hydrophilic polymers, as well as the ratio of hydrophilic polymer to plasticizer (cohesive enhancer), which provides the best adhesion.

When dry, the adhesives described in U.S. Pat. No. 6,576,712, e.g. the blends of high molecular weight PVP with oligomeric PEG ranging in molecular weight from 200 to 600 g/mol, provide rather low adhesion toward dry surfaces. Adhesion increases when the surface is moistened or the adhesive absorbs water. The maximum adhesion is observed when the adhesive contains 5-10% of absorbed water. This is usually the case when the adhesive is exposed to an atmosphere having 50% relative humidity. Additionally, under direct contact with water, the adhesive dissolves. However, these adhesives not contain covalent crosslinks, and are thus not suitable for applications that require swellable yet water-insoluble adhesives. In particular, these prior art adhesives are less useful when increased adhesion is desired upon much more appreciable hydration levels (e.g., 15% of absorbed water and higher).

Therefore, while the prior art discloses polymers and hydrogel compositions that can be tailored with respect to cohesive strength, adhesive strength, tack, elasticity, and water swellability, it remains desirable to develop a molecular design method for preparing novel hydrophilic PSAs that focuses on balancing cohesive interaction energy and free volume at a molecular level. The present invention addresses this need.

### SUMMARY OF THE INVENTION

One aspect of the invention relates to a water-insoluble, crosslinked hydrophilic adhesive polymer prepared by polymerization of a composition consisting essentially of a hydrophilic monomer and a dual-function monomer. The dual-function monomer undergoes polymerization with the hydrophilic monomer, as well as provides covalent crosslinks in the polymer.

Yet another aspect of the invention relates to a water-soluble, hydrophilic adhesive polymer that is free of covalent crosslinks, and is prepared by polymerization of a composition consisting essentially of a hydrophilic monomer and an acrylic acid monomer esterified with a hydrophilic side chain.

Still another aspect of the invention pertains to a water-insoluble adhesive polymer that is prepared by polymerization of a composition consisting essentially of: (a) a hydrophilic monomer, an acrylic acid monomer esterified with a hydrophilic side chain, and an acrylate monomer; (b) a hydrophilic monomer, an acrylic acid monomer esterified with a hydrophilic side chain, and a dual-function monomer; or (c) an acrylate monomer, an acrylic acid monomer esterified with a hydrophilic side chain, and a dual-function monomer.

Yet another aspect of the invention pertains to a water-insoluble, hydrophilic adhesive polymer blend that is free of covalent crosslinks, consisting essentially of at least one hydrophilic long-chain polymer and at least one amphiphilic crosslinker.

Still another aspect of the invention relates to a liquid film-forming composition of the invention comprising a water-insoluble film-forming polymer and one of the aforementioned polymer or polymer blends described above.

Yet another aspect of the invention relates to a water-insoluble hydrogel composition for topical or intraoral application comprising one of the aforementioned water-insoluble polymer or polymer blends described above, or comprising a water-insoluble film-forming polymer and the water-soluble polymer described above.

Still another aspect of the invention pertains to a water-insoluble, hydrophilic covalently crosslinked adhesive polymer blend prepared by polymerization of a hydrophilic acrylic monomer in the presence of a hydrophilic water-soluble high molecular weight polymer or copolymer, a dual function crosslinker or multi-function crosslinker, and an optional plasticizer.

Yet another aspect of the invention relates to a water-insoluble, hydrophilic covalently crosslinked adhesive polymer blend prepared by polymerization of a hydrophilic water-soluble high molecular weight polymer or copolymer, a dual function crosslinker or multi-function crosslinker, and an optional plasticizer.

### BRIEF DESCRIPTION OF THE DRAWINGS

FIG. 1 shows the swell ratio and adhesive durability as a function of UV-cured PEG-PVP hydrogels, which include dipentaerythritol pentaacrylate (SR-399) as a crosslinking promoter.

FIG. 2 shows the effect of free volume, evaluated in terms of swell ratio, on adhesive durability of UV-cured PVP-PEG hydrogels.

FIG. 3 shows the effect of crosslinking density on adhesive durability of cured PVP-PEG hydrogels.

FIG. 4 shows the swell ratio as a function of PEGDA content in VP-PEGDA copolymers.

FIG. 5 shows the glass transition as a function of PEGDA content in VP-PEGDA copolymers.

FIG. 6 shows the squeeze-recoil profiles of VP-PEGDA copolymers having different VP:PEGDA ratios under cyclic loading with a compressive force of 0.5, 1, 2 and 5 N.

FIG. 7 shows the effect of hydration of VP-PEGDA (15:100) crosslinked copolymer on squeeze-recoil kinetics under cyclic loading with a compressive force of 0.1, 0.2, 0.5 and 1 N, and on adhesive durability upon applying a standard detaching force of 0.37 N. The moment of detaching stress application is indicated at the arrow.

FIG. 8 shows the relationship between retardation times and the composition of dry VP-PEGDA copolymers.

FIG. 9 shows the relationship between retardation times and the glass transition temperature of crosslinked VP-PEGDA copolymers.

FIG. 10 shows the glass transition temperature as a function of PEGMMA content in VP-PEGMMA comb-like copolymers.

FIG. 11 shows the relationship between retardation times and the composition of comb-like VP-PEGMMA copolymers.

FIG. 12 shows the relationship between relaxation moduli and the composition of VP-PEGMMA copolymers.

FIG. 13 shows the relationship between Kelvin-Voigt retardation time and PEG content in PVP-PEG blends, VP-PEGDA and VP-PEGMMA copolymers.

FIG. 14 shows the relationship between the Kelvin-Voigt modulus and the PEG content in PVP-PEG blends, VP-PEGDA and VP-PEGMMA copolymers.

FIG. 15 shows a longer retardation time with respect to the PEG content in PVP-PEG blends, VP-PEGDA and VP-PEGMMA copolymers.

FIG. 16 shows the modulus, having a longer retardation time with respect to the PEG content in PVP-PEG blends, VP-PEGDA and VP-PEGMMA copolymers.

FIG. 17 shows a shorter retardation time with respect to the PEG content in PVP-PEG blends, VP-PEGDA and VP-PEGMMA copolymers.

FIG. 18 shows the modulus, having a shorter retardation time, with respect to the PEG content in PVP-PEG blends, VP-PEGDA and VP-PEGMMA copolymers.

FIG. 19 is a schematic representation of a carcass-like network complex between a long-chain hydrophilic polymer and a complementary amphiphilic crosslinking agent.

FIG. 20 illustrates the IR spectra of pure ibuprofen (a) and an ibuprofen-PVP blend (50:50, b) in the region of COOH groups vibration.

FIG. 21 represents DSC scans of ketoprofen and PVP/ketoprofen blends.

FIG. 22 represents DSC scans of ibuprofen and PVP/ibuprofen blends.

FIG. 23 demonstrates the adhesive properties of PVP-ibuprofen and PVP-ketoprofen films to a PET substrate.

FIG. 24 is a schematic representation of a carcass-like PVP-PEG network complex. The PVP-PEG complex combines high cohesive toughness (due to PVP-PEG H-bonding) with a large free volume (resulting from considerable length and flexibility of PEG chains). In order to emphasize enhanced free volume in the PVP-PEG blend, this type of complex structure is defined as a “carcass-like” structure. The carcass-like structure of the complex results from the location of reactive functional groups at both ends of PEG short chains.

FIG. 25 is a schematic representation of a ladder-like PVP complex with a complementary proton-donating polymer. When the complementary polymer contains reactive functional groups in repeating units of the backbone, the resulting complex has a so-called “ladder-like” structure. The ladder-like type of interpolymeric complexes were first described by Kabanov et al. (1979) Vysokomol. Soed. 21(A):243-281). While the formation of the carcass-like complex leads to enhanced cohesive strength and free volume (which determines the adhesive properties of PVP-PEG blends), the formation of a ladder-like complex is accompanied by the loss of blend solubility and the increase of cohesive strength coupled with the decrease in free volume. For this reason, the structure of the ladder-like complex provides no adhesion.

### DETAILED DESCRIPTION OF THE INVENTION

I. Definitions and Nomenclature

Before describing the present invention in detail, it is to be understood that unless otherwise indicated, this invention is not limited to specific polymerization methods, hydrogel compositions, manufacturing processes, or the like, as such may vary. It is also to be understood that the terminology used herein is for the purpose of describing particular embodiments only, and is not intended to be limiting. It must be noted that, as used in this specification and the appended claims, the singular forms “a,” “an,” and “the” include plural referents unless the context clearly dictates otherwise. Thus, for example, reference to “a hydrophilic polymer” includes a single hydrophilic homopolymer or copolymer, a combination thereof, and a mixture of two or more different hydrophilic polymers, reference to “a monomer” includes two or more monomers that may be the same or different, as well as a single monomer, and the like.

In describing and claiming the present invention, the following terminology will be used in accordance with the definitions set out below.

The definitions of “hydrophobic” and “hydrophilic” polymers are based on the amount of water vapor absorbed by polymers at 100% relative humidity (rh). According to this classification, hydrophobic polymers absorb only up to 1 wt % of water at 100% relative humidity, while moderately hydrophilic polymers absorb 1-10 wt % of water, hydrophilic polymers are capable of absorbing more than 10 wt % of water, and hygroscopic polymers absorb more than 20 wt % of water. A “water-swellable” polymer is one that absorbs an amount of water greater than at least 50 wt % of its own weight, upon immersion in an aqueous medium.

The term “crosslinked” herein refers to a composition containing intramolecular and/or intermolecular crosslinks, whether arising through covalent or non-covalent bonding. “Non-covalent” bonding includes both hydrogen bonding and electrostatic (ionic) bonding.

The term “polymer” includes homopolymers, linear and branched polymer structures, and also encompasses crosslinked polymers as well as copolymers (which may or may not be crosslinked), thus including block copolymers, alternating copolymers, random copolymers, and the like. Those compounds referred to herein as “oligomers” are polymers having a molecular weight below about 1000 Da, preferably below about 800 Da.

The term “hydrogel” is used in the conventional sense to refer to water-swellable polymeric matrices that can absorb a substantial amount of water to form elastic gels, where the “matrices” are three-dimensional networks of macromolecules held together by covalent or non-covalent crosslinks. Upon placement in an aqueous environment, dry hydrogels swell to the extent allowed by the degree of cross-linking.

The term “hydrogel composition” refers to a composition that either contains a hydrogel or is entirely composed of a hydrogel. As such, “hydrogel compositions” encompass not only hydrogels per se but also compositions that comprise a hydrogel and one or more non-hydrogel components or compositions, e.g., hydrocolloids, which contain a hydrophilic component (which may contain or be a hydrogel) distributed in a hydrophobic phase.

The terms “tack” and “tacky” are qualitative. However, the terms “substantially nontacky,” “slightly tacky,” and “tacky,” as used herein, may be quantified using the values obtained in a PKI tack determination, a TRBT tack determination, or a PSA tack determination/Polyken Probe (Solutia, Inc.). The term “substantially nontacky” means a hydrogel composition that has a tack value that is less than about 25 g-cm/sec, “slightly tacky” means a hydrogel composition that has a tack value in the range of about 25 g-cm/sec to about 100 g-cm/sec, and “tack” means a hydrogel composition that has a tack value of at least 100 g-cm/sec.

The term “pressure sensitive adhesive” (PSA) relates to the polymer materials, which form a strong adhesive bond to any surface with application of very slight external pressure over a short period of time (e.g., 1-5 seconds).

The term “bioadhesive” means a hydrogel that exhibits a pressure-sensitive character of adhesion toward highly hydrated biological surfaces such as mucosal tissue.

The term “water-insoluble” refers to a polymer, compound or composition whose solubility in water is less than 5 wt %, preferably less than 3 wt %, more preferably less than 1 wt % (measured in water at 20° C.).

The term “active agent” is used herein to refer to a compound suitable for administration to a human patient and that induces a desired beneficial effect, e.g., exhibits a desired pharmacological activity. The term includes, for example, agents that are therapeutically effective, prophylactically effective, or cosmeceutically effective. Also included are derivatives and analogs of those compounds or classes of compounds specifically mentioned that also induce the desired beneficial effect.

The term “transdermal” drug delivery means administration of an active agent to the skin or mucosa of an individual so that the drug passes through the skin tissue and into the individual's blood stream. Unless otherwise indicated, the term “transdermal” is intended to include “transmucosal” drug administration, i.e., administration of a drug to the mucosal (e.g., sublingual, buccal, vaginal, rectal) surface of an individual so that the drug passes through the mucosal tissue and into the individual's blood stream.

The term “topical administration” is used in its conventional sense to mean delivery of an active agent to a body surface, such as, the skin or mucosa, as in, for example, topical drug administration in the prevention or treatment of various skin disorders, the application of cosmetics and cosmeceuticals (including moisturizers, masks, sunscreens, etc.), and the like. Topical administration, in contrast to transdermal administration, provides a local rather than a systemic effect.

The term “surface” or “body surface” is used to refer to any surface located on the human body or within a body orifice. Thus, a “body surface” includes, by way of example, skin or mucosal tissue, including the interior surface of body cavities that have a mucosal lining. Unless otherwise indicated, the term “skin” as used herein should be interpreted as including mucosal tissue and vice versa. Similarly, when the term “transdermal” is used herein, as in “transdermal drug administration” and “transdermal drug delivery systems,” it is to be understood that unless explicitly indicated to the contrary, both “transmucosal” and “topical” administration and systems are intended as well.

II. Covalently Crosslinked Water-insoluble Hydrophilic Adhesive Polymers

In general, covalently crosslinked hydrophilic polymers can be visualized as a three-dimensional network, wherein the hydrophilic polymer is a molecular entity comprised of two or more hydrophilic monomers (i.e., vinyl monomers) that are linked to each other through a dual-function monomer (i.e., hydrophilic oligomer), where each of the linked hydrophilic monomers is capable of further polymerization or cross-linking. In general, the hydrophilic monomers and the dual-function monomers are vinyl monomers.

A distinctive feature of the present invention is that the adhesive behavior of the crosslinked polymers and hydrogels is factored into the method of their preparation. Specifically, the covalent crosslinks (i.e., the dual-function monomers) are of appreciable length and flexibility in order to provide a large free volume, which provides sufficient adhesive behavior of the crosslinked polymers and hydrogels.

In one embodiment of the invention, a water-insoluble, crosslinked hydrophilic adhesive polymer is prepared by polymerization of a composition consisting essentially of a hydrophilic monomer and a dual-function monomer. The dual-function monomer undergoes polymerization with the hydrophilic monomers, as well as provides covalent crosslinks in the polymer. The crosslinked hydrophilic polymer may be synthesized via free radical polymerization using a suitable thermal free radical initiator, or by radiation polymerization using a suitable photoinitiator alone or in combination with a suitable photosensitizer.

The present invention further provides a covalently crosslinked, water-insoluble hydrophilic adhesive polymer having formula (I)

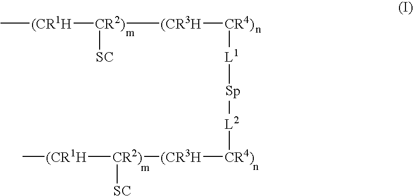

where: m is an integer in the range of 0 to 100,000; n is an integer in the range of 1 to 100,000; R¹, R², R³, and R⁴ are independently selected from hydrogen, lower alkyl, and lower hydroxyalkyl; SC is a hydrophilic side chain; L¹ and L² are linkages that are independently selected from —(CO)—O—, —O—(CO)—, —O—(CO)—O—, —(CO)—NH—, —NH—(CO)—, —O—(CO)—NH—, —NH—(CO)—O—, —S—S—, —S—(CO)—, and —(CO)—S—; and Sp is a poly(alkylene oxide) linker containing about 4-40 alkylene oxide units. In one preferred embodiment, R¹, R², and R³ are hydrogen; R⁴ is selected from hydrogen, methyl, and hydroxymethyl; SC is a poly(alkylene oxide) side chain containing about 4-20 alkylene oxide units; and L¹ and L² are —(CO)—O—.

When m in formula (I) is an integer in the range of 1 to 100,000, the polymer can be prepared by polymerization of a composition consisting essentially of a hydrophilic monomer and a dual-function monomer. In another embodiment of the invention, m in formula (I) is 0 and the polymer is prepared by homopolymerization of a composition consisting essentially of dual-function monomers selected from poly(ethylene glycol diacrylate) and poly(ethylene glycol) dimethacrylate, in the absence of any hydrophilic monomers.

Crosslinked hydrophilic polymers and hydrogels of the present invention can be designed to have optimum adhesion properties by controlling crosslinking in such a way so as to meet the following requirements: (1) the polymers and hydrogels posses two retardation times of about 10-50 and 300-700 sec, respectively; (2) the relaxation modulus, G₂, relating to longer retardation times, is higher than the relaxation modulus, G₁, corresponding to shorter retardation times; and (3) the absolute values of the G₂ and G₁ moduli are between the range of about 1.0-2.5 and about 0.30-0.75 MPa, respectively.

A. The Hydrophilic Monomers

Suitable hydrophilic monomers include, by way of illustration and not limitation, N-vinyl amides, N-vinyl lactams, vinyl alcohols, vinyl amines, acrylic acids, methacrylic acids, hydroxyalkyl acrylates, hydroxyalkyl methacrylate, vinyl ethers, alkyl acrylates, alkyl methacrylates, acrylamides, N-alkylacrylamides, N,N-dialkylacrylamides, N-hydroxyalkylacrylamides, maleic acids, esters of maleic acids, maleic acid-co-methylvinyl ethers, esters of maleic acid-co-methylvinyl ethers, sulfoalkylacrylates, sulfoalkylmethacrylates, hydroxystyrene, allyl alcohols, crotonic acid, and itaconic acid. Particularly preferred hydrophilic monomers include N-vinyl amides such as N-vinyl acetamide; N-vinyl lactams such as N-vinyl-2-pyrrolidone, N-vinyl-2-valerolactam, and N-vinyl-2-caprolactam; acrylic acids; methacrylic acids; hydroxyalkylacrylates such as hydroxyethylacrylate and hydroxyethylmethacrylate (HEMA); acrylamides; N-alkylacrylamides such as N-methylacrylamide and N-isopropylacrylamide; sulfoalkylacrylates such as sulfoethylacrylate; and sulfoalkylmethacrylates such as sulfoethylmethacrylate. The most preferred hydrophilic monomers are N-vinyl-2-pyrrolidone, acrylic acids, methacrylic acids, hydroxyethyl methacrylate, and hydroxyethyl acrylate, acrylamides, N-methylacrylamide, and N-isopropylacrylamide. Other exemplary hydrophilic monomers are shown in Table 15 in Example 10.

In one embodiment of the invention, the hydrophilic monomer has formula (II)

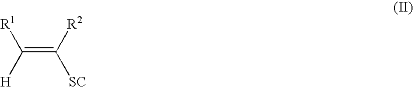

where: R¹ and R² are independently selected from hydrogen, lower alkyl, and lower hydroxyalkyl; and SC is a hydrophilic sidechain. In one embodiment, R¹ and R² are selected from hydrogen, methyl, and hydroxymethyl.

B. The Dual-Function Monomer

Generally, crosslinking of polymers will decrease their free volume and adhesion. In order to provide the necessary free volume to yield an adhesive hydrogel, the crosslinking agent is preferably selected so as to have sufficient chain length and flexibility. Exemplary dual-function monomers include poly(alkylene oxide) molecules containing about 4-40 alkylene oxide units, preferably about 9-20 alkylene oxide units, which are substituted at each terminus with a reactive group capable of undergoing vinyl polymerization. Preferably, the alkylene oxide units are selected from ethylene oxide, propylene oxide, or a combination thereof. Thus, crosslinks are formed by inserting dual-function monomers between two repeating units (e.g., two acrylic acid units) of neighboring chains of a hydrophilic polymer. The dual-function monomer may be linear or nonlinear. A preferred non-linear, dual-function monomer is a branched, star-like, multi-arm monomer, where a large free volume results from the length of the interchain covalent linker and from its branched structure.

In one embodiment, dual-function monomers may be prepared by reacting a hydrophilic crosslinking agent having formula (III)

R*-Sp-R* (III)

with an olefinic compound having formula (IV)

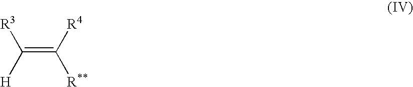

where: R³ and R⁴ are independently selected from hydrogen, lower alkyl, and lower hydroxyalkyl; R* and R** are reactive moieties capable of undergoing a nucleophilic addition reaction to form a covalent bond (e.g., R*is a nucleophilic group and R** is an electrophilic group); and Sp is a hydrophilic spacer moiety. In a preferred embodiment, R³ and R⁴ are selected from hydrogen, methyl, and hydroxymethyl.

Suitable dual-function monomers include those having formula (V)

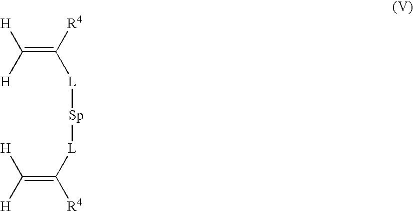

where: L is a linkage formed by the reaction of R* and R**. For example, R* may be a nucleophilic group selected from —NH₂, —NHR⁵, —N(R⁶)₂, —SH, —OH, —COOH, —PH₂, —PHR⁷, —P(R⁸)₂, -(L³)ₚ MgHal, and -L⁴Li, where R⁵, R⁶, R⁷, and R⁸ are C₁-C₆ hydrocarbyl, L³ and L⁴ are C₁-C₆ hydrocarbylene, p is zero or 1, and Hal is halo. Preferably, R* is selected from —OH, —SH and —NH₂.

Other suitable dual-function monomers include commercially available monomers such as, for example, polyethylene glycol diacrylate (PEGDA, SR-344), polyethylene glycol dimethacrylate, trimethylolpropane triacrylate (SR-351), ethoxylated trimetylolpropane trimethacrylate (SR-350), etoxylated (20) trimethylolpropane triacrylate (SR-415), and etoxylated (15) trimethylolpropane triacrylate (SR-9035) (the latter three of which are commercially available from Sartomer). The monomers, having 15-20 alkylene oxide units, have been found to provide excellent adhesion at equivalent degrees of crosslinking.

C. Preparation of Covalently Crosslinked Water-Insoluble Hydrophilic Adhesive Polymers

Hydrophilic polymers may be covalently crosslinked using heat, radiation, or with a chemical curing or crosslinking agent. Thermal crosslinking of the hydrophilic polymers is done by free radical polymerization in solution, and polymerization is carried out in the presence of an initiator, such as a free radical polymerization initiator, which is added to the polymer solution. The thermal free radical initiator can be any of the known free radical-generating initiators conventionally used in vinyl polymerization. Preferred thermal free radical initiators include peroxides, azo compounds, persulfates, and redox initiators, generally used in an amount from about 0.01-15 wt %, preferably about 0.05-10 wt %, more preferably from about 0.1-5 wt % and most preferably from about 0.5-4 wt % of the polymerizable material. The temperature for thermal crosslinking will depend on the actual components and may be readily deduced by one of ordinary skill in the art, but typically ranges from about 80-200° C.

Suitable peroxide initiators include dialkyl peroxides such as t-butyl peroxide, dicumyl peroxide, and 2,2 bis(t-butylperoxy)propane; diacyl peroxides such as benzoyl peroxide and acetyl peroxide; peresters such as t-butyl perbenzoate and t-butyl per-2-ethylhexanoate; perdicarbonates such as dicetyl peroxy dicarbonate and dicyclohexyl peroxy dicarbonate; ketone peroxides such as cyclohexanone peroxide and methylethylketone peroxide; and hydroperoxides such as cumene hydroperoxide and tert-butyl hydroperoxide. Suitable azo initiators include azo bis (isobutyronitrile) and azo bis (2,4-dimethylvaleronitrile). Suitable persulfate initiators include potassium persulfate, sodium persulfate, and ammonium persulfate. Suitable redox (oxidation-reduction) initiators include combinations of persulfate initiators with suitable reducing agents, such as, for example, using ammonium persulfate and N,N,N′,N′,-tetramethylethylenediamine as an initiator.

Hydrophilic polymers may also be prepared by a radiation polymerization process, in which both polymerization and crosslinking are accomplished with radiation. The radiation may be ultraviolet, alpha, gamma, electron beam, and x-ray radiation, although ultraviolet radiation is preferred. This process is typically carried out in the presence of an initiator, such as a photoinitiator, which can be used alone or in combination with a photosensitizer.

A “photoinitiator” is an agent that functions typically by either free radical initiation or cationic initiation (i.e., absorption of UV radiation followed by subsequent reaction to give a radical initiator or cation which induces the polymerization/crosslinking reaction). Suitable photoinitiators include, but are not limited to, peroxides such as hydrogen peroxide and dicumyl peroxide, persulfates such as sodium persulfate, ammonia persulfate and potassium persulfate, N,N,N′,N′,-tetramethylethylenediamine, benzophenones, xanthones, benzoin ethers, acetophenones, and benzoyl oximes.

Certain photoinitiators (e.g., benzophenones) also can be employed as photosensitizers. Useful photosensitizers are triplet sensitizers of the “hydrogen abstraction” type, and include benzophenone and substituted benzophenone and acetophenones such as benzyl dimethyl ketal, 4-acryloxybenzophenone, 1-hydroxy-cyclohexyl phenyl ketone, 2,2-diethoxyacetophenone and 2,2-dimethoxy-2-phenylaceto-phenone, substituted alpha-ketols such as 2-methyl-2-hydroxypropiophenone, benzoin ethers such as benzoin methyl ether and benzoin isopropyl ether, substituted benzoin ethers such as anisoin methyl ether, aromatic sulfonyl chlorides such as 2-naphthalene sulfonyl chloride, photoactive oximes such as 1-phenyl-1,2-propanedione-2-(o-ethoxy-carbonyl)-oxime, thioxanthones including alkyl- and halogen-substituted thioxanthonse such as 2-isopropylthioxanthone, 2-chlorothioxanthone, 2,4 dimethyl thioxanone, 2,4 dichlorothioxanone, and 2,4-diethyl thioxanone, and acyl phosphine oxides.

Radiation having a wavelength of about 200-800 nm, preferably, about 200-500 nm, is preferred for use herein, and low intensity ultraviolet light is sufficient to induce crosslinking in most cases. With photosensitizers of the hydrogen abstraction type, however, higher intensity UV exposure may be necessary to achieve sufficient crosslinking. Such exposure can be provided by a mercury lamp processor, such as, those available from PPG, Fusion, Xenon, and others. Crosslinking may also be induced by irradiating with gamma radiation or an electron beam. Appropriate irradiation parameters, i.e., the type and dose of radiation used to effect crosslinking, will be apparent to those skilled in the art.

Suitable chemical curing agents, also referred to as chemical crosslinking “promoters,” include, by way of illustration and not limitation, polymercaptans such as 2,2-dimercapto diethylether, dipentaerythritol pentaacrylate (SR-399), dipentaerythritol hexa(3-mercaptopropionate), ethylene bis(3-mercaptoacetate), pentaerythritol tetra(3-mercaptopropionate), pentaerythritol tetrathioglycolate, polyethylene glycol dimercaptoacetate, polyethylene glycol di(3-mercaptopropionate), trimethylolethane tri(3-mercaptopropionate), trimethylolethane trithioglycolate, trimethylolpropane tri(3-mercaptopropionate), trimethylolpropane trithioglycolate, dithioethane, di- or trithiopropane and 1,6-hexane dithiol. The crosslinking promoter is added to the uncrosslinked hydrophilic polymer to promote covalent crosslinking thereof. It should be noted that the dual function monomer can act as the chemical crosslinking promoter itself, such as, for example PEG-400 diacrylate.

D. Preparation of Covalently Crosslinked Water-Insoluble hHdrophilic Adhesive Polymers and Polymer Blends for use in Hydrogels

Covalently crosslinked water-insoluble hydrophilic adhesive polymers can also be prepared by polymerizing particular monomers and crosslinking long polymer chains. This method comprises polymerizing and simultaneously crosslinking a hydrophilic acrylic monomer, A, in the presence of both a crosslinker (i.e., a dual-function monomer or other crosslinking promoter) and a high molecular weight hydrophilic polymer, Bₙ (wherein B denotes the monomer unit of the high molecular weight polymer), and an optional plasticizer. In the latter case, an interpenetrating polymer network is obtained from polymerizing the hydrophilic monomer in the presence of the high molecular weight hydrophilic polymer, both of which have different chemical natures. In the interpenetrating polymer network, covalent crosslinks can be formed between both identical polymer chains (such as, A-crosslinker-A and B-crosslinker-B) and different polymer chains (such as, A-crosslinker-B). The adhesive properties of the crosslinked hydrophilic polymer are based on the specific ratio of free volume and cohesive energy. As such, the chemical nature of the polymerized monomer A and the high molecular weight polymer Bₙ, as well as the crosslinker, will affect this ratio. Curing of PSA polymers generally reduces free volume and decreases adhesion. Usually, the higher the crosslinking degree, the lower the free volume (estimated in terms of swell ratio) and the worse the adhesion, which means that for adhesive curing, long-chain crosslinker agents are most appropriate.

In one embodiment, a water-insoluble, hydrophilic covalently crosslinked adhesive polymer blend is prepared by polymerization of a hydrophilic acrylic monomer in the presence of a hydrophilic water-soluble high molecular weight polymer or copolymer, a dual function crosslinker or multi-function crosslinker, and an optional plasticizer. This is illustrated in Example 3.

In another embodiment, a water-insoluble, hydrophilic covalently crosslinked adhesive polymer blend is prepared by polymerization of a hydrophilic water-soluble high molecular weight polymer or copolymer, a dual function crosslinker or multi-function crosslinker, and an optional plasticizer. This is illustrated in Examples 1 and 2.

Examples of the hydrophilic acrylic monomer, A, include vinyl amines, acrylic acids, methacrylic acids, hydroxyalkyl acrylates, hydroxyalkyl methacrylate, vinyl ethers, alkyl acrylates, alkyl methacrylates, acrylamides, N-alkylacrylamides, N,N-dialkylacrylamides, N-hydroxyalkylacrylamides, maleic acids, esters of maleic acids, maleic acid-co-methylvinyl ethers, esters of maleic acid-co-methylvinyl ethers, sulfoalkylacrylates, sulfoalkylmethacrylates, hydroxystyrene, allyl alcohols, crotonic acid, and itaconic acid. Particularly preferred hydrophilic monomers for use in this embodiment of the invention, include acrylic acids, acrylamides, and hydroxyalkylacrylates such as hydroxyethylmethacrylate (HEMA).

Examples of suitable dual-function monomers include those discussed above, with polyethylene glycol diacrylate (PEGDA, SR-344), trimethylolpropane triacrylate (SR-351), and ethoxylated trimetylolpropane trimethacrylate, being particularly preferred.

Examples of suitable crosslinking promoters include those discussed above, with dipentaerythritol pentaacrylate (SR-399), being particularly preferred.

Examples of the high molecular weight hydrophilic polymer, B, suitable for forming the interpenetrating polymer networks include, but are not limited to, poly(N-vinyl amides), poly(N-vinyl lactams), polyvinyl alcohols, poly vinyl amines, polyacrylic acids, polymethacrylic acids, polyhydroxyalkyl acrylates, polyhydroxyalkyl methacrylates, polyacrylamides, poly(N-alkylacrylamides), poly(N,N-dialkylacrylamides), poly(N-hydroxyalkylacrylamides), polymaleic acids, esters of polymaleic acids, polymaleic acid-co-methylvinyl ethers, esters of polymaleic acid-co-methylvinyl ethers, polysulfoalkylacrylates, polysulfoalkylmethacrylates, and combinations thereof. Preferred high molecular weight polymers include poly(N-vinyl amides) such as poly(N-vinyl acetamide); poly(N-vinyl lactams) such as poly(N-vinyl-2-pyrrolidone), poly(N-vinyl-2-pyrrolidone-co-vinylacetate), poly(N-vinyl-2-valerolactam) and poly(N-vinyl-2-caprolactam). A preferred combination of high molecular weight polymers includes copolymers of polyacrylic acids or polymethacrylic acids with polyalkyl acrylates and polyalkyl methacrylates.

Exemplary plasticizers include polyethyleneglycol, glycerol, 1,2-propylenglycol, 2-methyl-1,3-propanediol, and water.

The covalently crosslinked interpenetrating hydrophilic polymer networks may be synthesized using either free radical polymerization in solution or radiation polymerization (provides simultaneous polymerization and crosslinking.

E. Forms of Products Based on Covalently Crosslinked Water-Insoluble Hydrophilic Adhesive Polymers

The polymers can be prepared in the form of amorphous gels, dry powders, films and hydrogel sheets. Amorphous gels and hydrogel sheets may be easily obtained by radical polymerization in solution in the form of a fully swollen hydrogel (e.g., for use in wound dressings, electrotherapy pads, facial skin-irrigating masks, and the like) or in moderately hydrated form (e.g., for use in transmucosal drug delivery systems, suppositories, dressings for moderately to heavily exudating burns and wounds). Dry powders (e.g., for dusting an exudating wound) can be prepared either by freeze-drying (i.e., lyophilization) an appropriate aqueous solution or by emulsion (dispersion) polymerization. Films are usually formed by irradiating uncured films, which are made by casting the reactive solution and drying. In order to form a curable film, the reactive mixture preferably comprises a solution of a long chain polymer loaded with relevant monomer and crosslinking agents. When γ-, electronic beam or UV-irradiation is employed, the reactive mixture will not typically need to contain a crosslinker.

F. Properties of Covalently Crosslinked Water-Insoluble Hydrophilic Adhesive Polymers

Pressure-sensitive adhesion of polymer materials is controlled by the ratio between cohesion energy and free volume. The covalent crosslinks in the polymer usually provide increased cohesion, i.e., the higher the crosslinking density, the greater the cohesive strength. Although the strength of a single covalent bond is much higher than that of a H-bond, the cohesive toughness of crosslinked polymers depends on the strength of crosslinked supramolecular structures (networks), rather than on the energy of separate bonds. Therefore, to compare the cohesive strength of covalently bonded and hydrogen bonded crosslinked structures, the transient nature of H-bonded structures is taken into account. The cohesive strength of polymer materials can be measured in terms of energy required to break the material under applied tensile stress. Under external mechanical stress, however, polymer relaxation occurs, and H-bonded and covalent bonded crosslinks contribute differently to the relaxation. Under applied stress, the covalent crosslinks break irreversibly, while the transient H-bonded network can rupture and reform anew at another place in the network during deformation, thereby eventually dissipating even more energy than required to deform and break the covalent crosslinks.

The length and flexibility of the dual-function monomer determines the free volume of the resulting polymer and thus the polymer's adhesive characteristics as well. Increased tack and adhesion can be obtained by providing a greater free volume, which is associated with a polymer in which the dual-function monomers are relatively long and flexible. Upon hydration, the polymer then will exhibit increased tack and adhesive strength, although upon reaching the absorption limit, the polymer will begin to lose adhesion.

The properties of covalently crosslinked water-insoluble hydrophilic adhesive polymers were evaluated and are set forth in Examples 1-6 and 10. Based upon these examples, the criteria for optimum adhesion and tack on the relaxation data can be stated as follows. To be a PSA, the polymer compositions preferably possess two retardation times of 10-50 seconds and 300-700 seconds, respectively. For proper adhesion, the relaxation modulus, G₂, relating to the longer retardation times, is preferably higher than the relaxation modulus, G₁, corresponding to the shorter retardation times. Finally, optimum tack is achieved as the absolute values of the G₂ and G₁ moduli range between 1.0-2.5 and 0.30-0.75 MPa, respectively.

G. Potential uses for Covalently Crosslinked Water-Insoluble Hydrophilic Adhesive Polymers

These polymers find numerous uses in health care products. Using VP-PEGDA (N-vinyl-2-pyrrolidone-polyethylene glycol diacrylate) crosslinked copolymers as an example, the polymers can be prepared in a variety of ways, and the physical properties exhibited will then determine the polymer's utility.

VP-PEGDA can be prepared as a dry powder by vacuum freeze-drying relevant aqueous solutions. This dry VP-PEGDA powder is: able to absorb a large amount of water; is nontacky in the dry state, but exhibits increased adhesion appreciably in the course of hydration; loses adhesion upon reaching its swelling limit; and maximum adhesion is observed under water uptake of three times the weight of dry polymer. This material is particularly suited for use as moisture and exudate absorbers in hydrocolloid patches (cushion, wound care), as well as powders for dusting the exudating wounds.

VP-PEGDA can also be prepared as a highly swollen hydrogel (at swelling limit), as a sheet, as an impregnated gauze, or as a paste, e.g., to be squeezed from tubes. This form of VP-PEGDA is: initially nontacky or has only a slight adhesion towards skin; adhesion is enhanced by dehydrating when being applied to dry skin; and forms an elastic transparent adhesive film that can be easily detached upon the loss of 80-90% adsorbed water. This material can be used for facial skin-irrigating masks, wound dressings, and electrotherapy pads.

In addition, VP-PEGDA can be prepared as an adhesive film, either in an unsupported form or supported with a backing member. VP-PEGDA films maintain strong adhesion to wet skin or mucosa having a wide hydration range, and adhesion decreases gradually both in the course of dehydration and hydration. These films can be used for application to the mucosa (e.g., breath refreshment, non-medicated, medicated, transmucosal drug delivery from buccal, vaginal and rectal devices, stomatitis treatment, etc.), can be molded and used as vaginal and rectal suppositories, and can be used as dressings for heavy to moderately exudates from wounds.

III. Covalently and Non-Covalently Crosslinked Adhesive Polymers

Water-insoluble adhesive polymers can also be prepared by polymerization of a composition consisting essentially of: (a) a hydrophilic monomer, an acrylic acid monomer esterified with a hydrophilic side chain, and an acrylate monomer; (b) a hydrophilic monomer, an acrylic acid monomer esterified with a hydrophilic side chain, and a dual-function monomer; or (c) an acrylate monomer, an acrylic acid monomer esterified with a hydrophilic side chain, and a dual-function monomer.

Suitable hydrophilic monomers and dual-function monomers are described above. Particularly preferred hydrophilic monomers include N-vinyl-2-pyrrolidone, acrylic acids, and acrylamides. Particularly preferred dual-function monomers include polyethylene glycol diacrylate (PEGDA).

Suitable acrylate monomers include acrylates, methacrylates, lower alkyl acrylates such as methacrylate and ethacrylate; 2-substituted lower alkyl acrylates such as 2-methyl methacrylate, 2-ethyl methacrylate, and 2-methyl ethacrylate; lower alkyl methacrylates; hydroxyalkyl acrylates; and hydroxyalkyl methacrylates.

The acrylic acid monomer is preferably esterified with a poly(alkylene oxide) chain containing about 4-40 alkylene oxide units. Preferred alkylene oxide units include ethylene oxide, propylene oxide, and combinations thereof. Particularly referred esterified acrylic acid monomers include polyethylene glycol monoacrylate (PEGMA) and polyethylene glycol monomethacrylate (PEGMMA).

An exemplary hydrophilic monomer/acrylic acid monomer esterified with a hydrophilic side chain/acrylate monomer is N-vinyl-2-pyrrolidone/PEGMMA/lower alkyl acrylate, which is a non-covalently crosslinked composition.

Another exemplary hydrophilic monomer/acrylic acid monomer esterified with a hydrophilic side chain/dual-function monomer composition is N-vinyl-2-pyrrolidone/PEGMMA/PEGDA, which is a covalently crosslinked composition.

An exemplary acrylate monomer/acrylic acid monomer esterified with a hydrophilic side chain/dual-function monomer is lower alkyl acrylate/PEGMMA/PEGDA, which is a covalently crosslinked composition.

The solubility of these adhesive compositions in water can be controlled, for example, by the degree of crosslinking or the degree of hydrophobicity of the acrylate monomer. Depending on relative amounts of the components, either water-soluble or water-insoluble but water swellable hydrogel compositions can be obtained. In particular, the crosslinked polymers can be synthesized using hydrophobic acrylate monomers such as, lower alcyl acrylates and alcyl methacrylates. This water-insoluble polymer will have amphiphilic properties, wherein the polymer has both hydrophobic and hydrophilic regions. Because of the hydrophobic adhesive component, the compositions, based on such amphiphilic crosslinked and uncrosslinked monomers, exhibit initial tack in the dry state. As is well understood, however, the tackiness of hydrophobic adhesives tends to drop with hydration. The hydrophilic monomer offsets the effect of the hydrophobic monomer in this regard, and provides for enhanced adhesion upon hydration. Such polymers and compositions are particularly useful as a pressure-sensitive bioadhesives that can sufficiently adhere to highly hydrated biological tissues (such as mucosal membranes), while retaining the toughness of a conventional PSA.

IV. Non-Covalently Crosslinked Water-Soluble, Hydrophilic Adhesive Polymers (Comb-like Polymers)

A. Non-Covalent Crosslinking Versus Covalent Crosslinking

As shown above for covalently crosslinked polymers, a H-bonded PVP-PEG complex possesses pressure-sensitive adhesive properties. In this complex, the adhesion appears as a result of crosslinking longer PVP chains by forming hydrogen bonds between complementary groups in PVP monomer units and hydroxyl groups at both ends of PEG short chains. The PVP-PEG network complex exhibits a high energy of cohesive interaction (due to PVP-PEG H-bonding) coupled with a large free volume (due to considerable length and flexibility of PEG crosslinks). The specific balance between enhanced cohesion and large free volume is a major factor governing the adhesion. This balance, however, did not appear to be the only factor responsible for the adhesion, since the covalent bonded replica of the complex does not exhibit pressure-sensitive adhesion. The most probable reason for the loss of adhesion in the covalently crosslinked network structure, which exhibits a strong cohesive interaction and a large free volume, is in the transient character of hydrogen bonded crosslinks. As a consequence of this behavior, the hydrogen bonded PVP-PEG network complex and its covalent replica reveal disparate relaxation and adhesive properties.

To confirm this, comb-like polymers of N-vinyl-2-pyrrolidone were prepared with different amounts of polyethylene glycol monomethacrylate (PEGMMA). In these polymers, the free hydroxyl group at the end of the PEG side-chain was capable of H-bonding to the carbonyl group of the VP monomer units in the backbone and to crosslink non-covalently with the VP-PEGMMA polymer forming a hydrogel.

Thus, the invention also pertains to a water-soluble, hydrophilic polymer is provided that is free of covalent crosslinks, i.e., a polymer that is non-covalently crosslinked through hydrogen, electrostatic, and/or ionic bonding.

One embodiment is a water-soluble, hydrophilic polymer is provided that is free of covalent crosslinks, wherein the polymer is prepared by polymerization of a composition consisting essentially of a hydrophilic monomer, and an acrylic acid monomer esterified with a hydrophilic side chain, preferably a poly(alkylene oxide) chain containing about 4-40 alkylene oxide units. Preferred alkylene oxide units include ethylene oxide, propylene oxide, and combinations thereof. Particularly referred esterified acrylic acid monomers include polyethylene glycol monoacrylate and polyethylene glycol monomethacrylate. Suitable hydrophilic monomers are as set forth above.

The present invention further provides a water-soluble, hydrophilic polymer that is free of covalent crosslinks having formula (VI)

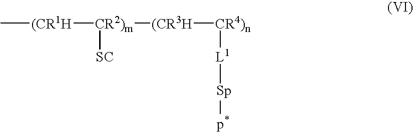

where m, n, R¹, R², R³, R⁴, SC, L¹, and Sp are defined above, and P* is a polar moiety. Preferably, R¹, R², and R³ are hydrogen; R⁴ is selected from hydrogen, methyl, and hydroxymethyl; SC is a poly(alkylene oxide) side chain containing about 4-20 alkylene oxide units; L¹ is —(CO)—O—; and P* is a hydroxyl group. The hydrophilic polymer may further comprise at least one additional water-insoluble hydrophilic polymer containing unesterified acidic groups.

When m in formula (VI) is an integer in the range of 1 to 100,000, the polymer can be prepared by polymerization of a composition consisting essentially of a hydrophilic monomer and an acrylic acid monomer esterified with a hydrophilic side chain. In another embodiment of the invention, m in formula (VI) is 0 and the polymer is prepared by homopolymerization of a composition consisting essentially of dual-function monomers selected from poly(ethylene glycol monoacrylate) and poly(ethylene glycol) monomethacrylates, in the absence of any hydrophilic monomers.

B. Hydrophilic Monomers

Suitable hydrophilic monomers are as described above for covalently crosslinked polymers, with N-vinyl lactams such as N-vinyl-2-pyrrolidone being particularly preferred.

C. Acrylic Acid Monomers Esterified with a Hydrophilic Side Chain

The acrylic acid monomer is either acrylic acid per se or a substituted acrylic acid, particularly acrylic acid substituted at the 2-position, e.g., with a lower alkyl group (as in methacrylic acid, ethacrylic acid, etc.). The acrylic acid monomer is esterified with a hydrophilic side chain, preferably a poly(alkylene oxide) chain containing about 4-40 alkylene oxide units to form a comb-like polymer. Examples of particular comb-like polymers that have been found to provide best adhesion, are polyethylene glycol monoacrylate (PEGMA), and polyethylene glycol monomethacrylate (PEGMMA).

These comb-like polymers have a backbone of alternating monomers (e.g., N-vinyl-2-pyrrolidone and methacrylic acid), with long and flexible hydrophilic side chains of poly(alkylene) glycol, which are covalently bound to the acrylic acid monomers through one terminal group, retaining opposite hydroxyl terminal group unmodified and accessible for hydrogen bonding. The comb-like polymers may be synthesized by polymerization of various hydrophilic monomers with a monosubstituted acrylate or methacrylate of poly(alkylene oxide).

D. Preparation Methods

Comb-like VP-PEGMMA polymers can be synthesized by radical polymerization in solution, as described above for covalently crosslinked polymers.

E. Forms of VP-PEGMMA Polymers

Comb-like VP-PEGMMA hydrophilic polymers that are free of covalent crosslinks are useful in products and compositions wherein cohesive strength and rapid swelling are less important than high tack and adhesion. Depending on the ultimate application, the polymer may be in the form of adhesive films, adhesive sheets, ointments, and mold implants. Since the hydrophilic comb-like polymers are soluble in water and polar volatile solvents, adhesive films and sheets may be prepared with a conventional cast-drying technique.

The properties of comb-like VP polymers with PEGMMA were evaluated and are set forth in Example 7. The properties of triple VP-PEGDA-PEGMMA polymers were evaluated and are set forth in Example 8. Hydrogen bonding versus covalent bonding was evaluated, comparing non-crosslinked adhesive PVP-PEG blends, VP-PEGDA and VP-PEGMMA polymers, and is detailed in Example 9. The properties of comb-like or crosslinked PEGMMA and PEGDA polymers with other hydrophilic monomers are shown in Example 10.

F. Potential uses for Non-Covalently Crosslinked Water-Soluble, Hydrophilic Adhesive Polymers

These polymers find numerous uses in health care products. Using VP-PEGMMA comb-like copolymers as an example, the polymers can be prepared in a variety of ways, and the physical properties exhibited will then determine the polymer's utility.

VP-PEGMMA comb-like copolymers can be prepared as an adhesive film, ointment or mold implants. This copolymer provides high immediate tack both to dry and wet skin and mucosa, and demonstrates slow swelling and dissolution in large amount of water. This material is particularly suited for use as a vaginal or rectal suppository, as well as for use as tackifiers for hydrophilic polymers.

Triple VP-PEGMMA-PEGDA copolymers and comb-like VP-PEGMMA copolymers that are UV-cured with SR 415 can be prepared as adhesive sheets and films. This copolymer provides similar properties as VP-PEGMMA comb-like copolymers (immediate tack, slow swelling and dissolution) but is also insoluble in water. These material are particularly suited for use as self-adhesive wound and burn dressings with slight to moderate exudate absorption, for use in transdermal and mucosal systems, as electrotherapy adhesive pads, and as skin-attaching devices and electrodes.

V. Non-Covalently Crosslinked Water-Insoluble Hydrophilic Polymer and Amphiphilic Crosslinker Blends

A. Preparation of Adhesive Polymer Blends of Hydrophilic Polymers with Complementary Amphiphilic Crosslinkers

It is known that water-soluble, pressure-sensitive hot-melt adhesives can be prepared by mixing of certain vinyl pyrrolidone polymers with monobasic saturated or unsaturated liquid fatty acids (see U.S. Pat. No. 4,331,576 to Colon). The present invention is directed to the discovery that binary blends of various hydrophilic polymers with complementary amphiphilic crosslinkers, whose molecules consist of polar heads and hydrophobic tails, provide the properties typical of pressure-sensitive adhesives and bioadhesives.

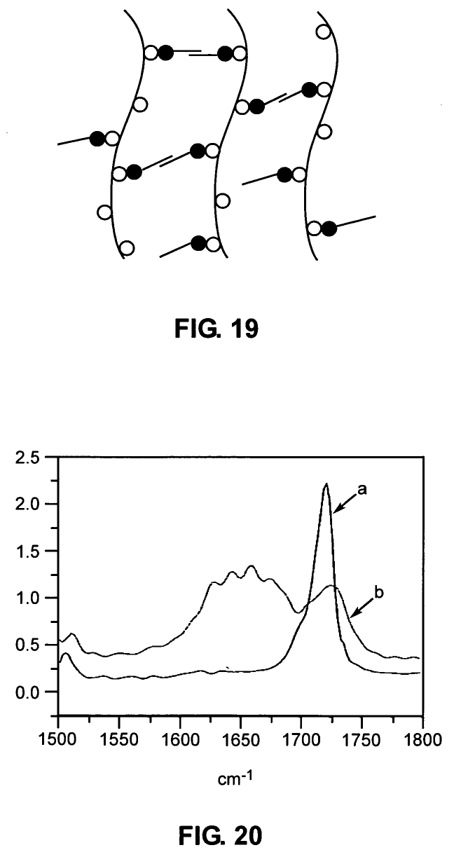

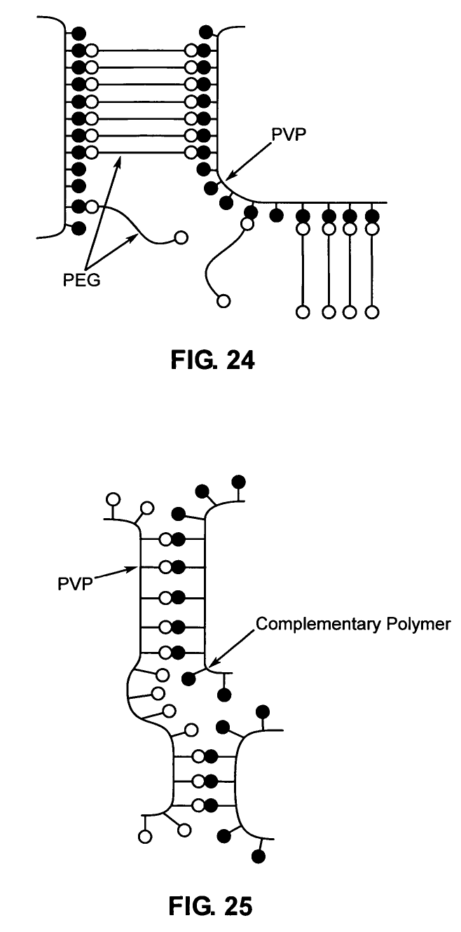

The molecular mechanism underlying the pressure-sensitive adhesion of the blends of hydrophilic polymers with amphiphilic crosslinkers, which bear complementary polar groups, is illustrated schematically in FIG. 19. This is similar to the blends of hydrophilic polymers and short-chain plasticizers that form a carcass-like complex as shown in FIG. 24, and distinct from the ladder-like complex shown in FIG. 25.

By forming hydrogen, electrostatic or ionic bonds with the complementary reactive groups in the long-chains of the hydrophilic polymer, the polar heads provide binding of the amphiphilic crosslinker with the hydrophilic polymer, while the hydrophobic tails are capable of forming non-covalent crosslinks between the long chains of hydrophilic polymer by means of hydrophobic interaction with the tails of neighboring surfactant molecules as is shown in FIG. 19. As a result, carcass-like molecular structures are provided, wherein the short-chain non-covalent crosslinks are formed by association of neighboring amphiphilic molecules into complexes stabilized by hydrophobic interaction between non-polar tails.

Accordingly, one embodiment of the invention is a water-insoluble, hydrophilic adhesive polymer blend that is free of covalent crosslinks, consisting essentially of: at least one hydrophilic long-chain polymer and at least one amphiphilic crosslinker.

The hydrophilic long-chain polymers capable of forming hydrogen, electrostatic or ionic bonds with the complementary reactive groups of the amphiphilic crosslinker, include, by way of illustration and not limitation, poly(N-vinyl amides), polyethylene oxide-co-vinyl alcohols, poly(acrylamides), poly (N-alkylacrylamides), poly(N,N-dialkylacrylamides), poly(N-hydroxyalkylacrylamides), poly(maleic acids), poly maleic acid-co-methylvinyl ethers, poly(sulfoalkylacrylates), poly(sulfoalkylmethacrylates), polyacrylic acids, polymethacrylic acids, poly(N-vinyl lactams), polyvinyl alcohols, poly(hydroxyalkyl acrylates), poly(hydroxyalkyl methacrylates), and salts and copolymers thereof; alginic acid, chitosan, hydroxypropylcellulose, hydroxyethyl cellulose, methylcellulose, hydroxypropyl methylcellulose, and carboxymethylcellulose, and salts thereof.

Suitable amphiphilic crosslinkers include, by way of illustration and not limitation, fatty acids, ionic and nonionic surfactants, and non-steroidal anti-inflammatory drugs (NSAIDs). Exemplary NSAIDs include drugs as ibuprofen and ketoprofen, both of which are fatty acids capable of H-bonding to poly(N-vinyl lactams) such as poly(N-vinyl-2-pyrrolidone) via their carboxylic groups.

In one embodiment, the adhesive polymer blend will contain from about 25-55 wt % of the hydrophilic long-chain polymer, and from about 45-75 wt % of the amphiphilic crosslinker.

An exemplary adhesive polymer blend is shown in Example 14.

B. Preparation of Elastic Adhesive Films from Hydrophilic Polymers and Complementary Amphiphilic Crosslinkers

These water-insoluble, hydrophilic adhesive polymer blends can also be non-covalently crosslinked to form elastic adhesive films suitable for application to body surfaces, when mixed with a plasticizer, which contains complementary reactive functional groups at its ends, and is capable of forming a carcass-like complex by hydrogen or electrostatic bonding with the hydrophilic long-chain polymer. This component can be referred to as a “carcass-like non-covalent crosslinker” as described above.

In particular, these films are well suited for application within the oral mucosal cavity in a form of mucosal sublingual and buccal patches for transmucosal drug delivery. When applied to mucosal tissue, the film immediately builds up intimate adhesive contact to the surface of the application site. After adhesive contact is formed the film can then deliver an active agent across the mucosal tissue.

Illustrative films are described in Example 15.

VI. Hydrogel Compositions

Any of the aforementioned polymers and polymer blends can be used as a water-insoluble hydrogel composition for topical application or for application to any mucosal surface, for example, for intraoral application. Water-insoluble polymers and polymer blends are used alone, while the water-soluble polymers are combined with a water-insoluble film-forming polymer, as described below in the discussion of liquid film-forming compositions.

A. Hydrogels made from Water-Insoluble Adhesive Hydrophilic Polymers

The hydrogel compositions, comprising the water-insoluble, hydrophilic polymers and polymer blends of the invention, may also comprise conventional additives such as absorbent fillers, preservatives, pH regulators, plasticizers, softeners, thickeners, antioxidants, active agents, pigments, dyes, refractive particles, stabilizers, toughening agents, tackifiers, detackifiers, pharmaceutical agents, and permeation enhancers. In those embodiments where adhesion is to be reduced or eliminated, conventional detackifying agents may be used. These additives, and the amounts thereof, are selected in such a way that they do not significantly interfere with the desired chemical and physical properties of the hydrogel composition.

Absorbent fillers may be advantageously incorporated to control the degree of hydration when the adhesive is on the skin or other body surface. Such fillers can include microcrystalline cellulose, talc, lactose, guar gum, kaolin, mannitol, colloidal silica, alumina, zinc oxide, titanium oxide, magnesium silicate, magnesium aluminum silicate, hydrophobic starch, calcium sulfate, calcium stearate, calcium phosphate, calcium phosphate dihydrate, and woven, non-woven paper, and cotton materials. Other suitable fillers are inert, i.e., substantially non-adsorbent, and include, for example, polyethylenes, polypropylenes, polyurethane polyether amide copolymers, polyesters and polyester copolymers, nylon, and rayon. One preferred filler is colloidal silica, e.g., Cab-O-Sil® (available from Cabot Corporation, Boston Mass.).

Preservatives include, by way of example, p-chloro-m-cresol, phenylethyl alcohol, phenoxyethyl alcohol, chlorobutanol, 4-hydroxybenzoic acid methylester, 4-hydroxybenzoic acid propylester, benzalkonium chloride, cetylpyridinium chloride, chlorohexidine diacetate or gluconate, ethanol, and propylene glycol.

Compounds useful as pH regulators include, but are not limited to, glycerol buffers, citrate buffers, borate buffers, phosphate buffers, and citric acid-phosphate buffers, which may be included so as to ensure that the pH of the hydrogel composition is compatible with that of an individual's body surface.

Suitable plasticizers and softeners include citric acid esters, such as triethyl citrate and acetyl triethyl citrate; tartaric acid esters such as dibutyltartrate; glycerol esters such as glycerol diacetate and glycerol triacetate; sorbitol; phthalic acid esters such as dibutyl phthalate and diethyl phthalate; and/or hydrophilic surfactants, preferably hydrophilic non-ionic surfactants such as, for example, partial fatty acid esters of sugars, polyethylene glycol fatty acid esters, polyethylene glycol fatty alcohol ethers, and polyethylene glycol sorbitan-fatty acid esters. Preferred plasticizers include PEG, glycerol, propylene glycol, poly(propylene glycol), sorbitol, block copolymers of ethylene oxide and propylene oxide (Pluronics), acetyl tributyl citrate, tributyl citrate, triethyl citrate, acetyl triethyl citrate, dibutyl sebacate, and dibutyl phthalate.

Optionally, a low molecular weight plasticizer may be included in the composition, i.e., a plasticizer for the hydrophilic polymer. Suitable low molecular weight plasticizers include, without limitation, low molecular weight poly(alkylene oxides) and polyhydric alcohols, dialkyl phthalates, dicycloalkyl phthalates, diaryl phthalates and mixed alkyl-aryl phthalates as represented by dimethyl phthalate, diethyl phthalate, dipropyl phthalate, di(2-ethylhexyl)-phthalate, di-isopropyl phthalate, diamyl phthalate and dicapryl phthalate; alkyl and aryl phosphates such as tributyl phosphate, trioctyl phosphate, tricresyl phosphate, and triphenyl phosphate; alkyl citrate and citrate esters such as trimethyl citrate, triethyl citrate, tributyl citrate, acetyl triethyl citrate, and trihexyl citrate; dialkyl adipates such as dioctyl adipate (DOA; also referred to as bis(2-ethylhexyl)adipate), diethyl adipate, di(2-methylethyl)adipate, and dihexyl adipate; dialkyl tartrates such as diethyl tartrate and dibutyl tartrate; dialkyl sebacates such as diethyl sebacate, dipropyl sebacate and dinonyl sebacate; dialkyl succinates such as diethyl succinate and dibutyl succinate; alkyl glycolates, alkyl glycerolates, glycol esters and glycerol esters such as glycerol diacetate, glycerol triacetate (triacetin), glycerol monolactate diacetate, methyl phthalyl ethyl glycolate, butyl phthalyl butyl glycolate, ethylene glycol diacetate, ethylene glycol dibutyrate, triethylene glycol diacetate, triethylene glycol dibutyrate and triethylene glycol dipropionate; and mixtures thereof.

Preferred thickeners are naturally occurring compounds or derivatives thereof, and include, by way of example, collagen, galactomannans, starches, starch derivatives and hydrolysates, cellulose derivatives such as methyl cellulose, hydroxypropylcellulose, hydroxyethyl cellulose, and hydroxypropyl methyl cellulose, colloidal silicic acids, and sugars such as lactose, saccharose, fructose and glucose. Synthetic thickeners such as polyvinyl alcohol, vinylpyrrolidone-vinylacetate-copolymers, polyethylene glycols, and polypropylene glycols, may also be used.

Incorporation of an antioxidant in these compositions is optional but preferred. The antioxidant serves to enhance the oxidative stability of the hydrogel composition. Heat, light, impurities, and other factors can all result in oxidation of the hydrogel composition. Thus, preferably antioxidants protect against light-induced oxidation, chemically induced-oxidation, and thermally-induced oxidative degradation during processing and/or storage. Oxidative degradation, as will be appreciated by those in the art, involves generation of peroxy radicals, which in turn react with organic materials to form hydroperoxides. Primary antioxidants are peroxy free radical scavengers, while secondary antioxidants induce decomposition of hydroperoxides, and thus protect a material from degradation by hydroperoxides. Most primary antioxidants are sterically hindered phenols, and preferred such compounds for use herein are tetrakis [methylene (3,5-di-tert-butyl-4-hydroxyhydrocinnamate)]methane (e.g., Irganox® 1010 available from Ciba-Geigy Corp., Hawthorne, N.Y.) and 1,3,5-trimethyl-2,4,6-tris [3,5-di-t-butyl-4-hydroxy-benzyl]benzene (e.g., Ethanox® 330 available from Ethyl Corp.). A particularly preferred secondary antioxidant that may replace or supplement a primary antioxidant is tris(2,4-di-tert-butylphenyl)phosphite (e.g., Irgafos® 168 available from Ciba-Geigy Corp.). Other antioxidants, including but not limited to multi-functional antioxidants, are also useful. Multifunctional antioxidants serve as both a primary and a secondary antioxidant. Irganox® 1520 D, manufactured by Ciba-Geigy is one example of a multifunctional antioxidant. Vitamin E antioxidants, such as that sold by Ciba-Geigy as Irganox® E17, are also useful in the present hydrogel compositions. Other suitable antioxidants include, without limitation, ascorbic acid, ascorbic palmitate, tocopherol acetate, propyl gallate, butylhydroxyanisole (BHA), butylated hydroxytoluene (BHT), bis(1,2,2,6,6-pentamethyl-4-piperidinyl)-(3,5-di-tert-butyl-4-hydroxybenzyl)butylpropanedioate, (available as Tinuvin® 144 from Ciba-Geigy Corp.) and a combination of octadecyl 3,5-di-tert-butyl-4-hydroxyhydrocinnamate (also known as octadecyl 3-(3′,5′-di-tert-butyl-4′-hydroxyphenyl)propionate) (Naugard® 76 available from Uniroyal Chemical Co., Middlebury, Conn.) and bis(1,2,2,6,6-pentamethyl-4-piperidinylsebacate) (Tinuvin® 765 available from Ciba-Geigy Corp.). Preferably, the antioxidant is present in an amount up to about 2 wt % of the hydrogel composition; typically, the amount of antioxidant is in the range of about 0.05 wt % to 1.5 wt %.

B. Hydrogels Made from Water-Insoluble Adhesive Hydrophilic Polymers and a Hydrophobic Polymer

The hydrogel compositions, comprising the water-insoluble, hydrophilic polymers of the invention, may also comprise a hydrophobic polymer. The hydrophobic polymer is typically a hydrophobic pressure-sensitive adhesive polymer, preferably a thermosetting polymer, which provides the composition with the advantageous properties of a PSA. Preferred hydrophobic PSA polymers are crosslinked butyl rubbers, which are isoprene-isobutylene copolymers typically having an isoprene content in the range of about 0.5 to 3 wt %, or a vulcanized or modified version thereof, e.g., a halogenated (brominated or chlorinated) butyl rubber. In a particularly preferred embodiment, the hydrophobic PSA polymer is butyl rubber crosslinked with polyisobutylene. Other suitable hydrophobic polymers include, for example, natural rubber adhesives, styrene-isoprene-styrene block copolymers, vinyl ether polymers, polysiloxanes, polyisoprene, butadiene acrylonitrile rubber, polychloroprene, atactic polypropylene, and ethylene-propylene-diene terpolymers (also known as “EPDM” or “EPDM rubber”) (Trilene® 65 and Trilene® 67 available from Uniroyal Chemical Co., Middlebury, Conn.). Still other suitable hydrophobic PSAs will be known to those of ordinary skill in the art and/or are described in the pertinent texts and literature. See, for example, the Handbook of Pressure-Sensitive Adhesive Technology, 2nd Ed., Satas, Ed. (New York: Von Nostrand Reinhold, 1989). Particularly preferred hydrophobic polymers are the crosslinked butyl rubbers available in the Kalar® series (Elementis Specialties, Inc., Hightstown, N.J.), with Kalar® 5200, Kalar® 5215, Kalar® 5246, and Kalare 5275 being most preferred.

For most applications, the crosslinked hydrophobic polymer will have a sufficiently high degree of crosslinking so that the composition does not exhibit cold flow following application to a surface (e.g., a body surface such as skin). As will be appreciated by those in the art, the degree of crosslinking correlates with Mooney viscosity, a measure of the resistance of a raw or unvulcanized rubber to deformation as measured in a Mooney viscometer. A higher Mooney viscosity indicates a higher degree of crosslinking. The Mooney viscosity of preferred hydrophobic PSAs for use herein is at least 20 cps at 25° C., and generally is in the range of about 25 cps to 80 cps, preferably about 30 cps to 75 cps, at 25° C. The Mooney viscosities of the preferred Kalar® series polymers herein are as follows: Kalar® 5200, 40-45 cps; Kalar® 5215, 47-57 cps; Kalar® 5246, 30-40 cps; and Kalar® 5275, 70-75 cps (all at 25° C.).

The molecular weight of the hydrophobic PSA is not critical, although the molecular weight will typically be less than about 100,000 Da. The amount of the polymer generally, although not necessarily, is present in the range of about 5 wt % to 15 wt %, preferably about 7.5 wt % to 12 wt %, most preferably about 7.5 wt % to 10 wt %, of the composition after drying.

Such compositions will generally, although not necessarily, also contain a plasticizer component for the hydrophobic PSA. The plasticizer component is preferably an elastomeric polymer that acts not only as a plasticizer, but also as a diluent. The term “plasticizing” means that the component tends to decrease the glass transition temperature of the hydrophobic polymer and/or reduce its melt viscosity. Suitable plasticizing elastomers are natural and synthetic elastomeric polymers, including, for example, AB, ABA, and “multiarmed” (AB)ₓ block copolymers, where for example, A is a polymerized segment or “block” comprising aryl-substituted vinyl monomers, preferably styrene, α-methyl styrene, vinyl toluene, and the like, B is an elastomeric, conjugated polybutadiene or polyisoprene block, and x has a value of 3 or more. Preferred elastomers are butadiene-based and isoprene-based polymers, particularly styrene-butadiene-styrene (SBS), styrene-butadiene (SB), styrene-isoprene-styrene (SIS), and styrene-isoprene (SI) block copolymers, where “S” denotes a polymerized segment or “block” of styrene monomers, “B” denotes a polymerized segment or block of butadiene monomers, and “I” denotes a polymerized segment or block of isoprene monomers. Other suitable elastomers include radial block copolymers having a SEBS backbone (where “E” and “B” are, respectively, polymerized blocks of ethylene and butylene) and I and/or SI arms. Natural rubber (polyisoprene) and synthetic polyisoprene can also be used.

Commercially available elastomers useful in the practice of the present invention include linear SIS and/or SI block copolymers such as Quintac® 3433 and Quintac® 3421 (Nippon Zeon Company, Ltd., Louisville, Ky.); Vector® DPX 559, Vector® 4111 and Vector® 4113 (Dexco, a partnership of Exxon Chemical Co., Houston, Tex. and Dow Chemical Co., Midland, Mich.); and Kraton® rubbers, such as Kraton® 604×, Kraton D-1107, Kraton D-1117, and Kraton D-1113 (Shell Chemical Co., Houston, Tex.). Kraton D-1107 is a predominantly SIS elastomer containing about 15% by weight SI blocks. Kraton D-1320× is an example of a commercially available (SI)_{x I}_{y} multiarmed block copolymer in which some of the arms are polyisoprene blocks. Commercially available butadiene-based elastomers include SBS and/or SB rubbers, such as, Kraton D-1101, D-1102 and D-1118X (Shell Chemical Co.); Solprenes 1205, an SB block copolymer (Housemex, Inc., Houston, Tex.); and Kraton TKG-101 (sometimes called “Tacky G”), a radial block copolymer having an SEBS backbone (E=ethylene block; B=butylene block) and I and/or SI arms.

In a particular embodiment, the adhesive hydrogel composition will also include a tackifying resin, i.e., a relatively low molecular weight resin (weight average molecular weight generally less than about 50,000), having a fairly high glass transition temperature. Tackifying resins include, for example, rosin derivatives, terpene resins, and synthetic or naturally derived petroleum resins. Preferred tackifying resins herein are generally selected from the group of non-polar tackifying resins such as: Regalrez® 1085, a hydrogenated hydrocarbon resin, and Regalite® Resins such as Regalite® 1900 (Hercules); Escorez 1304 and Escorez® 1102, also hydrocarbon resins (Exxon Chemical Co.); and Wingtack® 95 or Wingtack® 85, synthetic polyterpene resins (Goodyear Tire and Rubber). The amount of resin is present in the range of about 5-15 wt %, preferably 7.5-12 wt %, and most preferably 7.5-10 wt %, of the dry hydrogel composition. When increased adhesion is desired, a greater quantity of the resin is preferably used. Ideally, the weight ratio of the resin to the hydrophobic PSA is in the range of approximately 40:60 to 60:40.

C. Hydrogel Compositions Containing an Active Agent

Any of the presently described hydrogel compositions may be modified so as to contain an active agent, and thereby act as an active agent delivery system when applied to a body surface in active agent-transmitting relation thereto. The release of active agents loaded into the present hydrogel compositions typically involves both absorption of water and desorption of the agent via a swelling-controlled diffusion mechanism. Active agent-containing hydrogel compositions may be employed, by way of example, in transdermal drug delivery systems, in wound dressings, in topical pharmaceutical formulations, in implanted drug delivery systems, in oral dosage forms, in teeth whitening strips, and the like.

Suitable active agents that may be incorporated into the present hydrogel compositions and delivered systemically (e.g., with a transdermal, oral, or other dosage form suitable for systemic administration of a drug) include, but are not limited to: analeptic agents; analgesic agents; anesthetic agents; antiarthritic agents; respiratory drugs, including antiasthmatic agents; anticancer agents, including antineoplastic drugs; anticholinergics; anticonvulsants; antidepressants; antidiabetic agents; antidiarrheals; antihelminthics; antihistamines; antihyperlipidemic agents; antihypertensive agents; anti-infective agents such as antibiotics and antiviral agents; antiinflammatory agents; antimigraine preparations; antinauseants; antiparkinsonism drugs; antipruritics; antipsychotics; antipyretics; antispasmodics; antitubercular agents; antiulcer agents; antiviral agents; anxiolytics; appetite suppressants; attention deficit disorder (ADD) and attention deficit hyperactivity disorder (ADHD) drugs; cardiovascular preparations including calcium channel blockers, antianginal agents, central nervous system (CNS) agents, beta-blockers and antiarrhythmic agents; central nervous system stimulants; cough and cold preparations, including decongestants; diuretics; genetic materials; herbal remedies; hormonolytics; hypnotics; hypoglycemic agents; immunosuppressive agents; leukotriene inhibitors; mitotic inhibitors; muscle relaxants; narcotic antagonists; nicotine; nutritional agents, such as vitamins, essential amino acids and fatty acids; ophthalmic drugs such as antiglaucoma agents; parasympatholytics; peptide drugs; psychostimulants; sedatives; steroids, including progestogens, estrogens, corticosteroids, androgens and anabolic agents; smoking cessation agents; sympathomimetics; tranquilizers; and vasodilators including general coronary, peripheral and cerebral. Specific active agents with which the present adhesive compositions are useful include, without limitation, anabasine, capsaicin, isosorbide dinitrate, aminostigmine, nitroglycerine, verapamil, propranolol, silabolin, foridone, clonidine, cytisine, phenazepam, nifedipine, fluacizin, and salbutamol.

For topical drug administration and/or medicated cushions (e.g., medicated footpads), suitable active agents include, by way of example, the following:

Bacteriostatic and bactericidal agents: Suitable bacteriostatic and bactericidal agents include, by way of example: halogen compounds such as iodine, iodopovidone complexes (i.e., complexes of PVP and iodine, also referred to as “povidine” and available under the tradename Betadine® from Purdue Frederick), iodide salts, chloramine, chlorohexidine, and sodium hypochlorite; silver and silver-containing compounds such as silver sulfadiazine, silver protein acetyltannate, silver nitrate, silver acetate, silver lactate, silver sulfate, silver phosphate, silver chloride, and silver sodium hydrogen zirconium phosphate/zinc oxide; organotin compounds such as tri-n-butyltin benzoate; zinc and zinc salts; oxidants, such as hydrogen peroxide and potassium permanganate; aryl mercury compounds, such as phenylmercury borate or merbromin; alkyl mercury compounds, such as thiomersal; phenols, such as thymol, o-phenyl phenol, 2-benzyl-4-chlorophenol, hexachlorophen and hexylresorcinol; and organic nitrogen compounds such as 8-hydroxyquinoline, chlorquinaldol, clioquinol, ethacridine, hexetidine, chlorhexedine, and ambazone.

Antibiotic agents: Suitable antibiotic agents include, but are not limited to, antibiotics of the lincomycin family (referring to a class of antibiotic agents originally recovered from streptomyces lincolnensis), antibiotics of the tetracycline family (referring to a class of antibiotic agents originally recovered from streptomyces aureofaciens), and sulfur-based antibiotics, i.e., sulfonamides. Exemplary antibiotics of the lincomycin family include lincomycin itself (6,8-dideoxy-6-[[(1-methyl-4-propyl-2-pyrrolidinyl)-carbonyl]amino]-1-thio-L-threo-α-D-galactooctopyranoside), clindamycin, the 7-deoxy, 7-chloro derivative of lincomycin (i.e., 7 -chloro-6,7,8-trideoxy-6-[[(1-methyl-4-propyl-2-pyrrolidinyl)carbonyl]amino]-1-thio-L-threo-α-D-galacto-octopyranoside), related compounds as described, for example, in U.S. Pat. No. 3,475,407 to Birkenmeyer, and U.S. Pat. Nos. 3,509,127, 3,544,551 and U.S. Pat. No. 3,513,155 to Kagan et al., and pharmacologically acceptable salts and esters thereof. Exemplary antibiotics of the tetracycline family include tetracycline itself 4-(dimethylamino)-1,4,4α,5,5α,6,11,12α-octahydro-3,6,12,12α-pentahydroxy-6-methyl-1,11-dioxo-2-naphthacenecarboxamide), chlortetracycline, oxytetracycline, demeclocycline, rolitetracycline, methacycline and doxycycline and their pharmaceutically acceptable salts and esters, particularly acid addition salts such as the hydrochloride salts. Exemplary sulfur-based antibiotics include, but are not limited to, the sulfonamides sulfacetamide, sulfabenzamide, sulfadiazine, sulfadoxine, sulfamerazine, sulfamethazine, sulfamethizole, sulfamethoxazole, and pharmacologically acceptable salts and esters thereof, e.g., sulfacetamide sodium.

Antifungal agents: Suitable antifungal agents are undecylenic acid, tolnaftate, miconazole, griseofulvine, ketoconazole, ciclopirox, clotrimazole and chloroxylenol, and chinosol (8-hydroxyquinoline sulfate).

Pain relieving agents: Suitable pain relieving agents are local anesthetics, including, but not limited to, acetamidoeugenol, alfadolone acetate, alfaxalone, amucaine, amolanone, amylocalne, benoxinate, betoxycaine, biphenamine, bupivacaine, burethamine, butacaine, butaben, butanilicaine, buthalital, butoxycaine, carticaine, 2-chloroprocaine, cinchocaine, cocaethylene, cocaine, cyclomethycaine, dibucaine, dimethisoquin, dimethocaine, diperadon, dyclonine, ecgonidine, ecgonine, ethyl aminobenzoate, ethyl chloride, etidocaine, etoxadrol, eucaine, euprocin, fenalcomine, fomocaine, hexobarbital, hexylcaine, hydroxydione, hydroxyprocaine, hydroxytetracaine, isobutylp-aminobenzoate, kentamine, leucinocaine mesylate, levoxadrol, lidocaine, mepivacaine, meprylcaine, metabutoxycaine, methohexital, methyl chloride, midazolam, myrtecaine, naepaine, octacaine, orthocaine, oxethazaine, parethoxycaine, phenacaine, phencyclidine, phenol, piperocaine, piridocaine, polidocanol, pramoxine, prilocalne, procaine, propanidid, propanocaine, proparacaine, propipocaine, propofol, propoxycaine, pseudococaine, pyrrocaine, risocaine, salicyl alcohol, tetracaine, thialbarbital, thimylal, thiobutabarbital, thiopental, tolycaine, trimecaine, zolamine, and combinations thereof. Tetracaine, lidocaine, and prilocalne are preferred pain relieving agents herein.

Other topical agents that may be delivered using the present hydrogel compositions as drug delivery systems include the following: keratolytic agents, such as salicylic acid, lactic acid and urea; vesicants such as cantharidin; anti-acne agents such as organic peroxides (e.g., benzoyl peroxide), retinoids (e.g., retinoic acid, adapalene, and tazarotene), sulfonamides (e.g., sodium sulfacetamide), resorcinol, corticosteroids (e.g., triamcinolone), alpha-hydroxy acids (e.g., lactic acid and glycolic acid), alpha-keto acids (e.g., glyoxylic acid), and antibacterial agents specifically indicated for the treatment of acne, including azelaic acid, clindamycin, erythromycin, meclocycline, minocycline, nadifloxacin, cephalexin, doxycycline, and ofloxacin; skin-lightening and bleaching agents, such as hydroquinone, kojic acid, glycolic acid and other alpha-hydroxy acids, artocarpin, and certain organic peroxides; agents for treating warts, including salicylic acid, imiquimod, dinitrochlorobenzene, dibutyl squaric acid, podophyllin, podophyllotoxin, cantharidin, trichloroacetic acid, bleomycin, cidofovir, adefovir, and analogs thereof; and anti-inflammatory agents such as corticosteroids and nonsteroidal anti-inflammatory drugs (NSAIDs)such as ketoprofen, flurbiprofen, ibuprofen, naproxen, fenoprofen, benoxaprofen, indoprofen, pirprofen, carprofen, oxaprozin, pranoprofen, suprofen, alminoprofen, butibufen, fenbufen, and tiaprofenic acid.

For topical and transdermal administration of some active agents, and in wound dressings, it may be necessary or desirable to incorporate a permeation enhancer into the hydrogel composition in order to enhance the rate of penetration of the agent into or through the skin. Suitable enhancers include, for example, the following: sulfoxides such as dimethylsulfoxide (DMSO) and decylmethylsulfoxide (C₁₀MSO); ethers such as diethylene glycol monoethyl ether (available commercially as Transcutol®) and diethylene glycol monomethyl ether; surfactants such as sodium laurate, sodium lauryl sulfate, cetyltrimethylammonium bromide, benzalkonium chloride, Poloxamer (231, 182, 184), Tween (20, 40, 60, 80) and lecithin (U.S. Pat. No. 4,783,450 to Fawzi et al.); the 1-substituted azacycloheptan-2-ones, particularly 1-n-dodecylcyclaza-cycloheptan-2-one (Azone® available from Nelson Research & Development Co., Irvine, Calif.; see U.S. Pat. No. 4,557,934 to Cooper, and U.S. Pat. Nos. 3,989,816, 4,316,893, and 4,405,616 to Rajadhyaksha); alcohols such as ethanol, propanol, octanol, decanol, benzyl alcohol, and the like; fatty acids such as lauric acid, oleic acid and valeric acid; fatty acid esters such as isopropyl myristate, isopropyl palmitate, methylpropionate, and ethyl oleate; polyols and esters thereof such as propylene glycol, ethylene glycol, glycerol, butanediol, polyethylene glycol, and polyethylene glycol monolaurate (PEGML; see, e.g., U.S. Pat. No. 4,568,343 to Leeper et al.); amides and other nitrogenous compounds such as urea, dimethylacetamide, dimethylformamide, 2-pyrrolidone, 1-methyl-2-pyrrolidone, ethanolamine, diethanolamine and triethanolamine; terpenes; alkanones; and organic acids, particularly salicylic acid and salicylates, citric acid and succinic acid. Mixtures of two or more enhancers may also be used.

Alternatively, an active agent-containing hydrogel composition may be incorporated into a delivery system or patch, for example a transdermal drug delivery device. Exemplary systems contain a drug reservoir, an outwardly facing backing layer, and a means for affixing the system to a body surface. In manufacturing such systems, the hydrogel adhesive composition may be cast or extruded onto a backing layer or release liner, and then serves as the skin-contacting face of the system. The hydrogel composition may also be used as an active agent reservoir within the interior of such a system, with a conventional skin contact adhesive laminated thereto to affix the system to a patient's body surface.

Systems for the topical, transdermal, or transmucosal administration of an active agent typically may contain on of more of the following: a reservoir containing a therapeutically effective amount of an active agent; an adhesive means for maintaining the system in active agent transmitting relationship to a body surface; a backing layer; and a disposable release liner that covers the otherwise exposed adhesive, protecting the adhesive surface during storage and prior to use. In many such devices, the reservoir can also serve as the adhesive means, and the hydrogel compositions of the invention can be used as the reservoir and/or the adhesive means.

Any number of active agents can be administered using such delivery systems. Suitable active agents include the broad classes of compounds normally delivered to and/or through body surfaces and membranes, as described above. With some active agents, it may be necessary to administer the agent along with a permeation enhancer in order to achieve a therapeutically effective flux through the skin.

Accordingly, an active agent-containing composition is incorporated into the reservoir, either during manufacture of the system or thereafter. The composition will contain a quantity of an active agent effective to provide the desired dosage over a predetermined delivery period. The composition will also contain a carrier (e.g., a vehicle to solubilize the active agent), a permeation enhancer, if necessary, and optional excipients such as colorants, thickening agents, stabilizers, surfactants and the like. Other agents may also be added, such as antimicrobial agents, to prevent spoilage upon storage (i.e., to inhibit growth of microbes such as yeasts and molds). Suitable antimicrobial agents are typically selected from the group consisting of the methyl and propyl esters of p-hydroxybenzoic acid (i.e., methyl and propyl paraben), sodium benzoate, sorbic acid, imidurea, and combinations thereof.

The delivery system may be “monolithic,” meaning that a single layer serves as both the active agent-containing reservoir and the skin contact adhesive. However, the reservoir and the skin contact adhesive may be separate and distinct layers. Also, more than one reservoir may be present, each containing a different component for delivery into the skin. The present hydrogel compositions may be used as any or all of the aforementioned layers.

The backing layer of the drug delivery system functions as the primary structural element of the transdermal system, and preferred backing materials in transdermal drug delivery devices are well known in the art. Additional layers, e.g., intermediate fabric layers and/or rate-controlling membranes, may also be present in a transdermal drug delivery system. Fabric layers may be used to facilitate fabrication of the device, while a rate-controlling membrane may be used to control the rate at which a component permeates out of the device. The component may be a drug, a permeation enhancer, or some other component contained in the drug delivery system.

In any of these systems, it may be desirable to include a rate-controlling membrane in the system on the body surface side of the drug reservoir. The materials used to form such a membrane are selected to limit the flux of one or more components contained in the drug formulation, and the membrane may be either microporous or dense. Representative materials useful for forming rate-controlling membranes include polyolefins such as polyethylene and polypropylene, polyamides, polyesters, ethylene-ethacrylate copolymer, ethylene-vinyl acetate copolymer, ethylene-vinyl methylacetate copolymer, ethylene-vinyl ethylacetate copolymer, ethylene-vinyl propylacetate copolymer, polyisoprene, polyacrylonitrile, ethylene-propylene copolymer, polysiloxane-polycarbonate block copolymer, and the like.

The compositions of the invention may also serve to deliver an active agent using other routes of administration. For example, the compositions may be formulated with excipients, carriers, and the like, suitable for oral administration of an orally active drug. The compositions may also be used in buccal and sublingual drug delivery, insofar as the compositions can adhere well to moist surfaces within the mouth. In buccal and sublingual systems, hydrolyzable and/or bioerodible polymers may be incorporated into the compositions to facilitate gradual erosion throughout a drug delivery period. Still other types of formulations and drug delivery platforms may be prepared using the present compositions, including implants, rectally administrable compositions, vaginally administrable compositions, and the like.

Examples of hydrogel formulations suitable for use in drug delivery are presented in Example 11.

D. Hydrogels as Wound Dressings

In one embodiment of the invention, the hydrogel compositions are used as absorbent materials in a wound dressing. The hydrogel compositions are prepared so that they are substantially nontacky, or at most slightly tacky, when applied to the body surface. The hydrogel composition may be formulated so as to contain a pharmacologically active agent. Preferred active agents, in this embodiment, include bacteriostatic and bactericidal agents, antibiotic agents, pain-relieving agents, and cytokines, as well as the following:

Topical Vasodilators: Such compounds are useful for increasing blood flow in the dermis, and preferred topical vasodilators are those known as rubefacients or counterirritants. Rubefacient agents include nicotinic acid, nicotinates such as methyl, ethyl, butoxyethyl, phenethyl, and thurfyl nicotinate, as well as essential oils such as mustard, turpentine, cajuput and capsicum oil, and components thereof. Particularly preferred such compounds include, but are not limited to, methyl nicotinate, nicotinic acid, nonivamide, and capsaicin.

Proteolytic enzymes: Proteolytic enzymes are effective wound cleansing agents, and include, for example, pepsin, trypsin, collagenase, chymotrypsin, elastase, carboxypeptidase, aminopeptidase, terrilytine, and the like.

Peptides, proteins, and amino acids: Suitable peptides and proteins are tissue-healing enhancing agents (also referred to in the art as “tissue regenerative agents”) such as collagen, glycosaminoglycans (e.g., hyaluronic acid, heparin, heparin sulfate, chondroitin sulfate, etc.), proteoglycans (e.g., versican, biglycan), substrate adhesion molecules (e.g., fibronectin, vitronectin, laminin), polypeptide growth factors (e.g., platelet-derived growth factor, a fibroblast growth factor, a transforming growth factor, an insulin-like growth factor, etc.), and other peptides such as osteopontin and thrombospondin, all of which contain the tripeptide sequence RGD (arginine-glycine-aspartic acid), a sequence generally associated with adhesive proteins and necessary for interaction with cell surface receptors.

An exemplary wound dressing contains: an outer backing layer that serves as the external surface of the dressing following application to the body surface; a skin contact adhesive layer laminated thereto, which may or may not be an adhesive hydrogel composition of the invention, optionally containing one or more pharmacologically active agents; an absorbent wound-contacting region comprised of a hydrogel composition of the invention and located on the wound contacting side of the layer; and a removable release liner. Upon removable of the release liner, the dressing is applied to a body surface in the region of a wound, and placed on the body surface so that the wound-contacting region is directly over the wound. In this embodiment, the wound dressing adheres to the skin surrounding the wound as a result of the exposed skin contact adhesive areas surrounding the wound-contacting region. When the wound-contacting hydrogel composition is prepared so that it has some degree of tack prior to absorption of water (as in, e.g., wound exudate), the dressing adheres in the central region as well. It should be noted that any of the hydrogel compositions of the invention may be used as a wound dressing herein, providing that, as noted above, the hydrogel composition is substantially nontacky or at most slightly tacky. Also, those hydrogel compositions that exhibit a high degree of absorbency are preferred.

Another exemplary wound dressing contains a laminated composite of a body facing layer having a body-contacting surface, an outwardly facing backing layer, wherein at least a portion of the body-contacting surface is comprised of a water-insoluble, hydrophilic polymer of the invention, and optionally one or more pharmacologically active agents. The wound dressing may also have a pressure-sensitive adhesive layer between the body-facing layer and the backing layer and/or a removable release liner covering co-extensive with the body-facing surface. The backing layer can be occlusive or non-occlusive. The entire body-contacting surface can be comprised of a hydrogel composition comprising the water-insoluble, hydrophilic polymer of the invention. In a preferred embodiment, the body-facing layer has a perimeter comprised of a skin-contact adhesive and an inner region comprising a hydrogel composition, wherein the hydrogel composition comprises a water-insoluble, hydrophilic polymer of the invention. When the wound dressing has such a perimeter, it is desirable that the inner region further comprises a central, wound-contacting portion, which is comprised of the hydrogel composition.

Examples of hydrogel formulations suitable for use as wound dressings are presented in Example 12.

E. Conductive Hydrogels

The hydrogel compositions of the invention can be rendered electrically conductive for use with biomedical electrodes and in other electrotherapy contexts, i.e., to attach an electrode or other electrically conductive member to the body surface. For example, the hydrogel composition, formulated so as to exhibit pressure-sensitive adhesion, may be used to attach a transcutaneous nerve stimulation electrode, an electrosurgical return electrode, or an EKG electrode to a patient's skin or mucosal tissue. These applications involve modification of the hydrogel composition so as to enhance conductivity and contain a conductive species. In order to enhance conductivity, adding of poly-2-acrylamido-2-methyl propane sulfonic acid can be helpful. Suitable conductive species are ionically conductive electrolytes, particularly those that are normally used in the manufacture of conductive adhesives used for application to the skin or other body surface, and include ionizable inorganic salts, organic compounds, or combinations thereof.

Examples of ionically conductive electrolytes include, but are not limited to, ammonium sulfate, ammonium acetate, monoethanolamine acetate, diethanolamine acetate, sodium lactate, sodium citrate, magnesium acetate, magnesium sulfate, sodium acetate, calcium chloride, magnesium chloride, calcium sulfate, lithium chloride, lithium perchlorate, sodium citrate, sodium chloride, and potassium chloride, and redox couples such as a mixture of ferric and ferrous salts such as sulfates and gluconates. Preferred salts are potassium chloride, sodium chloride, magnesium sulfate, and magnesium acetate, and potassium chloride is most preferred for EKG applications.

Although virtually any amount of electrolyte may be present in the adhesive compositions of the current invention, typically the electrolyte is present at a concentration in the range of about 0.1-15 wt % of the hydrogel composition. The procedure described in U.S. Pat. No. 5,846,558 to Neilsen et al. for fabricating biomedical electrodes may be adapted for use with the hydrogel compositions of this invention. Other suitable fabrication procedures may be used as well, as will be appreciated by those skilled in the art.

F. Hydrogels as Cushions and for Other Products Requiring Adhesion to a Body Surface

The hydrogel compositions of the present invention are useful in any number of additional contexts, wherein adhesion of a product to a body surface is called for or desirable. These applications include, for example, pressure-relieving cushions for application to a foot, wherein the cushions may or may not contain active agents for transdermal or topical delivery, e.g., in the treatment of dicubitis, veinous and diabetic foot ulcers, or the like.

Such cushions will generally be comprised of a flexible, resilient outer layer, fabricated from a foam pad or fabric, with a layer of an adhesive hydrogel composition of the invention laminated thereto for application to the skin surface. Suitable cushions include heel cushions, elbow pads, knee pads, shin pads, forearm pads, wrist pads, finger pads, corn pads, callus pads, blister pads, bunion pads, and toe pads.

The hydrogel compositions of the invention are also useful for intraoral applications. Such applications include teeth whitening strips, breath freshener films, sore throat, mouth ulcer/canker sore, anti-gingivitis.

The hydrogel compositions of the invention are also useful in a host of other contexts, e.g., as adhesives for affixing medical devices, diagnostic systems and other devices to be affixed to a body surface, and in any other application wherein adhesion to a body surface is necessary or desired. The hydrogel compositions can be used as sealants for ostomy devices, prostheses, and face masks, as sound, vibration or impact absorbing materials, as carriers in cosmetic and cosmeceutical gel products, and will have other uses known to or ascertainable by those of ordinary skill in the art, or as yet undiscovered.

Examples of hydrogel formulations suitable for such uses are presented in Example 13.

G. Hydrogels as Liquid Film-Forming Compositions

The hydrogel compositions described above, for example, Samples 111-137, are designed for the application to body surfaces in a form of flexible, elastic adhesive films. However, since all the components of such hydrogels are soluble in a range of common solvents (e.g. water and alcohols), those can be also applied to the body surfaces either in a swollen state or in the form of liquid solutions, giving elastic adhesive films in the course of drying at application site.

A similar approach (but with other necessary active agents) is also suitable for the preparation of liquid bandages, e.g., liquid film-forming compositions for the treatment of cold sores, canker sores, and so forth. In all these cases, a thin elastic adhesive film is formed at the skin surface, protecting the application site from aggressive action of environment (water, microbial flora) and gradually releasing the active agents. The major distinctive feature of the products designed for skin application is that the film, formed at the skin surface upon solvent vaporization, should be water-insoluble. In addition, it may be preferred that the film have minimal water-swellability, whereas the hydrogels described above should be swellable in water. To provide this property, a water-insoluble film-forming polymer can be incorporated into formulation.

Accordingly, a liquid film-forming composition of the invention comprises a water-insoluble film-forming polymer; and a composition selected from:

(a) a water-insoluble, crosslinked hydrophilic adhesive polymer prepared by polymerization of a composition consisting essentially of a hydrophilic monomer and a dual-function monomer that both undergoes polymerization with the hydrophilic monomer and provides covalent crosslinks in the polymer;

(b) a water-soluble, hydrophilic adhesive polymer that is free of covalent crosslinks, wherein the polymer is prepared by polymerization of a composition consisting essentially of a hydrophilic monomer and an acrylic acid monomer esterified with a hydrophilic side chain; and

(c) a water-insoluble, hydrophilic adhesive polymer blend, that is free of covalent crosslinks, consisting essentially of: at least one hydrophilic long-chain polymer and at least one amphiphilic crosslinker.

Suitable water-insoluble film-forming polymers include, by way of illustration and not limitation, acrylate-based polymers and copolymers, polyvinylacetate, ethylene-vinylacetate copolymers, alkyl cellulose, nitrocellulose, and polysilicones.

Particularly suitable water-insoluble film-forming polymers are acrylate polymers formed from acrylic acid, methacrylic acid, methyl acrylate, ethyl acrylate, methyl methacrylate, ethyl methacrylate, and/or other vinyl monomers. One such acrylate copolymer is available under the tradename “Eudragit RS” from Rohm Pharma Polymers, which is a copolymer of trimethylammonioethylmethacrylate chloride (0.1) with ethylacrylate (1) and methylmethacrylate (2). Plasticizers for the water-insoluble film-forming polymers may also be included, for example, tributylcitrate.

H. Manufacture of Hydrogels

The hydrogel compositions of the invention are generally melt extrudable, and thus may be prepared using a simple blending and extruding process. The components of the composition are weighed out and then admixed, for example using a Brabender or Baker Perkins Blender, generally, although not necessarily, at an elevated temperature, e.g., about 90-140° C. Solvents may be added. The resulting composition can be extruded using a single or twin extruder, or pelletized. Preferably, the composition is extruded directly onto a substrate, such as, a backing layer or release liner, and then pressed. The thickness of the resulting hydrogel-containing film, for most purposes, will be in the range of about 0.20-0.80 mm, more usually in the range of about 0.37-0.47 mm.

Alternatively, the hydrogel compositions may be prepared by solution casting, by admixing the components of the composition in a suitable solvent, e.g., a volatile solvent such as ethanol, methanol, or isopropanol, at a concentration typically in the range of about 35-60 wt/vol %. The solution is cast onto a substrate, such as, a backing layer or release liner, as above. Both admixture and casting are preferably carried out at ambient temperature. The substrate coated with the hydrogel film is then baked at a temperature in the range of about 80-100° C., preferably about 90° C., for a time period in the range of about 1-4 hours, preferably about 2 hours.

When tacky hydrogel compositions are desired, melt extrusion is the preferred process, although solution casting may still be used. For preparation of substantially nontacky hydrogel compositions, solution casting is preferred. Also, melt extrusion can be used for any of the hydrogel compositions of the present invention, whether or not the compositions contain a hydrophobic phase, a continuous hydrophilic phase, or a discontinuous hydrophilic phase. Solution casting is generally, although not necessarily, limited to hydrogel compositions that are entirely composed of a hydrophilic phase. Also, either melt extrusion or solution casting techniques can be used to prepare translucent hydrogels, although solution casting is typically preferred in this case.

The following examples are put forth so as to provide those of ordinary skill in the art with a complete disclosure and description of how to make and use the polymers and compositions of the invention, and are not intended to limit the scope of what the inventors regard as their invention. Efforts have been made to ensure accuracy with respect to numbers (e.g., amounts, temperatures, etc.), but some errors and deviations should be accounted for. Unless indicated otherwise, parts are parts by weight, temperature is in degrees Celsius (° C.), and pressure is at or near atmospheric.

### EXAMPLES

### General Methods

Adhesive joint strength of adhesive hydrogels, having a thickness of 100 mm, was evaluated by 180° peeling test with an Instron 1221 Tensile Strength Tester at the peeling rate of 10 mm/min. A low-density polyethylene (PE) film, having crystallinity 45%, contact angle 105°, and surface energy 28.5 mJ/m², was employed as a standard substrate. The adhesives were saturated with water by equilibrating in desiccators with controlled pressure of water vapor of 50% at ambient temperature for 6-7 days. The time to attain a maximum strength of adhesive contact with the substrate was about 15-20 minutes. The character of adhesive joint failure was observed with a TV camera interfaced to an IBM computer and photographed with a microscope. The locus of failure was ascertained by contact angle measurement of the detached substrate surface.

Phase behavior of the hydrophilic polymers blends with PEG-400 over an entire composition range was investigated by Differential Scanning Calorimetry (DSC) using a Mettler TA 4000/DSC-30 differential scanning calorimeter calibrated with indium and gallium. In the DSC apparatus, the samples were first quench cooled with liquid nitrogen from ambient temperature to −100° C. over 2-3 minutes and then heated up at a rate of 20° C./minute to 220° C. Upon heating the blends, a heat capacity jump followed by a single exotherm coupled with a symmetric endotherm, and a high temperature endotherm were normally observed. These four transitions were respectively attributed to the glass transition, PEG cold crystallization, melting, and water thermodesorption (see Feldstein et al. (2000) Polymer 41(14):5327-5359). The glass transition temperatures were recorded at half-height of the relevant heat capacity jumps in DSC heating thermograms. All reported values are the average of replicate experiments varying less than 1-2%. Samples (between 5-15 mg) were sealed in standard aluminum pans supplied with pierced lids so that absorbed moisture could evaporate upon heating. An argon purge (50 mL/minute) was used to avoid moisture condensation at the sensor. The content of absorbed water in the blends was determined by weighing the samples before and after DSC scans using a Mettler Analytical Balance, AE 240, with an accuracy of ±0.01 mg. Weight loss of the sample after scanning was compared to the amount of desorbed water evaluated from the enthalpy change associated with water evaporation from the sample by DSC.

Water vapor sorption: Adhesive films were equilibrated at room temperature in desiccators over aqueous H₂SO₄ solutions of controlled density, which maintained the required relative humidity ranged from 10 to 90%. Equilibrium water sorption was measured gravimetrically and confirmed with a vacuum assembly containing a quartz-spring microbalance.

Viscoelastic properties and the durability of adhesive joints of adhesive hydrogels were studied using a squeeze-recoil technique on a DTDM thermomechanical analyzer (microdilatometer) as described by Kotomin et al. (1999) Polym Mater. Sci. Eng. 81:425-426 and Kotomin et al. (2000) Proceed. 23^{rd} Adhesion Soc. Annual Meeting, Myrtle Beach, S.C., pp. 413-415. The polymer samples were placed between two flat silica surfaces formed by a loading rod and a supporting plate and subjected to the action of a fixed compressive load, followed by removing the compressive load to allow sample relaxation. As a measure of adhesion, the durability (t*, sec) of adhesive joints under a fixed detaching force of 0.92 N was employed. The adhesive durability was defined as the time required to fracture the adhesive joint under a standard value of detaching force (0.92 N). The longer the durability, the higher the adhesion as assessed in terms of a conventional peel test.

Relaxation properties of adhesive hydrogels were studied with the squeeze-recoil technique under test conditions modeling an adhesive bond formation. A sample was squeezed under fixed normal force of 1-500 g, applied to a cylindrical quartz rod with flat end of 6-mm in diameter, and the kinetics of rod displacement was measured with an accuracy of 1 μm. Upon the removal of the compressive force, the sample was allowed to relax and to recover its initial thickness either fully or partly. The retardation times coupled with corresponding moduli were evaluated using equation (1) in terms of compliance.

$$J = {J}_{0} + {\sum }_{i = 1}^{i = n} {J}_{i} ( 1 - {ⅇ}^{- t / {τ}_{i}} ) \qquad ( 1 )$$

where Jᵢ is the compliance (Pa⁻¹) in i-element of a structure, τ-is the retardation time(s). Corresponding values of relaxation moduli, G, were evaluated with Eq. (1) as the reciprocal of the compliance. When t=∞, then J₀=0.

Probe tack measurements were provided from a stainless steel probe having a diameter of approximately 0.5 cm using the following conditions: applied contact weight of 177 g, dwell time of 10 seconds, withdrawal speed of 5.0 cm/sec.

Mechanical properties under uniaxial drawing were examined with an Instron 1222 Tensile Tester at ambient temperature. Dumbbell-shaped samples of the total length of 21 mm with a nip-to-nip distance of 10 mm were cut from rectangular films of 0.5-0.7 mm in thickness. The width of a necked region was 5 mm. The tensile strength of the samples was determined at a fixed cross head speed ranging from 10 to 100 mm per minute, 10 N full scale load. The nominal tensile stress was defined as a stretching force normalized by the original cross-section area of the sample.

The ultimate tensile strength was the maximum force applied (to breaking) divided by the cross-sectional area of the sample. Elongation at break was calculated by dividing the distance that the cross head of the Instron tensile tester had traveled to sample break by the original length of the sample. All reported stress-strain curves were reproduced in replicate experiments, varying less than 10%.

Determination of adhesive blend swell ratio: Network density and free volume in covalently crosslinked, insoluble gels were characterized in terms of the swell ratio (SwR). The larger the swell ratio, the higher the free volume, and the lower the crosslinking density. The swell ratio measured for the UV-crosslinked hydrogels was calculated using equation (2) as follows:

SwR=Swollen adhesive blend weight/Dry adhesive blend weight (2)

The swollen weight was measured after having immersed a sample (disc) of adhesive blend in distilled water for 24 hours at room temperature, removing the swollen adhesive blend, gently removing excess free water clinging to the adhesive blend surface, and then weighing the sample. The dry weight was measured after having placed the swollen adhesive blend sample in an oven at 45° C. for 24 hours.

### Materials

Procedure for UV-curing of hydrophilic polymers: PVP K-90 (BASF), PEG-400, crosslinking promoters (e.g., SR-399 and PEG-400 diacrylate (SR-344)), as well as a photoinitiator (e.g., dicumyl peroxide (DCP)), were first dissolved in ethanol. Solutions (100 nL) were then cast on silicone-coated release liners and allowed to dry overnight at room temperature. Films were then dried at 70° C. for 2 hours to completely remove the solvent. Lastly, dry films were exposed to UV light using the Fusion F300 Lamp (H-bulb) for 1 pass at 3 in/min. In the first batch, the dry film thickness varied between about 0.2-0.3 mm, and in the second batch varied between about 0.6-0.8 mm.

Preparation of VP polymers with PEG-400 Diacrylate (PEGDA) and PEG-360 Monomethacrilate (PEGMMA) as well as triple VP-PEGDA-PEGMMA polymers was performed by radical polymerization of relevant monomers in aqueous solutions, taking a redox system ammonium persulfate (i.e., N,N,N′,N′,-tetramethylethylenediamine) as an initiator. Molar ratios of monomers in copolymer varied from 100:2 of VP:PEGDA (PEGMMA) to 0:100 of VP:PEGDA (PEGMMA). For triple copolymers of VP with PEGDA and PEGMMA, the molar ratio ranged from 100:2:50 to 100:5:50. When the total initial concentration of monomers in solution was 20 wt %, a highly crosslinked water insoluble polymerization products was obtained, most likely due to a chain transfer reaction. The VP copolymers with PEGDA were, in this case, white in color, whereas the VP-PEGMMA copolymers were transparent. When the total initial monomer concentration in the mixture was about 5 wt %, the VP-PEGDA copolymers and triple VP-PEGDA-PEGMMA copolymers were only slightly crosslinked and developed appreciable adhesion toward the glass walls of the reactor vessel. The VP-PEGMMA copolymers were, in the latter case, water-soluble (non-crosslinked). The copolymers were purified from residual monomers by sevenfold washing with twice-distilled water.

### Example 1

### Adhesion as a Function of Crosslinking Density and Length of Crosslinks

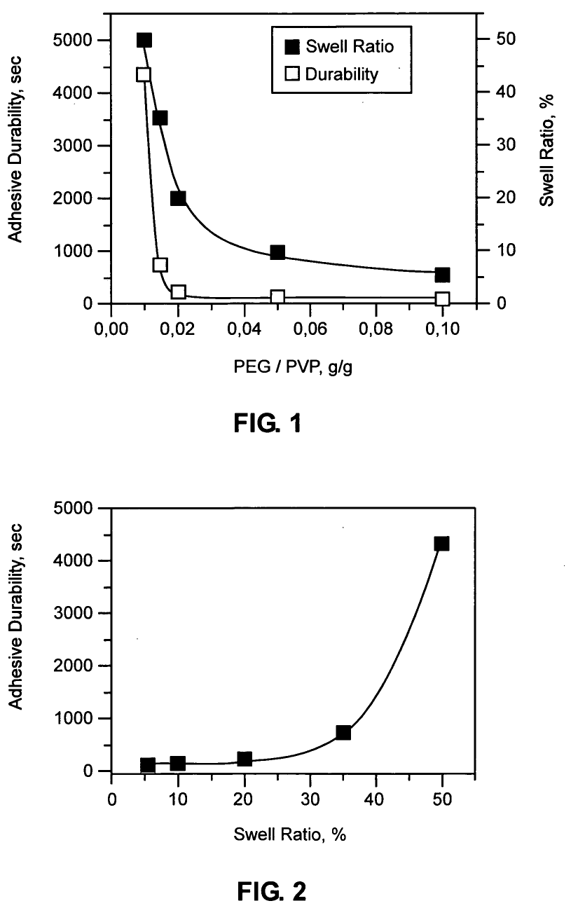

Generally, for high adhesion, strong cohesive interactions have to be counterbalanced with a large free volume. FIG. 1 shows the crosslinking density (free volume) and adhesive durability, t*, as effected by covalently crosslinked PVP-PEG adhesive blends. Crosslinking density was evaluated in terms of swell ratio and adhesive durability was measured using a squeeze-recoil test. Samples of PVP-PEG-400 blends, with the chemical curing agent dipentaerythritol pentaacrylate (SR-399), were crosslinked by photopolymerization. Both swell ratio and adhesive durability decreased with a higher content of the dual-function monomer and/or crosslinking promoter (i.e., crosslinker). PVP blends with PEG-400, containing no covalent crosslinks, was previously demonstrated to provide high adhesion.

FIG. 2 demonstrates the effect of free volume on adhesive durability of UV-cured PVP-PEG adhesive blends. Hydrogels having a swell ratio of less than 20% exhibited no adhesion. For proper pressure-sensitive adhesion, hydrogels preferably have swell ratios of about 30% and higher. The swell ratio of cured adhesives are preferably not higher than about 50%, since the larger the swell ratio, the lower the adhesive durability. In this way, a swell ratio value of about 50% distinguishes pressure-sensitive adhesives from bioadhesives, which typically have 180° C. peel adhesion lower than 50 N/m and swell ratios higher than about 50%, which provide good tack but insufficient cohesive durability of swollen polymer.

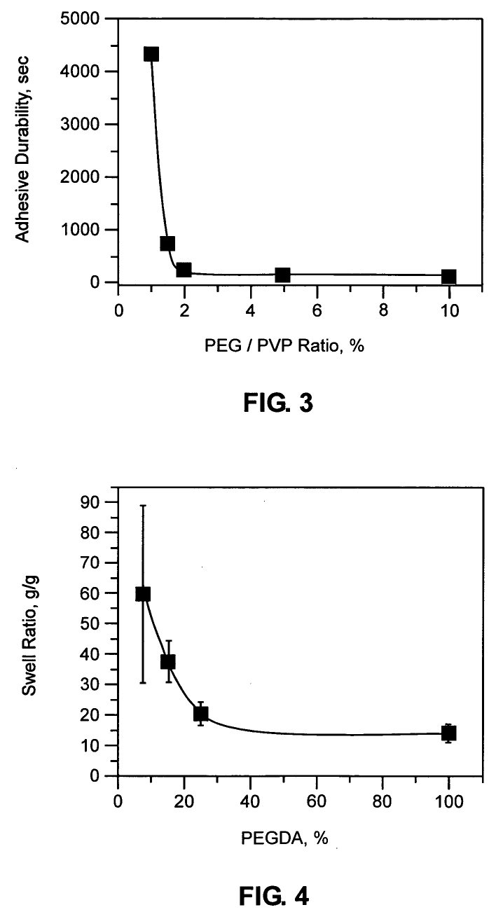

FIG. 3 shows the effect of crosslinking density on adhesive durability of cured PVP-PEG adhesive blends that include the curing agent, SR-399. Covalent crosslinking is capable of maintaining adhesion of cured PVP-PEG hydrogels when the swell ratio is about 50%. This was achieved in PVP-PEG adhesive blends when the SR-399/PVP K-90 ratio was nearly 0.01 g/g (FIG. 3).

Table 1 displays the compositions of UV-cured PVP-PEG adhesive blends and the results of their examination in terms of swell ratio and adhesive durability under a fixed detaching force of 0.92 N.

TABLE 1
Composition and properties of crosslinked PVP-PEG adhesive blends

| | Sample | | | | | |
|---|---|---|---|---|---|---|
| Composition | 1 | 2 | 3 | 4 | 5 | 6 |
| PVP (wt %) | 64 | 63.34 | 62.87 | 63.13 | 61.84 | 59.06 |
| PEG (wt %) | 36 | 35.88 | 36.08 | 35.48 | 34.76 | 34.41 |
| SR-399 (wt %) | 0 | 0.647 | 0.921 | 1.26 | 3.09 | 5.94 |
| SR-344 (wt %) | 0 | 0 | 0 | 0 | 0 | 0 |
| DCP (wt %) | 0 | 0.127 | 0.128 | 0.127 | .309 | 0.601 |
| crosslinker/PVP Ratio (%) | 0 | 1 | 1.5 | 2.0 | 5.0 | 10.0 |
| SwR (%) | n.a. | 49.9 | 35.2 | 20.0 | 9.79 | 5.49 |
| t*, sec | 4340 | 4336 | 1440 | 1430 | 128 | 84 |
| Probe tack, g/cm² | 4857 | 2750 | 2439 | 6454 | | |

TABLE 2
Composition and properties of crosslinked PVP-PEG adhesive blends

| | Sample | | | | |
|---|---|---|---|---|---|
| Composition | 7 | 8 | 9 | 10 | 11 |
| PVP (wt %) | 37.85 | 45.77 | 63.54 | 63.33 | 62.86 |
| PEG (wt %) | 61.07 | 51.72 | 30.82 | 25.33 | 0 |
| SR-399 (wt %) | 0.946 | 2.29 | 0 | 0 | 0 |
| SR-344 (wt %) | 0 | 0 | 5.33 | 11.02 | 36.82 |
| DCP (wt %) | 0.126 | 0.229 | 0.317 | 0.317 | 0.315 |
| crosslinker/ | 2.5 | 5.0 | 8.4 | 17.4 | 58.6 |
| PVP Ratio (%) | | | | | |
| SwR (%) | 34.2 | 14.3 | 24.6 | 22.6 | 3.12 |
| t*, sec | 600 | 350 | n.d. | n.d. | 0 |
| Probe tack, g/cm² | 2357 | | | | |

The PVP-PEG adhesive blends were classified according to the type and concentration of covalent crosslinker. Sample 1 was a reference uncured adhesive blend. Samples 2-6 spanned the adhesive blends having a standard PVP/PEG ratio (64:36) cured with SR-399 and having DCP as the photoinitiator, and are arranged in the order of increasing density of crosslinks, which is controlled by crosslinker/PVP ratio. Samples 7 and 8 differ by increased content of PEG-400 in blend, whereas their crosslinker/PVP ratios remain within the ranges described for the other formulations. Samples 9-11 were cured with SR-344, and show the effects of covalent crosslinking density and PVP-PEG ratio on the swell ratio of adhesive blends.

The data for Samples 1-11 shows that adhesion decreases with the increase in crosslinking density and with the decrease of swell ratio and free volume. Oligomeric PEG acts as an enhancer of adhesion and the greater the PEG content at equivalent crosslinking degrees, the higher the adhesion. In PVP-PEG blends, only high molecular weight polymers (i.e., PVP) can be crosslinked. Sol fraction, which defines the content of water-soluble (non-crosslinked) or slightly crosslinked polymer fractions, matches closely the weight fraction of PEG-400 in cured blends, thereby indicating that the PEG remains non-crosslinked. This conclusion is in agreement with earlier established data that in γ-irradiated PVP-PEG mixtures only PVP undergoes crosslinking (see Lucao et al. (1998) Radiat. Phys. Chem. 52:1-6 and U.S. Pat. No. 4,871,490 to Rosiak et al.). Thus, covalent crosslinking has been shown to appreciably affect the subtle balance between free volume and cohesive durability of hydrogels, which is determinative of their adhesive performance. The following data refines the mechanism of manipulating adhesion by covalent crosslinking and hydrogen bonding.

The data listed in Tables 1 and 2 provides quantitative comparison of the contributions of H-bonding and covalent crosslinking to the adhesion. Adhesion can be analyzed by the swell ratio in relation to both PEG-400 content and crosslinker/PVP ratio for the hydrogels cured with SR-344 crosslinking agent (Samples 9-11). This relationship has been shown to obey the following equation, where R²=0.99295:

SwR=(53.48±4.52)−(67.47±9.86)[^{w}PEG-400]−(85.60+0.49)[crosslinker/PVP]

where ^{W}PEG-400 is a weight fraction of PEG-400 in blends. From this equation, it was determined that an increase in both PEG-400 content and crosslinker/PVP ratio decreased the swell ratio in cured PVP-PEG hydrogels. Since, however, the regression coefficient with respect to H-bonding (PEG content) was about 1.25 times lower than that related to the density of the covalent crosslinking, it indicated a stronger covalent crosslinking contribution to cohesive strength from the PVP-PEG hydrogels as compared with H-bonding contribution. Both contributions are nevertheless comparable, eliciting the significance of hydrogen bonds for the adhesive behavior of chemically crosslinked hydrogels.

The relevance of the free volume for adhesive behavior of covalently crosslinked hydrophilic polymers of the invention was also supported by the observation that under equivalent degrees of crosslinking and content of crosslinker in the reactive mixture, the adhesion of polymers crosslinked through considerably longer and more flexible polymer chains was always higher than for those cured with short, rigid-chain crosslinkers. The compositions of UV-cured films are presented in the Table 3 along with the results of their evaluation. Prepared samples (Samples 12-25) were evaluated in terms of swell ratio and sol fraction (the fraction of soluble polymer).

TABLE 3
Properties of PVP-PEG blends UV-cured with different
cross-linking agents

| | UV-Curing | Crosslinker type | | Sol |
|---|---|---|---|---|
| Sample | conditions | and % | SwR (g/g) | fraction (%) |
| 12 | 1 pass | SR-399; 3.1 | 16.0 | 54.5 |
| 13 | 2 pass 1 side | | 10.9 | 38.7 |
| 14 | 1 pass 2 side | | 10.7 | 36.4 |
| 15 | 1 pass | SR-415; 3.1 | 97.3 | 64.3 |
| 16 | 2 pass 1 side | | 77.5 | 67.7 |
| 17 | 1 pass 2 side | | 5.3 | 47.8 |
| 18 | 1 pass | SR-415; 10.6 | 45.4 | 48.6 |
| 19 | 1 pass 2 side | | 50.2 | 59.5 |
| 20 | 1 pass | SR-351; 3.1 | 34.6 | 29.2 |
| 21 | 2 pass 1 side | | 14.3 | 41.5 |
| 22 | 1 pass 2 side | | 17.8 | 50.0 |
| 23 | 1 pass | SR-351; 8.3 | 8.8 | 67.7 |
| 24 | 2 pass 1 side | | 4.9 | 44.0 |
| 25 | 1 pass 2 side | | 96.4 (85.7) | 68.7 (51.7) |

Among the samples listed in Table 3, higher adhesion and ductility of the cured polymer was shown with SR-415, implying that the major factor controlling the adhesion of cured hydrogels was the crosslinker chain length.

### Example 2

### Properties of UV-Cured Blends of Vinyl Pyrrolidone-Vinyl Acetate Copolymers and poly(N-vinyl Caprolactam) with PEG

To obtain adhesive hydrogels, it is suitable to use, for instance, PVP blends with different hydrophilic polymers for covalent crosslinking by means of low weight, high volume, comparatively long-chain and flexible crosslinking agents. Suitable hydrophilic polymers are the VP-VA copolymers and PVCap, available commercially from BASF as Luviscol polymers. A desirable feature of these polymers is that they possess a LCST in the vicinity of about 37° C., which can be used to form so-called “smart” adhesive hydrogels with stimuli-responsible sorption and adhesive properties.

TABLE 4
Characteristics of network density in UV-cured blends of VP-VA copolymers
(Luviscol) and PVCap with PEG-400

| | | | | | SR- | | | Sol |
|---|---|---|---|---|---|---|---|---|
| | Curing | | PEG | DCP | 399 | SR/ | SwR | fraction |
| Sample | condition | Polymer, % | (%) | (%) | (%) | Polymer | (g/g) | (%) |
| 26 | UV | Luv64, 61.06 | 34.34 | 0.15 | 3.1 | 5 | 72.9 | 87.5 |
| 27 | UV 10 passes | Luv64, 61.71 | 34.71 | 0.5 | 3.3 | 5 | 15.2 | 79.8 |
| | Thermo | | | | | | 23.5 | 88.5 |
| 28 | UV 10 passes | 1Luv/PVP | 34.71 | 0.5 | 3.1 | 5 | 16.0 | 53.4 |
| | Thermo | 64:1, 61.71 | | | | | 29.2 | 63.5 |
| 29 | UV 10 passes | 2Luv/PVP | 34.71 | 0.5 | 3.1 | 5 | 27.4 | 72.1 |
| | Thermo | 64:1, 61.71 | | | | | 30.6 | 52.1 |
| 30 | UV 10 passes | 1Luv/PVP | 34.71 | 0.5 | 3.1 | 5 | 13.7 | 46.9 |
| | Thermo | 64:2, 61.71 | | | | | 31.9 | 60.5 |
| 31 | UV 5 passes | 1Luv/PVP | 33.66 | 1.5 | 5.0 | | 12.9 | 56.9 |
| | UV 10 passes | 64:2 59.84 | | | | | 3.25 | 34.2 |
| 32 | UV 5 passes | 1Luv/PVP | 34.02 | 0.5 | 5.0 | | 15.1 | 53.85 |
| | UV 10 passes | 64:2, 60.48 | | | | | 16.3 | 53.80 |
| 33 | UV 5 passes | Luv73, 64.26 | 32.13 | 0.5 | 3.1 | 5 | 20.0 | 82.3 |
| | UV 10 passes | | | | | | 22.7 | 85.0 |
| 34 | UV 5 passes | Luv73, 63.0 | 31.5 | 1.5 | 3.1 | | 23.7 | 92.0 |
| | UV 10 passes | | | | | | 25.7 | 89.0 |
| 35 | UV 5 passes | PVP K30, | 32.13 | 0.5 | 3.1 | | 35.9 | 80.0 |
| | UV 10 passes | 64.26 | | | | | 34.0 | 85.1 |
| 36 | UV 5 passes | PVCap, | 32.13 | 0.5 | 3.1 | | 48.8 | 96.7 |
| | UV 10 passes | 64.36 | | | | | 27.9 | 93.0 |
| 37 | UV 1 pass | PVP K-90, | 32.13 | 0.5 | 3.1 | | 16.3 | 43.0 |
| | | 64.26 | | | | | | |
| 38 | UV 5 passes | PVP K-90, | NA | 0.5 | 3.1 | | 7.9 | 2.4 |
| | UV 10 passes | 94.6 | | | | | 6.9 | 3.0 |

All the samples in Table 4, except for cured PVP (Sample 38), were found to be highly tacky. Samples 26-27 demonstrated the increased value of cohesive toughness of VP-VA (Luviscol) copolymer blends with PEG-400, which resulted from the covalent curing with SR-399. Actually, the cohesive toughness increased appreciably as compared to the non-crosslinked blends, but the films revealed a less desirable value of fracture strength under extension. UV-curing provided a higher crosslinking degree than thermal curing (see Samples 27-30).

Samples 26-32 used Luviscol 64 as a film-forming polymer. This is a copolymer containing 60% of VP units and 40% of VA units. Samples 28-32 outline the efforts to increase the break strength of adhesive film by mixing Luviscol with high molecular weight PVP K-90. The addition of PVP, created films of acceptable ultimate strength under drawing. The reason for low fracture toughness of the films may be either a low energy of cohesive interaction of VA units (embedded in comparatively low Tg of PVA), or insufficiently high molecular weight of the film-forming polymers, the VP-VA copolymers and PVCap (100,000 g/mol). In an attempt to resolve this issue, in Samples 23 and 24, Luviscol 64 was replaced with Luviscol 73, which contained 70% of strongly interacting VP units and 30% of weaker interacting VA units. This attempt, however, was unsuccessful. Even the cured film of PVCap blend with PEG (Sample 26) was cohesively weak, despite the PVCap, revealing the high values of cohesive interaction energy and Tg. It is believed that use of the low molecular weight film-forming polymer is the cause of this. Actually, when high molecular weight PVP K-90 (1,000,000 g/mol) was replaced with low molecular weight PVP K-30 (40,000 g/mol, Sample 35), an easily breakable adhesive film was obtained. Control films (Samples 37 and 38) provided the necessary fracture strength. As such, both the VP-VA copolymers and PVCap are suitable candidates in order to achieve highly adhesive hydrogels of moderate hydrophilicity. The VP-VA copolymers and PVCap of the higher molecular weight (of the order of magnitude of 1,000,000 g/mol) are preferred.

### Example 3

### Preparation of Interpenetrating Hydrophilic Polymer Networks by Means of Hydrophilic Monomer Polymerization

Interpenetrating hydrophilic polymer networks with adhesive properties can be prepared by UV irradiation of aqueous solutions containing a hydrophilic monomer, a high molecular weight polymer, a crosslinker and, optionally, a photoinitiator alone or in combination with a photosensitizer. Examples of such hydrogels prepared from aqueous solutions containing 70% of water are shown in Table 5. The UV irradiation dose was 10±1 J/cm². The following materials were used in the examples presented in Table 5:

| | |
|---|---|
| PVP | Polyvinylpyrrolidone K90 (from BASF) |
| AAM | Acrylamide (from Sigma) |
| HEMA | 2-Hydroxyethyl methacrylate (from Sigma) |
| PEGDA-700 | polyethyleneglycol diacrylate (from Aldrich) |
| SR-415 | 20 mole ethoxylated trimethylolpropane triacrylate |
| | (from Sartomer) |
| SR-9035 | 15 mole ethoxylated trimethylolpropane triacrylate |
| | (from Sartomer) |
| Photoinitiators: | (1) Irgacure 2959 and (2) Hydrogen peroxide |
| | (3% solution) |

TABLE 5
Network density in UV-cured interpenetrating polymer hydrogels

| | Sample | | | | | | |
|---|---|---|---|---|---|---|---|
| Composition (wt %) | 39 | 40 | 41 | 42 | 43 | 44 | 45 |
| PVP | 52.8 | 54 | 52 | 53.6 | 40.1 | 51 | 49.4 |
| PEG | 26.9 | 26 | 27 | 26 | 20 | 26.2 | 25.3 |
| AAM | 17.7 | 15.7 | 18 | 17.5 | | | |
| HEMA | | | | | 36.5 | 18.2 | 22.5 |
| SR-415 | 2.6 | | | 2.6 | | | |
| SR-9035 | | | 2.5 | | | | 2.4 |
| PEGDA700 | | 4.3 | | | 3 | 4.3 | |
| Irgacure2959 | | | | 0.3 | 0.4 | 0.3 | |
| H₂O₂ | | | 0.5 | | | | 0.4 |
| SwR (g/g) | 53.5 | 35.6 | 40.2 | 44.3 | 14.8 | 29.8 | 20.2 |
| Sol fraction (%) | 40.6 | 38.4 | 37.7 | 38.6 | 55.5 | 61.3 | 35.6 |

### Example 4

### Properties of VP Covalently Crosslinked Through PEGDA

The compositions and properties of synthesized VP-PEGDA copolymer gels are presented in Table 6. The properties of the synthesized products were evaluated in terms of swell ratio, sol fraction, and glass transition temperature. The tackiness of the samples in Table 6 is characterized in terms of “+” symbols. Each + corresponds roughly to the value of detaching stress of 0.25 MPa.

TABLE 6
Properties of VP-PEGDA copolymers

| | Composition | | | | | | |
|---|---|---|---|---|---|---|---|
| | amount of | | | | | | |
| | PEGDA | | | | | | |
| | molecules per | | | | Sol fraction | | |
| Sample | 100 VP units | Mol. Fr. | % wt | SwR (g/g) | (%) | Tg (° C.) | Tack |
| 46 | 2 | 0.02 | 8.4 | | 100 | | + |
| 47 | 7.5 | 0.07 | 25.6 | 88.7 | 53.5 | 8.8 | ++ |
| 48 | (7.0) | | | 30.7 | | | |
| 49 | 15 | 0.13 | 40.7 | 51.4 | 33.5 | −0.7 | +++ |
| 50 | | | | 32.4 | 1.9 | | |
| 51 | | | | (34.2) | 0 | | |
| 52 | | | | 25.2 | | | |
| 53 | | | | 41.0 | 39.7 | 3.2 | |
| 54 | 25 | 0.2 | 53.4 | 20.7 | 4.5 | −6.0 | ++++ |
| 55 | | | | 14.7 | 6.3 | | |
| 56 | | | | 25.6 | 5.2 | −3.8 | |
| 57 | 100 | 1 | 100 | 17.9 | 5.9 | −27.8 | ++ |
| 58 | | | | 10.3 | 3.5 | −21.9 | |

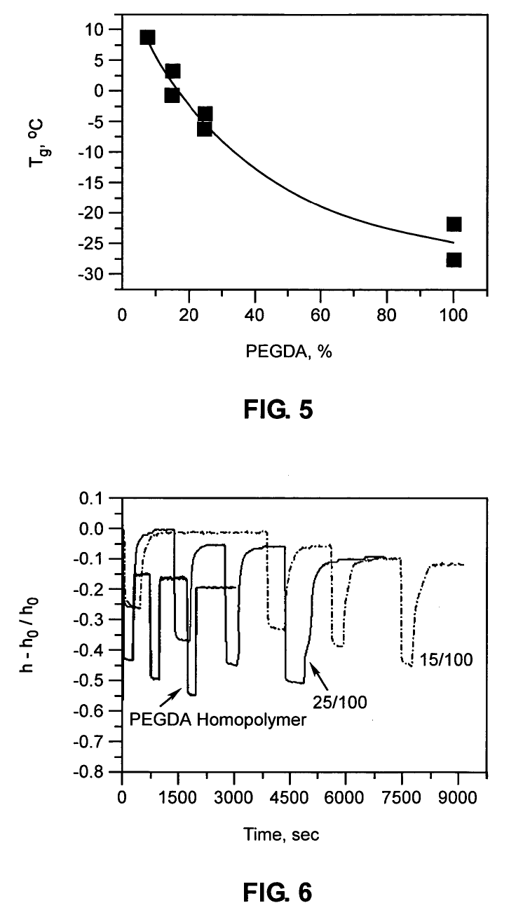

Based on Table 6 and FIGS. 4 and 5, both SwR and Tg are decreasing functions of PEGDA content and crosslinking density in copolymers. An increase in the PEGDA content resulted in the increase of copolymer tack. As expected, the crosslinking density increased with increasing PEGDA content. The higher the PEGDA content, the lower the swell ratio in water (i.e., the denser the network). The amount of slightly crosslinked sol fraction decreased with the increase in crosslinking density.

The VP-PEGDA copolymers represent covalent bonded replicas of hydrogen bonded stoichiometric complex formed in PVP-PEG blends, which possess a network structure and display high adhesion (see Chalykh et al (2002) J. Adhesion 78(8):667-694 and U.S. Pat. No. 6,576,712 to Feldstein et al.). The structure of VP-PEGDA copolymers differed from the structure of the PVP-PEG mixtures in that all the hydrogen-bonded PEG cross-links between longer PVP macromolecules are replaced by covalent bonds. For this reason, comparison of the properties of PVP-PEG blends and VP-PEGDA copolymers was informative on the contribution of hydrogen bonding to performance of hydrophilic adhesives.

The most surprising feature of VP-PEGDA crosslinked copolymers is the Tg behavior (FIG. 5). Although the PVP-PEG blends exhibited two interrelated glass transition temperatures (see Feldstein et al., (2003) Polymer 44(6): 1819-1834), only a single Tg was observed in VP-PEGDA copolymers, signifying that PEG cross-links were homogeneously distributed among PVP units. It is generally recognized, that the higher the network density, the greater the cohesive interactions energy, and the higher the Tg of a polymer. In contrast to this typical Tg behavior, the Tg of the PVP-PEGDA network did not increase, but decreased appreciably with the increase in crosslinking density. It is believed that this apparently abnormal Tg behavior was due to the prevailing contribution of PEG chain length. Every PEG short chain created a space between longer PVP chains in the covalently crosslinked PVP-PEG network, and contributed to the increase in free volume. However, it is also widely known, that the larger the free volume, the lower the Tg. As such, the present results indicate that the PEG contribution to free volume dominates its contribution to the density of network junctions.

Based on the data presented in Table 6 and shown in FIGS. 4 and 5, the swell ratio tended to be a limiting value with the rise of PEGDA content in the crosslinked hydrogel, while the Tg decreased gradually up to 100% PEGDA content. The implication of this finding is that at high PEGDA concentration in copolymers with hydrophilic monomers, the flexible PEG segments were not only capable of crosslinking the long chains of hydrophilic polymers, but the PEGDA could also polymerize with hydrophilic monomers giving the structures of following type:

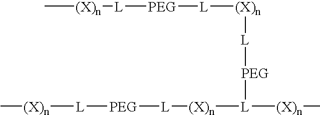

where X is a repeating unit of hydrophilic monomer, n=0-100,000, PEG is the PEG chain segment, and L is a covalent linkage, which in the present case is the acrylic radical, —CH2 —C(CO—O—)—.

These results are of great importance in order to manipulate the adhesion of PVP-PEG covalent networks, since it is known that the network density (cohesive toughness) and free volume have to be in a specific ratio to each other in order to get adhesion. For example, the Tg of the blends that demonstrated perfect adhesion was established to be between about −40 and −60° C.

Viscoelastic properties of synthesized polymers were tested using a squeeze-recoil technique. The squeeze-recoil profiles of the VP-PEGDA copolymers under cyclic compressive loading are presented in FIG. 6 for the copolymers of different VP/PEGDA ratios. Crosslinking PVP through long and flexible PEG-400 chains resulted in material softening. As a rule, the higher the PEGDA content, the softer the material under compressive force, which corresponded to the pattern shown by the dependence of Tg on composition (see FIG. 5). The covalently crosslinked replica of H-bonded PVP-PEG adhesive complex exhibited an average 97% elastic recovery under an increase in the repeating compressive force. In the first loading cycle, the elastic recovery could not be evaluated accurately due to initially non-uniform sample thickness. However, upon removal of compressive force of 1, 2 and 5 N, the sample demonstrated a 97% strain recovery. The higher the PEGDA content the faster the copolymer recovered its initial thickness upon removal of compressive force, i.e., the shorter is the retardation time of the copolymer.

### Example 5

### Effect of Water Adsorption on Adhesive Properties of Crosslinked Hydrogels

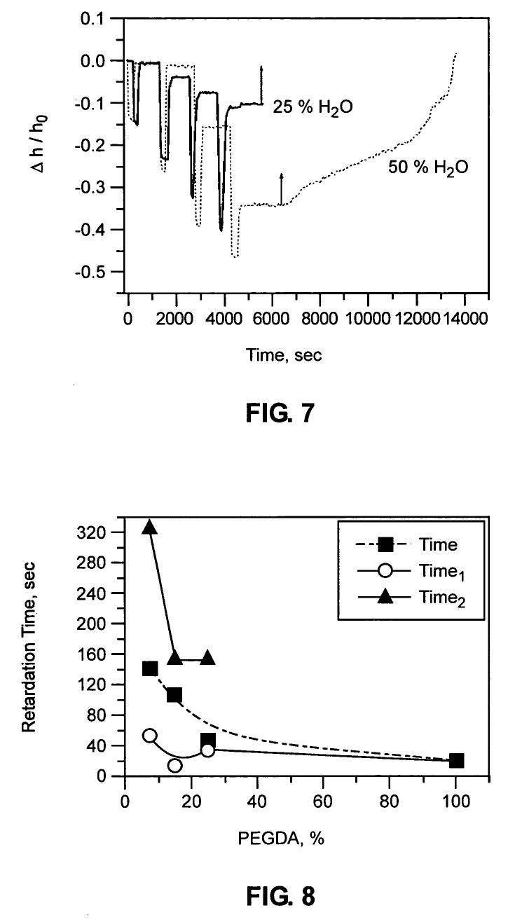

Due to molecular fundamentals of adhesion, both dry and highly swollen VP-PEGDA crosslinked copolymers provided no or slight adhesion, but within the intermediate range of swelling degrees the adhesion became much stronger. Based on the results of the squeeze-recoil test, the adhesion was evaluated in terms of the durability of adhesive joint of crosslinked hydrogel with probe rod under fixed detaching force. 100 PVP monomeric units were crosslinked covalently by 15 PEGDA chains, and the hydrogel, swollen in 25 wt % of absorbed water, was unbound immediately upon detaching stress application (FIG. 7). In contrast, the hydrogel containing 50 wt % of absorbed water became highly tacky and demonstrated adhesive joint durability of 6.840 seconds. When the PVP-PEGDA hydrogel was allowed to uptake as much as 90 wt % of water, it lost its tack.

### Example 6

### Relaxation Properties of Covalently Crosslinked Hydrogels

As has been recently shown (see Novikov et al., Relaxation times featuredfor pressure-sensitive adhesives, Proceed. 26^{th} Annual Meeting of Adhesion Society, 2003, Myrtle Beach, S.C., USA, p. 402-404), although PSAs differ due to their chemical composition, their relaxation behavior are remarkable similar. Under the conditions modeling an adhesive bond formation, two different relaxation times were featured for the PSAs. The shorter relaxation time on the order of 10-50 seconds was associated with elastic recovery of adhesive polymers, whereas the longer relaxation time (100-700 seconds) related to tackiness and ability to flow of PSA polymers.

Based on the data in Table 7, typical SIS-based PSA DURO-TAK 34-4230 (commercially available from the National Starch and Chemicals, Corp.; Sample 59) demonstrated two retardation times of 10-20 and 350-375 seconds, respectively. Adhesive properties of the DURO-TAK 34-4230 PSA were considered as a “gold standard.” The relaxation properties of a hydrophilic PSA, based on a non-covalently crosslinked PVP-PEG blend, followed the same pattern and displayed retardation times of 20-50 and 300-700 seconds, respectively. This PSA provided the best adhesion and contained 36% of PEG-400 (see Sample 62 in Table 8 and Sample 1 in Table 1). With an increase in PEG content, both retardation times tended to increase, while the corresponding moduli revealed appreciable reduction with the rise in PEG concentration (Table 8).

An essential feature of the PSAs examined (Tables 7 and 8) is that the relaxation modulus corresponding to the longer retardation time was always higher than that relating to the shorter retardation time. However, the moduli for a PVP-PEG blend exhibiting the best adhesion (Sample 62) was approximately three times as high as those values for the DURO-TAK 34-4230 PSA. It should be noted that the latter PSA provided higher immediate tack, and that the stickiness of PVP-PEG blends grew with an increase of PEG content. Based on these findings, it was concluded that the absolute values of relaxation moduli outline the criteria for high tack, while the requirement of G₂>G₁ can be considered as the criteria for high adhesion.

TABLE 7
Reference Sample 59: Relaxation properties of DURO-TAK
34-4230 PSA

| Compressive | | Time | | Time₁ | | Time₂ |
|---|---|---|---|---|---|---|
| force (N) | G MPa | (sec) | G₁ MPa | (sec) | G₂ MPa | (sec) |
| 0.5 | 0.37 | 39 | — | — | — | — |
| 1 | 0.25 | 31.7 | 0.30 | 17 | 1.12 | 356 |
| 5 | 0.59 | 28.8 | 0.74 | 10 | 2.48 | 375 |

TABLE 8
Relaxation behavior of uncured PVP blends containing different amounts
of PEG-400 and 8-9% of absorbed water

| | Compressive | | | | Time₁ | | Time₂ |
|---|---|---|---|---|---|---|---|
| Sample | force (N) | G MPa | Time (sec) | G₁ MPa | (sec) | G₂ MPa | (sec) |
| 60 | 1 | 1.27 | 147 | 4.59 | 29 | 1.75 | 165 |
| PVP-PEG 31% | 2 | 1.97 | 89 | 6.67 | 22 | 2.7 | 131 |
| | 5 | 2.52 | 63 | 3.46 | 32 | 7.69 | 298 |
| 61 | 1 | 1.30 | 13 | 1.37 | 11 | 21.74 | 285 |
| PVP-PEG 34% | 2 | 1.59 | 44 | 2.20 | 13 | 4.83 | 134 |
| | 5 | 1.82 | 172 | 3.23 | 59 | 3.45 | 619 |
| 62 | 1 | 1.03 | 70 | 1.25 | 48 | 4.35 | 411 |
| (see Table 1, | 2 | 1.35 | 77 | 2.17 | 26 | 2.94 | 325 |
| Example 1) | 5 | 1.52 | 167 | 2.27 | 68 | 3.77 | 742 |
| PVP-PEG 36% | | | | | | | |
| 63 | 1 | 0.41 | 72 | 0.44 | 38 | 4.76 | 197 |
| PVP-PEG 39% | 2 | 0.40 | 58 | 0.64 | 13 | 0.88 | 284 |
| | 5 | 0.63 | 143 | 0.86 | 80 | 1.32 | 940 |
| 64 | 1 | 0.47 | 52 | 0.69 | 25 | 1.22 | 201 |
| PVP-PEG 41% | 2 | 0.63 | 169 | 1.29 | 47 | 1.04 | 450 |
| | 5 | 0.69 | 282 | 1.18 | 107 | 1.44 | 856 |

Two kinds of relaxation processes were typical for the covalently crosslinked VP-PEGDA copolymers (Table 9). The first one is characterized by a shorter retardation time (average of 30 seconds), and the second process involves the longer time of retardation (150-300 seconds, FIG. 8). In non-crosslinked PVP blends with PEG-400, the adhesion was shown above to be the result of stoichiometric H-bonded network complex formation. In the stoichiometric complex, 15-20% of PVP units were only crosslinked non-covalently through hydrogen bonds with terminal —OH groups at PEG short chains. In this respect, the VP PEGDA copolymer, containing 15 PEGDA chains per 100 VP monomer units (Sample 66) was considered as a replica of PVP-PEG stoichiometric network complex (Sample 62), wherein the H-bonds in PEG crosslinks were replaced with covalent bonds.

Comparing Samples 66 and 62, it was observed that replacing PVP-PEG H-bonding with covalent bonds led to a decrease of both retardation times from 20-50 and 300-400 seconds in H-bonded network complex to 10-30 and 100-200 seconds in the covalently crosslinked replica, respectively. In contrast to the PVP-PEG adhesive H-bonded complex, for covalently crosslinked PVP-PEG network both the G₁ and G₂ moduli were very close in their values and were comparatively low (0.1-0.5 MPa). These values were in conflict with the above stated relaxation criterion for pressure-sensitive adhesion, and indeed, the PVP-PEGDA covalently crosslinked copolymers were shown to be non-adhesive in the dry state.

The shorter retardation time was practically independent of the PEGDA content, whereas the longer time decreased rapidly with the rise of PEGDA content in the range of lower crosslinking density and eventually vanished with the PEGDA homopolymer. Only shorter retardation times were found with the PEGDA homopolymer. This implied that the shorter time described the behavior of PEGDA crosslinks, whereas the longer retardation time was most likely associated with the relaxation of PVP chain segments between neighbor crosslinks.

In accordance with this behavior, the resistance of material to the slower relaxation process (G₂) increased appreciably with the growth of PEGDA content in the copolymer (Table 8). In contrast, the resistance to fast elastic recovery (G₁) was essentially stable for the copolymers containing 25% of PEGDA units and more. Within the region of lower PEGDA content, the modulus of fast elastic recovery demonstrated unstable behavior.

A characteristic feature of the VP-PEGDA crosslinked copolymers was a low value of relaxation modulus. In the agreement with the Dahlquist's criterion of tack, the average (Kelvin-Voigt) relaxation modulus was in the vicinity of about 100,000 Pa, the value typical of soft pressure-sensitive adhesives. Although the VP-PEGDA copolymers were highly crosslinked, the material was very soft due to the appreciable length and flexibility of PEG chains in the PEGDA crosslinks between PVP chains.

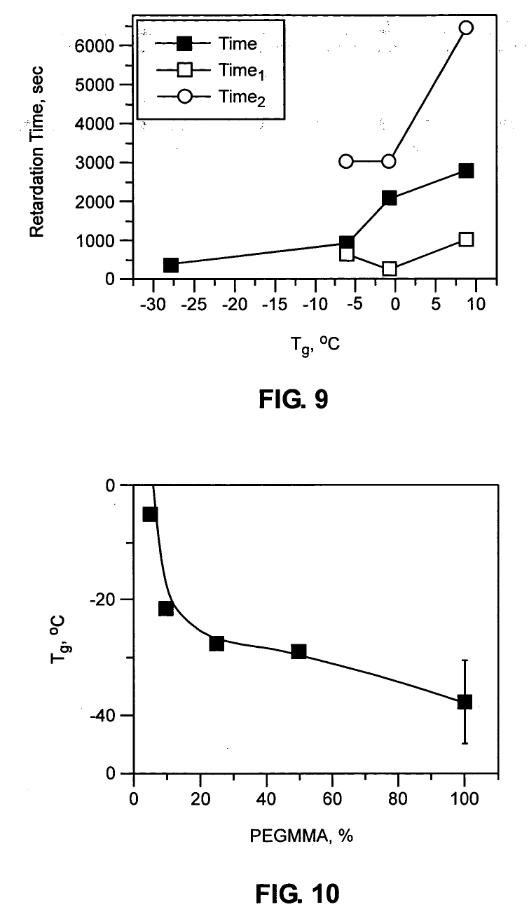

Varying around the value of 100,000 Pa, the relaxation moduli demonstrated no appreciable dependence on the Tg of the VP-PEGDA copolymers. At the same time, the retardation times tended to increase as the Tg value of the VP-PEGDA copolymers increases (FIG. 9).

TABLE 9
Properties of covalently crosslinked VP-PEGDA copolymers in dry state

| | Compressive | | Time | | Time₁ | | Time₂ |
|---|---|---|---|---|---|---|---|
| Sample | force (N) | G MPa | (sec) | G₁ MPa | (sec) | G₂ MPa | (sec) |
| 65 | 0.5 | 0.025 | 83 | 0.03 | 41 | 0.05 | 270 |
| 7.5 PEGDA/100 VP | 1 | 0.033 | 140 | 0.05 | 51 | 0.05 | 324 |
| | 2 | 0.05 | 159 | 0.1 | 41 | 0.1 | 346 |
| 66 | 0.5 | 0.05 | 86 | 0.17 | 26 | 0.10 | 123 |
| 15 PEGDA/100 VP | 1 | 0.10 | 105 | 0.32 | 13 | 0.12 | 152 |
| | 2 | 0.16 | 105 | 0 | | 0 | |
| | 5 | 0.30 | 139 | 1.28 | 27 | 0.39 | 186 |
| 67 | 0.5 | 0.05 | 43 | 0.05 | 23 | 0.19 | 241 |
| 25 PEGDA/100 VP | 1 | 0.1 | 46 | 0.1 | 32 | 0.31 | 152 |
| | 2 | 0.1 | 77 | | | | |
| 68 | 1 | 0.1 | 20 | | | | |
| Homopolymer | 2 | 0.11 | 8 | | | | |
| PEGDA | 5 | 0.23 | 4 | | | | |

The VP-PEGDA copolymers were allowed to swell in water within a wide range of water content (from 0 to 95%), and the viscoelastic and relaxation properties of the swollen hydrogels were examined using the squeeze-recoil analysis (Table 10). Only single retardation time was documented in the swollen hydrogels. With a rise in water uptake, the relaxation modulus tended to increase insignificantly from 30-50 to 100 kPa, whereas the retardation time decreased from 80 to 20 seconds. This behavior was, in essence, unaffected by compressive force, which varied from 0.5 to 2 N.

TABLE 10
Effect of moistening with water on the relaxation properties of
PVP-PEGDA copolymers

| | Compression | | Time | | Time₁ | | Time₂ |
|---|---|---|---|---|---|---|---|
| Sample | force (N) | G MPa | (sec) | G₁ MPa | (sec) | G₂ MPa | (sec) |
| 69 | 0.2 | 0.05 | 44 | | | | |
| 15 PEGDA/100 VP | 0.5 | 0.05 | 50 | 0.1 | 35 | 0.38 | 258 |
| 5% H₂O | 1 | 0.1 | 40 | 0.16 | 17 | 0.23 | 99 |
| | 2 | 0.125 | 70 | | | | |
| 70 | 0.2 | 0.03 | 9.5 | | | | |
| 15 PEGDA/100 VP | 0.5 | 0.03 | 44 | 0.03 | 34 | 0.20 | 149 |
| 10% H₂O | 1 | 0.05 | 40.5 | 0.01 | 10 | 0.10 | 88 |
| | 2 | 0.1 | 77 | 0.14 | 30 | 0.18 | 154 |
| 71 | 0.1 | 0.02 | 39 | | | | |
| 15 PEGDA/100 VP | 0.2 | 0.025 | 29 | | | | |
| 25% H₂O | 0.5 | 0.05 | 92 | | | | |
| | 1 | 0.1 | 121 | | | | |
| 72 | 0.5 | 0.05 | 10 | | | | |
| 15 PEGDA/100 VP | 1 | 0.1 | 18 | | | | |
| 27% H₂O | 2 | 0.1 | 17 | | | | |
| 73 | 0.2 | 0.03 | 9 | | | | |
| 15 PEGDA/100 VP | 0.5 | 0.05 | 32 | | | | |
| 50% H₂O | 1 | 0.1 | 9 | | | | |
| | 2 | 0.1 | 5.2 | | | | |
| 74 | 0.1 | 0.1 | 13 | | | | |
| 15 PEGDA/100 VP | 0.2 | 01 | 14 | | | | |
| 68% H₂O | 0.5 | 0.1 | 33 | | | | |
| 75 | 0.1 | 0.02 | 41 | | | | |
| 15 PEGDA/100 VP | 0.2 | 0.02 | 22 | | | | |
| 74% H₂O | 0.5 | 0.05 | 50 | | | | |
| | 1 | 0.16 | 38 | | | | |
| 76 | 0.2 | 0.05 | 8.7 | | | | |
| 15 PEGDA/100 VP | 0.5 | 0.05 | 14.7 | | | | |
| 75% H₂O | 1 | 0.1 | 24 | | | | |
| | 2 | 0.19230 | 34 | | | | |
| | | 7 | | | | | |
| 77 | 0.1 | 0.05 | 37 | | | | |
| 15 PEGDA/100 VP | 0.2 | 0.05 | 13 | | | | |
| 80% H₂O | 0.5 | 0.1 | 20 | | | | |
| 78 | 0.2 | 0.05 | 14 | | | | |
| 15 PEGDA/100 VP | 0.5 | 0.1 | 17 | | | | |
| 97% H₂O | | | | | | | |
| 79 | 0.2 | 0.19 | 32 | | | | |
| PEGDA | 0.5 | 0.1 | 21 | | | | |
| Homopolymer | 1 | 0.1 | 15 | | | | |
| 5% H₂O | 2 | 0.11 | 5 | | | | |
| 80 | 0.2 | 0.15 | 10 | | | | |
| PEGDA | 0.5 | 0.05 | 10 | | | | |
| Homopolymer 10% | 1 | 0.1 | 6.5 | | | | |
| H₂O | 2 | 0.12 | 8.2 | | | | |
| 81 | 0.2 | 0.025 | 9 | | | | |
| PEGDA | 0.5 | 0.05 | 9 | | | | |
| Homopolymer | 1 | 0.05 | 12 | | | | |
| 25% H₂O | 2 | 0.1 | 9 | | | | |
| 82 | 0.5 | 0.1 | 8 | | | | |
| PEGDA | 1 | 0.12 | 5 | | | | |
| Homopolymer | 2 | 0.23 | 6.6 | | | | |
| 50% H₂O | | | | | | | |
| 83 | 0.2 | 0.02 | 9 | | | | |
| PEGDA | 0.5 | 0.05 | 7 | | | | |
| Homopolymer | 1 | 0.1 | 7 | | | | |
| 75% H₂O | 2 | 0.1 | 8.7 | | | | |

Comparing the data presented in Tables 6 and 10, the VP-PEGDA crosslinked copolymers exhibited some tack, although they did not obey the relaxation criteria for pressure-sensitive adhesion. This apparent contradiction resulted from the fact that the crosslinked VP-PEGDA copolymers behaved as bioadhesives, which are nontacky in dry state, but revealed some tack under swelling. The strength of adhesive joints for bioadhesives was always much lower than for PSAs.

### Example 7

### Compositions and Properties of VP-PEGMMA Comb-like Polymers

TABLE 11
Properties of VP-PEGMMA copolymers

| | Composition | | | | | | |
|---|---|---|---|---|---|---|---|
| | amount of | | | | | | Tack |
| | PEGMMA | | | | | | (Peel |
| | molecules per | Mol. | | SwR | Sol fraction | Tg | Force, |
| Sample | 100 VP units | fraction | % wt | (g/g) | (%) | (° C.) | N/m) |
| 84 | 5 | 0.048 | 14.6 | | | | |
| Radical | | | | | 100 | −5.0 | — |
| polymerization | | | | | | | |
| UVcured* | | | | | 100 | | |
| 85 | 10 | 0.09 | 25.5 | | | | |
| Radical | | | | | 100 | −21.5 | ± |
| polymerization | | | | | | | |
| UVcured* | | | | | 100 | | |
| 86 | 25 | 0.2 | 46.13 | | | | |
| Radical | | | | | 100 | −28.2 | 25 |
| polymerization | | | | | | | |
| UVcured* | | | | 93.7 | 66.6 | | |
| From EtOH | | | | 40.6 | 33.3 | | + |
| From water | | | | | 100 | −26.9 | |
| 87 | 50 | 0.33 | 63.14 | | | | |
| Radical | | | | 46.5 | 32.0 | −29.0 | +++ |
| polymerization | | | | | | | 60 |
| Film** | | | | 25.3 | 30.5 | | |
| 88 | PEGMMA | 0.13 | 100 | | | | |
| Radical | Homo | | | 53.4 | 37.5 | −32.4 | |
| polymerization | polymer | | | 50.0 | 38.1 | | |
| | | | | 88.7 | 61.5 | | |
| | | | | 89.2 | 64 | | ++ |
| Film** | | | | 38.4 | 46.6 | −42.8 | |

*These films contained the crosslinker SR-415, and were prepared from an alcohol solution and UV-cured.
**These films (0.78 mm thick) were prepared from amorphous polymer by hot pressing (100° C.) between two release liners.

The glass transition temperature of the VP-PEGMMA copolymers decreased as a function of the PEGMMA content (Table 11, FIG. 10). The increase in PEGMMA content resulted in increased tack of the copolymers.

The VP-PEGMMA copolymers represent linear comb-like polymers and therefore were expected to have unlimited swelling followed by dissolution in water. However, polymers containing 25 and greater PEGMMA units per 100 VP units (Table 11) exhibited a swell ratio that implied that a crosslinked structure existed between the VP polymers and PEGMMA. This crosslinking of VP and PEGMMA was due to the presence of PEG dimethacrylate in commercial PEGMMA. While the copolymers containing less than 25 PEGMMA units were water soluble, they became only partially soluble as the PEGMMA content approached 25 units. Thus, Sample 79 was soluble in water at low concentration (0.1%). At 10% concentration, this sample was only soluble under heating at 60° C. for 2 hours. Samples 80 and 81 were insoluble. The swell ratio tended to decrease with increasing PEGMMA concentration.

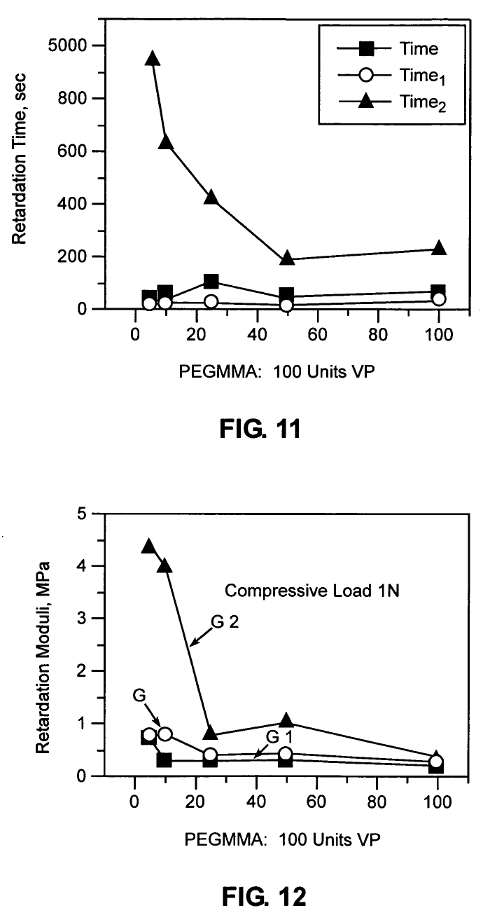

Similar to crosslinked VP copolymers with PEGDA, two distinct relaxation processes are featured in the comb-like VP-PEGMMA polymers. The process of fast elastic recovery was characterized with shorter retardation time and corresponding modulus, which are essentially independent of the VP-PEGMMA composition (FIGS. 11 and 12). In contrast, the retardation times and moduli of slower relaxation for the soluble (non-crosslinked) copolymers containing 5 and 10 PEGMMA per 100 VP units are appreciably higher than those for the swellable hydrogels. In turn, the relaxation modulus for comb-like VP-PEGMMA copolymers were appreciably higher than that for crosslinked VP-PEGDA copolymers (compare Tables 9 and 12).

TABLE 12
Relaxation properties of dry comb-like VP-PEGMMA copolymers

| | Compressive | | Time | | Time₁ | | Time₂ |
|---|---|---|---|---|---|---|---|
| Sample | force (N) | G MPa | (sec) | G₁ MPa | (sec) | G₂ MPa | (sec) |
| 84 | 0.5 | 1.25 | 84 | 0 | | 0 | |
| 5PEGMMA/100VP | 1 | 0.71 | 33 | 0.77 | 24 | 4.35 | 773 |
| | 2 | 1.08 | 109 | 1.45 | 68 | 3.57 | 384 |
| 85 | 0.2 | 0.33 | 113 | 0.00 | | 0.00 | |
| 10PEGMMA/100VP | 0.5 | 0.53 | 53 | 1.23 | 10 | 0.88 | 102 |
| | 1 | 0.98 | 34 | 1.24 | 19 | 4.00 | 207 |
| | 2 | 0.94 | 77 | 1.73 | 18 | 1.92 | 209 |
| 86 | 0.2 | 0.30 | 64 | 0.00 | | 0.00 | |
| 25PEGMMA/100VP | 0.5 | 0.53 | 43 | 0.77 | 26 | 1.50 | 109 |
| | 1 | 0.77 | 86 | 1.20 | 26 | 1.61 | 343 |
| | 2 | 1.22 | 75 | 1.69 | 28 | 3.30 | 445 |
| 87 | 0.5 | 0.63 | 61 | 0.85 | 38 | 2.00 | 170 |
| 50PEGMMA/100VP | 1 | 1.11 | 53 | 2.10 | 8.6 | 2.11 | 147 |
| | 2 | 1.54 | 88 | 2.54 | 26 | 3.25 | 323 |
| | 5 | 2.41 | 106 | 3.83 | 24 | 5.71 | 463 |
| 88 | 0.2 | 0.31 | 23 | 0.32 | 21 | 5.88 | 120 |
| PEGMMA | 0.5 | 0.20 | 79 | 0.40 | 19 | 0.33 | 218 |
| Homopolymer | 1 | 0.22 | 153 | 0.48 | 46 | 0.38 | 310 |
| | 2 | 0.29 | 241 | 0.40 | 134 | 0.77 | 811 |

From the relaxation data presented in Table 12, it was determined that keeping terminal hydroxyl groups in PEG the side chains accessible for hydrogen bonding, led to the desired relaxation properties for pressure sensitive adhesives. All the VP-PEGMMA polymers presented in Table 12 displayed two relaxation times with the values typical for PSAs (10-50 and 300-700 seconds, respectively). The polymers also met the G₂>G₁ criteria. With respect to the absolute values of the G₁ and G₂ moduli, the relaxation modulus G₁ was abnormally high for all the samples except for PEGMMA homopolymer (Samples 84 and 88). The G₁ modulus, as described above, is associated with a faster relaxation process of elastic recovery, and the high resistance to elastic recovery is typical for non-crosslinked polymers. The fact that the PVP-PEG complex free of covalent crosslinks revealed higher compliance toward elastic recovery was, most likely, the result of fixing PEG crosslinks in VP-PEGMMA copolymers at a specific site of the polymer backbone. In PVP-PEG complexes crosslinked through H-bonding, the PEG crosslinks were capable of slipping along the PVP chains under applied mechanical stress, dissipating additional energy.

Although all the moduli increase with increasing Tg value for comb-like copolymers, this effect was much more pronounced for the modulus of slower retardation.

### Example 8

Table 13 shows the influence of compressive force on the squeeze recoil characteristics of the triple VP-PEGMMA-PEGDA (100/50/2) polymer. From the data, it was determined that an average Kelvin-Voigt retardation time and modulus (G) were practically independent of compressive force. Both the shorter and longer retardation times tended to decrease with the force of compression. The relaxation modulus, corresponding to the slower retardation processes (G₁), was in essence unaffected by the change in compressive force. However, the G₂ modulus, which is associated with a fast elastic recovery, increased with the rise in compression force. The most plausible implication of this effect is that the higher the compressive force, the greater the changes in the network structure of the polymer, and the stronger the resistance of material to the elastic recovery.

TABLE 13
Relaxation properties of a triple copolymer containing
50 PEGMMA and 2 PEGDA units per 100 VP units

| Compressive | | time | | Time₁ | | time₂ |
|---|---|---|---|---|---|---|
| force (N) | G Pa | (sec) | G₁ Pa | (sec) | G₂ Pa | (sec) |
| 1 | 1.22 10⁵ | 80 | 1.75 10⁵ | 50 | 3.57 10⁵ | 221 |
| 2 | 2.50 10⁵ | 45 | 3.57 10⁵ | 22 | 8.33 10⁵ | 176 |
| 5 | 3.85 10⁵ | 74 | 1.04 10⁵ | 11 | 5.88 10⁵ | 130 |

In terms of compliance with the relaxation criteria for tack and adhesion, which are specified above, the relaxation properties of the triple PVP-PEGMMA-PEGDA copolymers exhibited decreased value of the longer retardation times, coupled with G₁ and G₂ moduli, which were increased as compared with reference values for typical PSAs. While, the triple VP-PEGMMA-PEGDA copolymers in the dry state provided no adhesion, the adhesion of the triple copolymers appeared with their hydration, passing through a maximum at the middle values of hydration degree.

### Example 9

### Hydrogen Bonding Versus Covalent Bonding in PVP-PEG Blends VP-PEGDA and VP-PEGMMA Polymers

The structure of VP-PEGDA crosslinked polymers is a covalent bonded replica of the structures, which are formed in the PVP-PEG adhesive blends due to the PVP-PEG hydrogen bonding. The VP-PEGDA copolymers exhibited either low or negligible adhesion as compared to the PVP-PEG non-crosslinked blends. When only one terminal hydroxyl group of PEG was replaced by covalent bond leaving an opposite terminal group capable of forming H-bonds (as occurs in VP-PEGMMA comb-like copolymers) the adhesive properties were intermediate between PVP-PEG blends and VP-PEGDA copolymers (see Table 11). Hence, the replacement of transient H-bonds for much stronger and durable covalent bonds resulted in the loss of adhesion. The physical significance of this is that the hydrogen bonds are labile. For this reason, the H-bonded supramolecular structures are able to relax under applied mechanical stress during adhesive joint failure, whereas the covalent bonds, being broken, are incapable to reform anew like H-bonds. This is indicative of the importance of the relaxation processes in order to gain an insight into the adhesive behavior of hydrophilic polymer systems.

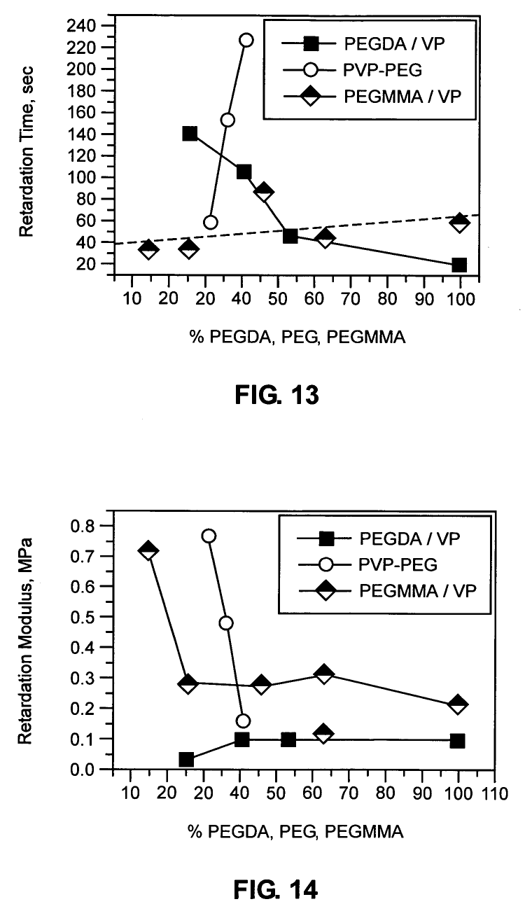

Considering relaxation, the most evident difference between the H-bonded (PVP-PEG) and covalent bonded systems (VP-PEGDA) copolymers was a sharp growth of the Kelvin-Voigt retardation time in the H-bonded systems with the rise of PEG concentration (FIG. 13). The retardation times of the H-bonded structures were much longer compared with those for covalent bonded structures in VP-PEGDA copolymers. In the latter, the increase in PEG content accelerated the process of elastic recovery. It should be noted that the VP-PEGMMA copolymers demonstrated intermediate behavior. In these systems only half of the H-bonds were replaced by covalent bonding.

As seen in FIG. 14, the Kelvin-Voigt modulus in the H-bonded PVP-PEG systems declined rapidly with PEG concentration. The implication of this effect is that the PVP plasticization with PEG facilitates the process of elastic polymer recovery. In contrast, in covalently bonded (VP-PEGDA) systems, the Kelvin-Voigt retardation modulus was practically unaffected by the content of PEG chains, crosslinking the PVP backbones. Again, the VP-PEGMMA systems exhibited intermediate behavior.

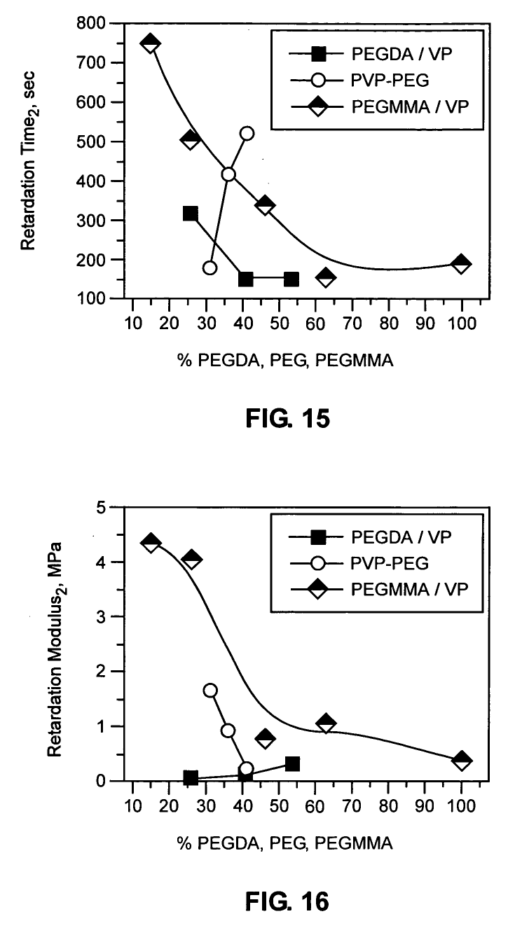

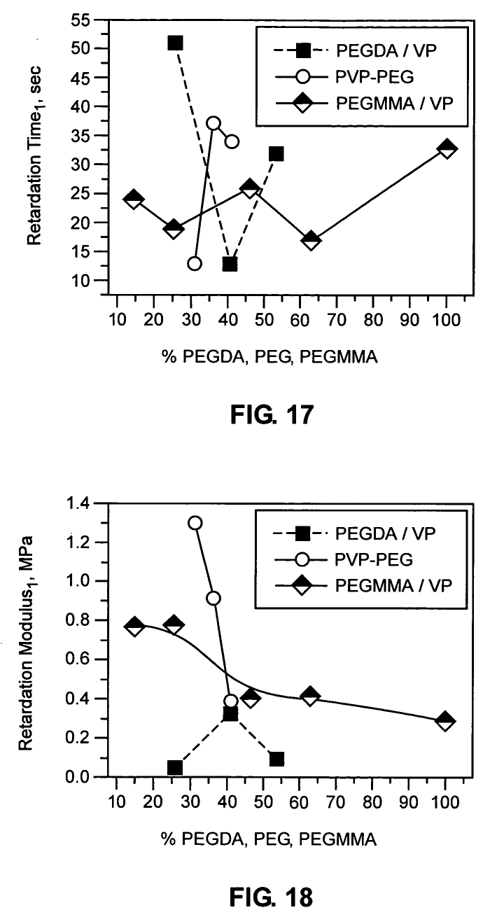

In general, the pattern shown by the Kelvin-Voigt retardation time and modulus was typical of both the longer and shorter retardation processes (compare FIGS. 13 and 14 with FIGS. 15-18). As seen from the data in Table 13, replacing H-bonds with covalent bonds resulted in the decrease of average retardation time (Kelvin-Voigt) in the row: PVP-PEG, VP-PEGDA, VP-PEGMMA. The Kelvin-Voigt modulus decreased in the row: PVP-PEG, VP-PEGMMA, VP-PEGDA, indicating the reduction of the resistance to elastic recovery. A shorter retardation time, associated mainly with the elastic response, was nearly the same for all the hydrogels examined, whereas the resistance to the fast elastic recovery was higher for the PVP-PEG H-bonded blend. The systems involving H-bonding (PVP-PEG and VP-PEGMMA) demonstrated longer retardation times than the corresponding covalent bonded replica (VP-PEGDA). This type of elastic recovery is thought to involve the process of viscous flow that requires longer time. The resistance to a slow elastic recovery (G₂) was higher for the non-covalently crosslinked VP-PEGMMA and the non-crosslinked PVP-PEG.

TABLE 14
Comparative contributions of hydrogen and covalent PVP-PEG
bonding to the relaxation properties of the systems containing
36 wt % of PEG

| | G | Time | | Shorter | | Longer |
|---|---|---|---|---|---|---|
| System | MPa | (sec) | G₁ MPa | time (sec) | G₂ MPa | time (sec) |
| PVP-PEG | 0.48 | 153 | 0.9 | 37 | 0.91 | 427 |
| VP-PEGDA | 0.08 | 114 | 0.57 | 22 | 0.09 | 203 |
| VP-PEGMMA | 0.28 | 62 | 0.24 | 23 | 2.3 | 427 |

### Example 10

### Properties of Comb-Like or Crosslinked PEGMMA and PEGDA Polymers with other Hydrophilic Monomers

Examples 7-9 illustrate the approach to hydrophilic pressure-sensitive adhesive and bioadhesive copolymers taking VP as an example of a monomer, which is polymerized with PEGMMA or PEGDA. Monomers of different chemical natures can be employed instead of VP to give the adhesives upon polymerization with PEGMMA or PEGDA, because adhesion is controlled by the balance between cohesion energy and free volume, which is mainly determined by the PEG side-chains and crosslinks, whereas the nature of backbone is less important. The major properties of such copolymers are listed in Table 15. All these copolymers differ from VP-PEGDA and VP-PEGMMA copolymers by lower hygroscopicity, which is important for a range of practical applications.

TABLE 15
Properties of PEGMMA and PEGDA polymers with various hydrophilic monomers

| Sample | Monomer | Properties |
|---|---|---|
| 95 | Other vinyl lactams | The higher VCap content, the less water |
| | Vinyl caprolactam (VCap) | adsorption and the lower the solubility of non- |
| | | crosslinked copolymers (with PEGMMA) in |
| | | water. Copolymers possess the Lower Critical |
| | | Solution Temperature (LCST) ranged from 37° C. |
| | | and higher (depending on the co-monomer |
| | | composition). |
| 96-98 | Vinyl and acrylic esters | The higher the monomers content, the less water |
| | Vinyl alcohol (VA), vinyl | absorption and the lower the solubility of non- |
| | acetate (VAc), hydroxyethyl | crosslinked copolymers (with PEGMMA) in |
| | methacrylate (HEMA) | water. Copolymers possess the Lower Critical |
| | | Solution Temperature (LCST) ranged from 37° C. |
| | | and higher (depending on the co-monomer |
| | | composition). |
| 99-101 | Vinyl ethers | Polyvinyl ethers possess a good adhesion to skin |
| | Methyl ether (VME), ethyl | and high water vapor permeability. Polyvinyl |
| | ether (VEE), isobutyl ether | methyl ether is soluble in water, whereas |
| | (VIBE) | polyvinylisobutyl ether is insoluble. By varying |
| | | the composition of vinyl ether copolymers with |
| | | PEGMMA and PEGDA, the adhesion, solubility |
| | | and hydrophilicity of the adhesives can be |
| | | regulated. |
| 102-103 | Acrylamides | The higher the monomers content, the less water |
| | Acryl Amide (Aam) | absorption and the lower the solubility of non- |
| | N-isopropyl acrylamide | crosslinked copolymers (with PEGMMA) in |
| | (NIPAM) | water. Copolymers possess the Lower Critical |
| | | Solution Temperature (LCST) ranged from 37° C. |
| | | and higher (depending on the co-monomer |
| | | composition). |
| 104-105 | Acrylic acid (AA), methacrylic | pH-sensitive water swelling, water adsorption and |
| | acid (MA) | dissolution properties: The higher the pH, the |
| | | greater the swell ratio (for PEGDA copolymers) |
| | | and dissolution in water (for non-crosslinked |
| | | PEGMMA copolymers). |
| 106-107 | Vinyl amine (VA), | pH-sensitive water swelling, water sorption and |
| | dimethylamino | dissolution properties: The higher the pH, the |
| | ethylmethacrylate (DMAEMA) | lower the swell ratio (for PEGDA copolymers) |
| | | and the less the dissolution in water (for non- |
| | | crosslinked PEGMMA copolymers). |
| 108-110 | Alkyl acrylates | The copolymers combine the properties of |
| | 2,6-ethyl hexyl acrylate, | hydrophobic and hydrophilic adhesives, |
| | isooctyl acrylate, butyl acrylate | maintaining a high level of adhesion throughout a |
| | | wide range of hydration, both towards the dry and |
| | | moistened substrates. |

### Example 11

### Topical Dermal Patches (e.g., Anti-Acne and Anti-Fungal) and Transdermal Delivery Systems

Properties of hydrogels designed for application to dry skin include a high initial tack, and adhesion maintained at sufficiently high level to keep the patch in place during the period of drug delivery. The following adhesive hydrogel compositions are most appropriate for applications to dry skin:

1) The UV crosslinked hydrogels of Samples 2-45, preferably those that provide a comparatively high swell ratio (30 g/g and higher), low sol fraction (10-40%) and high initial tack to dry skin. The compositions of Samples 2-4, 7, 16, 18-20, 29, 35 and 37 are especially preferred.

2) The crosslinked PEGDA copolymers with hydrophilic monomers exemplified by Samples 39-58, and preferably, Samples 50, 51, 54, 56, 57 and 58.

3) The comb-like PEGMMA copolymers with hydrophilic monomers exemplified by Samples 84-88. The composition of Samples 87 and 88 are most suitable.

### Example 12

### Wound Dressings

The polymer matrices of wound dressings provide a great capacity to absorb exudate, control a moisture vapor transmission rate and be tacky towards dry skin, thereby decreasing the adhesion towards hydrated areas of damaged skin in order to provide dressing removal without pain. To allow the easy inspection of the wound recovery process, the dressing can be clear. The following adhesive hydrogel compositions are well suited for wound dressings:

1) The UV crosslinked hydrogels present in Samples 2-45, preferably those that provide a comparatively high swell ratio (30 g/g and higher), low sol fraction (10 -40%) and high initial tack to dry skin. The compositions of Samples 2-4, 7, 16, 18-20, 29, 35 and 37 are especially preferred.

2) The crosslinked PEGDA copolymers with hydrophilic monomers exemplified by Samples 39-58, and preferably, Samples 50, 51, 54, 56, 57 and 58.

3) The comb-like PEGMMA copolymers with hydrophilic monomers exemplified by Samples 84-88. The compositions of Samples 87 and 88 are most suitable.

4) The blends made by non-covalent crosslinking of polymer chains in Samples 111-132. If initial tack is desirable, the PVP-based compositions may contain a small amount of the ladder-like crosslinker (2-8%) or a large amount of the carcass-like crosslinker (e.g., Samples 118 and 119). For initially nontacky compositions, the blends overloaded with Eudragit polymers are preferred, as in Samples 120-126.

The hydrogel platforms in wound dressings may contain an appropriate amount of an antibacterial agent. For this purpose, silver salts such as silver nitrate, silver sulfate, silver phosphate, silver sulfadiazine or silver sodium hydrogen zirconium phosphate/zinc oxide may be used.

### Example 13

### Products Designed for Intraoral Application

The products designed for intraoral application are preferentially nontacky in dry state, but develop optimal adhesion to moistened biological substrates such as buccal, mucosal membranes or teeth surfaces. To provide a long-lasting effect at the application site, the intraoral products are preferably either insoluble (tooth whitening strip) or dissolve slowly in saliva (breath freshener and sore throat films or lozenges). The following adhesive hydrogel compositions are suitable for use as matrices designed for intraoral application:

1) The UV crosslinked hydrogels of Samples 2-45, preferably those that provide a comparatively low swell ratio (5-25 g/g) and sole fraction (10-40%). Compositions of Samples 5, 6, 13, 14, 17, 23, 24, 31 and 32 are preferred.

2) The crosslinked PEGDA copolymers with hydrophilic monomers exemplified by Samples 46-58, and preferably, Samples 48, 55 and 58.

3) The comb-like PEGMMA copolymers with hydrophilic monomers exemplified by Samples 84-86. The composition of Sample 88 is most suitable as a strip, whereas the other compositions are suitable for slowly dissolving films.

Tooth whitening strips using the hydrogel compositions of the invention may contain about 3-7% hydrogen peroxide as an active agent. Breath fresheners and sore throat slowly dissolving films or lozenges may be loaded with aromatic oils as active agents. Sore throat, mouth ulcer/canker sore and anti-gingivitis products may contain a low dose of an analgesic and/or anesthetic (e.g., benzocaine, lidocaine, tetracaine), as well as an appropriate antiseptic.

### Example 14

The mechanism of binding between amphiphilic surfactants (e.g., NSAIDs) and hydrophilic long-chain polymers (e.g., PVP) can be demonstrated by means of FTIR spectral analysis. In FIG. 20, the FTIR spectrum of a PVP/ibuprofen blend is compared with the FTIR spectrum of pure ibuprofen in the region of vibrations of C=0 bonds comprising ibuprofen carboxylic groups. It is seen from FIG. 20 that the band corresponding to the ibuprofen carboxylic group is split into five smaller bands and shifted towards higher vibration frequencies in the PVP/ibuprofen blend, thus indicating a strong interaction between the ibuprofen carboxylic groups and the PVP macromolecule.

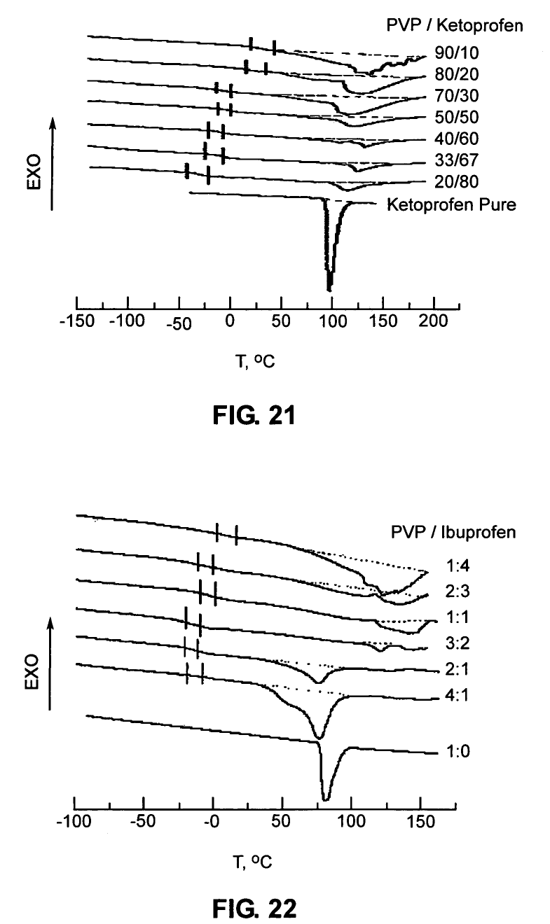

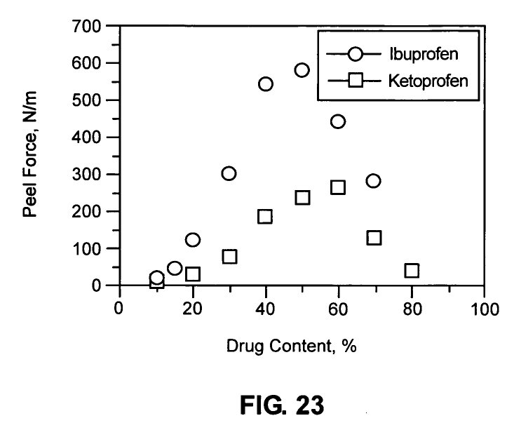

Favorable interactions between the polymer and the amphiphilic compound usually yields a miscible blends in a wide range of compositions. The miscibility of such systems can be confirmed by DSC analysis. FIGS. 21 and 22 are examples of DSC scans for PVP/ketoprofen and PVP/ibuprofen blends in a wide range of polymer-drug compositions. Both ketoprofen and ibuprofen are crystalline drugs with melting points 100° C. and 70° C., respectively, which are reflected in the DSC scans by sharp melting endotherms. However, in the PVP/drug blends the melting endotherms disappeared in the wide range of compositions. For example, the DSC scans of PVP/ibuprofen blends containing up to 60% of ibuprofen and DSC scans of PVP/ketoprofen blends containing up to 80% of ketoprofen were characterized by a single glass transition temperature indicating full miscibility of the polymer/drug systems within the specified composition ranges. It should be noted that all initial compounds, both the polymer and the amphiphilic drugs, were solids either in a glassy state (polymer) or in a crystalline state (drugs) with a glass transition temperature or melting point above ambient temperature. However, the polymer-drug blends were characterized by low glass transition temperatures, as is observed for elastomers. Wide miscibility and low glass transition temperatures of the polymer-amphiphilic drug blends provides materials having a high drug loading, as well as having pressure sensitive properties. The pressure sensitive adhesive properties of the polymer-amphiphilic drug blends were evaluated by the 180° peel test. Examples of peel test results for PVP/ibuprofen and PVP/ketoprofen blends to a polyethylene terephthalate (PET) substrate are shown in FIG. 23. The peel test results demonstrated that compositions with different adhesive properties were obtained.

### Example 15

### Preparation of Elastic Adhesive Films

The composition of Samples 146 and 147 were prepared by casting an ethanol solution containing 30% of solids. After casting the ethanol solution onto a 1.5 mil thick polyethylene film, the films were dried for 1 day at ambient conditions, followed by subsequent drying in an oven at 60° C. for 6 hours.

TABLE 16

| Composition | Sample 146 (wt %) | Sample 147 (wt %) |
|---|---|---|
| PVP (Kollidon K90) | 60 | 55 |
| Ibuprofen | 26 | — |
| Ketoprofen | — | 30 |
| PEG 400 | 14 | 15 |

The adhesive film for Sample 146 was 4 mils in thickness and achieved an adhesive force of 230N/m after it was laminated to a PET substrate. The adhesive film for Sample 147 was 4 mils in thickness and achieved an adhesive force of 190 N/m after lamination.

The compositions of Samples 148 and 149 were designed for use as fast dissolving drug delivery systems. These samples can be applied within the oral mucosal cavity in a form of a rapidly dissolving film for transmucosal drug delivery. When applied to oral mucosal cavity site the film sticks to the application site instantaneously and rapidly dissolves (over 10-60 seconds) within the oral cavity. When loaded with an active agent, the films are suitable for releasing drug that can be absorbed transmucosally.

Samples 148 and 149 were prepared by casting an ethanol slurry solution containing 40% of solids. After casting the ethanol solution onto a 1.5 mil thick polyethylene film, the films were dried for 1 day at ambient conditions followed by subsequent drying in an oven at 50° C. for 4 hours.

TABLE 17

| Composition | Sample 148 (wt %) | Sample 149 (wt %) |
|---|---|---|
| PVP (Kollidon K90) | 32.5 | |
| PVP (Kollidon K17) | — | 9 |
| Kollicoat ® IR (polyvinyl | — | 21 |
| alcohol-polyethylene | | |
| glycol; BASF Corporation) | | |
| PEG 540 | 10 | — |
| PEG 400 | — | 13 |
| Mannitol | 42.5 | 45 |
| Ketoprofen | 15 | 12 |

The adhesive film for Sample 148 was 4 mils in thickness, and was die cut with a circular punch 1 inch in diameter. In vivo dissolution time was tested on 6 volunteers. The average in vivo dissolution time of the Sample 148 was 35±7 sec.

The adhesive film for Sample 149 was 8 mils in thickness, and was die cut with a circular punch 1 inch in diameter. In vivo dissolution time was tested on 6 volunteers. The average in vivo dissolution time of the obtained samples was 40±6 sec.

The practice of the present invention will employ, unless otherwise indicated, conventional techniques of polymer chemistry, adhesive manufacture, and hydrogel preparation, which are within the skill of the art. Such techniques are fully explained in the literature.

It is to be understood that while the invention has been described in conjunction with the preferred specific embodiments thereof, the foregoing description, as well as the examples that are presented above and as follow, are intended to illustrate and not limit the scope of the invention. Other aspects, advantages and modifications will be apparent to those skilled in the art to which the invention pertains. All patents, patent applications, journal articles, and other references cited herein are incorporated by reference in their entireties.

We claim:

1. A water-insoluble, crosslinked hydrophilic adhesive polymer prepared by polymerization of a composition consisting essentially of a hydrophilic monomer and a dual-function monomer that both (a) undergoes polymerization with the hydrophilic monomer and (b) provides covalent crosslinks in the polymer.

2. The polymer of claim 1, wherein the hydrophilic monomer is selected from N-vinyl amides, N-vinyl lactams, vinyl alcohols, vinyl amines, acrylic acids, methacrylic acids, hydroxyalkyl acrylates, hydroxyalkyl methacrylate, vinyl ethers, alkyl acrylates, alkyl methacrylates, acrylamides, N-alkylacrylamides, N,N-dialkylacrylamides, N-hydroxyalkylacrylamides, maleic acids, esters of maleic acids, maleic acid-co-methylvinyl ethers, esters of maleic acid-co-methylvinyl ethers, sulfoalkylacrylates, sulfoalkylmethacrylates, hydroxystyrene, allyl alcohols, crotonic acid, and itaconic acid.

3. The polymer of claim 2, wherein the hydrophilic monomer is an N-vinyl lactam.

4. The polymer of claim 1, wherein the hydrophilic monomer has the formula: 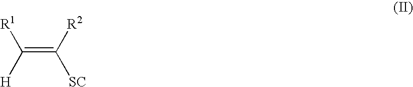
where: R¹ and R² are independently selected from hydrogen, lower alkyl, and lower hydroxyalkyl; and SC is a hydrophilic sidechain.

5. The polymer of claim 1, wherein the dual-function monomer is a poly(alkylene oxide) molecule containing about 4-40 alkylene oxide units and substituted at each terminus with a reactive group capable of undergoing vinyl polymerization.

6. The polymer of claim 5, wherein the alkylene oxide units are selected from ethylene oxide, propylene oxide, and combinations thereof.

7. The polymer of claim 6 wherein the dual-function monomer is polyethylene glycol diacrylate.

8. The polymer of claim 1, wherein the dual-function monomer is prepared by reacting a hydrophilic crosslinking agent having the formula:
R*-Sp-R*
with an olefinic compound having the formula: 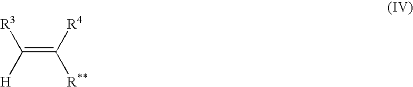
where: R³ and R⁴ are independently selected from hydrogen, lower alkyl, and lower hydroxyalkyl; R* and R** are reactive moieties capable of undergoing a nucleophilic addition reaction to form a covalent bond; and Sp is a hydrophilic spacer moiety.

9. The polymer of claim 8, wherein the dual-function monomer has the formula: 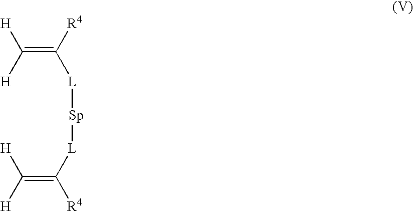
where L is a linkage formed by the reaction of R* and R**.

10. The polymer of claim 9, wherein R* is a nucleophilic group and R** is an electrophilic group.

11. The polymer of claim 10, wherein R* is selected from —NH₂, —NHR⁵, —N(R⁶)₂, —SH, —OH, —COOH, —PH₂, —PHR⁷, —P(R⁸)₂, -(L³)ₚ MgHal, and -L⁴Li, where R⁵, R⁶, R⁷, and R⁸ are C₁-C₆ hydrocarbyl, L³ and L⁴ are C₁-C₆ hydrocarbylene, p is zero or 1, and Hal is halo.

12. A liquid film-forming composition consisting essentially of a water-insoluble film-forming polymer and the polymer of claim 1.

13. The composition of claim 12, wherein the water-insoluble film-forming polymer is selected from acrylate-based polymers and copolymers, polyvinylacetate, ethylene-vinylacetate copolymers, alkyl cellulose, nitrocellulose, and polysilicones.

14. A water-insoluble hydrogel composition for topical or intraoral application consisting essentially of the polymer of claim 1.

15. The composition of claim 14, further comprising a hydrophobic polymer.

16. The composition of claim 14, further comprising an active agent.

17. The composition of claim 16, wherein the active agent is selected from bacteriostatic and bactericidal agents, antibiotic agents, pain-relieving agents, cytokines, topical vasodilators, proteolytic enzymes, and tissue-healing enhancing agents; and wherein the hydrogel is suitable for use as a wound dressing.

18. The composition of claim 14, which forms at least a portion of the body-contacting surface of a wound dressing, wherein the wound dressing comprises a laminated composite of a body facing layer having a body-contacting surface, and an outwardly facing backing layer.

19. The composition of claim 14, which forms at least one of the reservoir or the affixing means of a transdermal drug delivery device, wherein the transdermal drug delivery device comprises a drug reservoir, an outwardly facing backing layer, and a means for affixing the device to a body surface.

20. A water-insoluble, hydrophilic adhesive polymer having the formula: 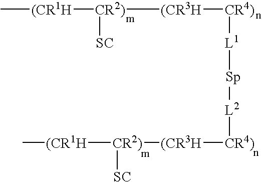
where:
m is an integer in the range of 0 to 100,000;
n is an integer in the range of 1 to 100,000;
R¹, R², R³, and R⁴ are independently selected from hydrogen, lower alkyl, and lower hydroxyalkyl;
SC is a hydrophilic side chain;
L¹ and L² are linkages that are independently selected from —(CO)—O—, —O—(CO)—, —O—(CO)—O—, —(CO)—NH—, —NH—(CO)—, —O—(CO)—NH—, —NH—(CO)—O—, —S—S—, —S—(CO)—, and —(CO)—S—; and
Sp is a poly(alkylene oxide) linker containing about 4-40 alkylene oxide units.

21. The polymer of claim 20, where:
R¹, R², and R³ are hydrogen;
R⁴ is selected from hydrogen, methyl, and hydroxymethyl;
SC is a poly(alkylene oxide) side chain containing about 4-20 alkylene oxide units; and
L¹ and L² are —(CO)—O—.

22. The polymer of claim 20, where m is an integer in the range of 1 to 100,000, and the polymer is prepared by polymerization of a composition consisting essentially of a hydrophilic monomer and a dual-function monomer that both (a) undergoes polymerization with the hydrophilic monomer and (b) provides covalent crosslinks in the polymer.

23. The polymer of claim 20, where m is 0 and the polymer is prepared by homopolymerization of a composition consisting essentially of dual-function monomers selected from poly(ethylene glycol diacrylate) and poly(ethylene glycol) dimethacrylate, in the absence of any hydrophilic monomers.

24. A water-soluble, hydrophilic adhesive polymer that is free of covalent crosslinks, wherein the polymer is prepared by polymerization of a composition consisting essentially of a hydrophilic monomer and an acrylic acid monomer esterified with a hydrophilic side chain.

25. The polymer of claim 24, wherein the hydrophilic monomer is selected from N-vinyl amides, N-vinyl lactams, vinyl alcohols, vinyl amines, acrylic acids, methacrylic acids, hydroxyalkyl acrylates, hydroxyalkyl methacrylate, vinyl ethers, alkyl acrylates, alkyl methacrylates, acrylamides, N-alkylacrylamides, N,N-dialkylacrylamides, N-hydroxyalkylacrylamides, maleic acids, esters of maleic acids, maleic acid-co-methylvinyl ethers, esters of maleic acid-co-methylvinyl ethers, sulfoalkylacrylates, sulfoalkylmethacrylates, hydroxystyrene, allyl alcohols, crotonic acid, and itaconic acid.

26. The polymer of claim 25, wherein the hydrophilic monomer is an N-vinyl lactam.

27. The polymer of claim 24, wherein the acrylic acid monomer is esterified with a poly(alkylene oxide) chain containing about 4-40 alkylene oxide units.

28. The polymer of claim 27, wherein the acrylic acid monomer is selected from polyethylene glycol monoacrylate and polyethylene glycol monomethacrylate.

29. A liquid film-forming composition consisting essentially of a water-insoluble film-forming polymer and the polymer of claim 24.

30. The composition of claim 29, wherein the water-insoluble film-forming polymer is selected from acrylate-based polymers and copolymers, polyvinylacetate, ethylene-vinylacetate copolymers, alkyl cellulose, nitrocellulose, and polysilicones.

31. A water-insoluble hydrogel composition for topical or intraoral application consisting essentially of a water-insoluble film-forming polymer and the polymer of claim 24.

32. The composition of claim 31, wherein the water-insoluble film-forming polymer is selected from acrylate-based polymers and copolymers, polyvinylacetate, ethylene-vinylacetate copolymers, alkyl cellulose, nitrocellulose, and polysilicones.

33. The composition of claim 31, further comprising a hydrophobic polymer.

34. The composition of claim 31, further comprising an active agent.

35. The composition of claim 34, wherein the active agent is selected from bacteriostatic and bactericidal agents, antibiotic agents, pain-relieving agents, cytokines, topical vasodilators, proteolytic enzymes, and tissue-healing enhancing agents; and wherein the hydrogel is suitable for use as a wound dressing.

36. The composition of claim 31, which forms at least a portion of the body-contacting surface of a wound dressing, wherein the wound dressing comprises a laminated composite of a body facing layer having a body-contacting surface, and an outwardly facing backing layer.

37. The composition of claim 31, which forms at least one of the reservoir or the affixing means of a transdermal drug delivery device, wherein the transdermal drug delivery device comprises a drug reservoir, an outwardly facing backing layer, and a means for affixing the device to a body surface.

38. A water-soluble, hydrophilic adhesive polymer that is free of covalent crosslinks, having the formula: 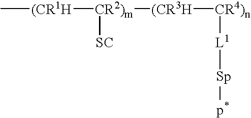
where:
m is an integer in the range of 0 to 100,000;
n is an integer in the range of 1 to 100,000;
R¹, R², R³, and R⁴ are independently selected from hydrogen, lower alkyl, and lower hydroxyalkyl;
SC is a hydrophilic side chain;
L¹ is selected from —(CO)—O—, —O—(CO)—, —O—(CO)—O—, —(CO)—NH—, —NH—(CO)—, —O—(CO)—NH—, —NH—(CO)—O—, —S—S—, —S—(CO)—, and —(CO)—S—;
Sp is a poly(alkylene oxide) linker containing about 4-40 alkylene oxide units; and
P* is a polar moiety.

39. The polymer of claim 38, where:
R¹, R², and R³ are hydrogen;
R⁴ is selected from hydrogen, methyl, and hydroxymethyl;
SC is a poly(alkylene oxide) side chain containing about 4-20 alkylene oxide units;
L¹ is —(CO)—O—; and
P* is a hydroxyl group.

40. The polymer of claim 38, where m is an integer in the range of 1 to 100,000, and the polymer is prepared by polymerization of a composition consisting essentially of a hydrophilic monomer and an acrylic acid monomer esterified with a hydrophilic side chain.

41. The polymer of claim 38, where m is 0 and the polymer is prepared by homopolymerization of a composition consisting essentially of dual-function monomers selected from poly(ethylene glycol monoacrylate) and poly(ethylene glycol) monomethacrylates, in the absence of any hydrophilic monomers.

42. A water-insoluble adhesive polymer, wherein the polymer is prepared by polymerization of a composition consisting essentially of: (a) a hydrophilic monomer, an acrylic acid monomer esterified with a hydrophilic side chain, and an acrylate monomer; (b) a hydrophilic monomer, an acrylic acid monomer esterified with a hydrophilic side chain, and a dual-function monomer; or (c) an acrylate monomer, an acrylic acid monomer esterified with a hydrophilic side chain, and a dual-function monomer.

43. The polymer of claim 42, wherein the hydrophilic monomer is selected from N-vinyl amides, N-vinyl lactams, vinyl alcohols, vinyl amines, acrylic acids, methacrylic acids, hydroxyalkyl acrylates, hydroxyalkyl methacrylate, vinyl ethers, alkyl acrylates, alkyl methacrylates, acrylamides, N-alkylacrylamides, N,N-dialkylacrylamides, N-hydroxyalkylacrylamides, maleic acids, esters of maleic acids, maleic acid-co-methylvinyl ethers, esters of maleic acid-co-methylvinyl ethers, sulfoalkylacrylates, sulfoalkylmethacrylates, hydroxystyrene, allyl alcohols, crotonic acid, and itaconic acid.

44. The polymer of claim 43, wherein the hydrophilic monomer is an N-vinyl lactam.

45. The polymer of claim 42, wherein the acrylate monomer is selected from acrylates, methacrylates, lower alkyl acrylates, 2-substituted lower alkyl acrylates, lower alkyl methacrylates, hydroxyalkyl acrylates, and hydroxyalkyl methacrylates.

46. The polymer of claim 42, wherein the acrylic acid monomer is esterified with a poly(alkylene oxide) chain containing about 4-40 alkylene oxide units.

47. The polymer of claim 46, wherein the acrylic acid monomer is selected from polyethylene glycol monoacrylate and polyethylene glycol monomethacrylate.

48. The polymer of claim 42, wherein the dual-function monomer is polyethylene glycol diacrylate.

49. A water-insoluble hydrogel composition for topical or intraoral application consisting essentially of the polymer of claim 42.

50. The composition of claim 49, further comprising a hydrophobic polymer.

51. The composition of claim 49, further comprising an active agent.

52. The composition of claim 51, wherein the active agent is selected from bacteriostatic and bactericidal agents, antibiotic agents, pain-relieving agents, cytokines, topical vasodilators, proteolytic enzymes, and tissue-healing enhancing agents; and wherein the hydrogel is suitable for use as a wound dressing.

53. The composition of claim 49, which forms at least a portion of the body-contacting surface of a wound dressing, wherein the wound dressing comprises a laminated composite of a body facing layer having a body-contacting surface, and an outwardly facing backing layer.

54. The composition of claim 49, which forms at least one of the reservoir or the affixing means of a transdermal drug delivery device, wherein the transdermal drug delivery device comprises a drug reservoir, an outwardly facing backing layer, and a means for affixing the device to a body surface.

55. A water-insoluble, hydrophilic adhesive polymer blend that is free of covalent crosslinks, consisting essentially of at least one hydrophilic long-chain polymer and at least one amphiphilic crosslinker.

56. The polymer blend of claim 55, wherein the hydrophilic long-chain polymer is selected from poly(N-vinyl amides), polyethylene oxide-co-vinyl alcohols, poly(acrylamides), poly (N-alkylacrylamides), poly(N,N-dialkylacrylamides), poly(N-hydroxyalkylacrylamides), poly(maleic acids), poly maleic acid-co-methylvinyl ethers, poly(sulfoalkylacrylates), poly(sulfoalkylmethacrylates), polyacrylic acids, polymethacrylic acids, poly(N-vinyl lactams), polyvinyl alcohols, poly(hydroxyalkyl acrylates), poly(hydroxyalkyl methacrylates), and salts and copolymers thereof; alginic acid, chitosan, hydroxypropylcellulose, hydroxyethyl cellulose, methylcellulose, hydroxypropyl methylcellulose, and carboxymethylcellulose, and salts thereof.

57. The polymer blend of claim 56, wherein the hydrophilic long-chain polymer is a poly(N-vinyl lactam).

58. The polymer blend of claim 55, wherein the amphiphilic crosslinker is selected from fatty acids, ionic and nonionic surfactants, and non-steroidal anti-inflammatory drugs.

59. The polymer blend of claim 55, which is in the form of an elastic adhesive film.

60. A liquid film-forming composition consisting essentially of a water-insoluble film-forming polymer and the polymer blend of claim 55.

61. The composition of claim 60, wherein the water-insoluble film-forming polymer is selected from acrylate-based polymers and copolymers, polyvinylacetate, ethylene-vinylacetate copolymers, alkyl cellulose, nitrocellulose, and polysilicones.

62. A water-insoluble hydrogel composition for topical or intraoral application consisting essentially of the polymer blend of claim 55.

63. The composition of claim 62, further comprising a hydrophobic polymer.

64. The composition of claim 62, further comprising an active agent.

65. The composition of claim 64, wherein the active agent is selected from bacteriostatic and bactericidal agents, antibiotic agents, pain-relieving agents, cytokines, topical vasodilators, proteolytic enzymes, and tissue-healing enhancing agents; and wherein the hydrogel is suitable for use as a wound dressing.

66. The composition of claim 62, which forms at least a portion of the body-contacting surface of a wound dressing, wherein the wound dressing comprises a laminated composite of a body facing layer having a body-contacting surface, and an outwardly facing backing layer.

67. The composition of claim 62, which forms at least one of the reservoir or the affixing means of a transdermal drug delivery device, wherein the transdermal drug delivery device comprises a drug reservoir, an outwardly facing backing layer, and a means for affixing the device to a body surface.

68. A water-insoluble, hydrophilic covalently crosslinked adhesive polymer blend prepared by polymerization of a hydrophilic acrylic monomer in the presence of a hydrophilic water-soluble high molecular weight polymer or copolymer, a dual function crosslinker or multi-function crosslinker, and an optional plasticizer.

69. The polymer blend of claim 68, wherein the hydrophilic acrylic monomer is selected from vinyl amines, acrylic acids, methacrylic acids, hydroxyalkyl acrylates, hydroxyalkyl methacrylate, vinyl ethers, alkyl acrylates, alkyl methacrylates, acrylamides, N-alkylacrylamides, N,N-dialkylacrylamides, N-hydroxyalkylacrylamides, maleic acids, esters of maleic acids, maleic acid-co-methylvinyl ethers, esters of maleic acid-co-methylvinyl ethers, sulfoalkylacrylates, sulfoalkylmethacrylates, hydroxystyrene, allyl alcohols, crotonic acid, and itaconic acid.

70. The polymer blend of claim 68, wherein the hydrophilic water-soluble high molecular weight polymer or copolymer is selected from poly(N-vinyl amides), poly(N-vinyl lactams), polyvinyl alcohols, poly vinyl amines, polyacrylic acids, polymethacrylic acids, polyhydroxyalkyl acrylates, polyhydroxyalkyl methacrylates, polyacrylamides, poly(N-alkylacrylamides), poly(N,N-dialkylacrylamides), poly(N-hydroxyalkylacrylamides), polymaleic acids, esters of polymaleic acids, polymaleic acid-co-methylvinyl ethers, esters of polymaleic acid-co-methylvinyl ethers, polysulfoalkylacrylates, polysulfoalkylmethacrylates, and combinations thereof.

71. The polymer blend of claim 70, wherein the hydrophilic water-soluble high molecular weight polymer or copolymer is a poly(N-vinyl lactam).

72. The polymer blend of claim 68, wherein the dual function crosslinker or multi-function crosslinker is selected from polyethyleneglycol diacrylate, dipentaerythritol pentaacrylate, trimethylolpropane triacrylate, and ethoxylated trimethylolpropane triacrylate.

73. The polymer blend of claim 68, wherein the plasticizer is included, and is selected from polyethyleneglycol, glycerol, 1,2-propylenglycol, 2-methyl-1,3-propanediol, and water.

74. A water-insoluble hydrogel composition for topical or intraoral application consisting essentially of the polymer blend of claim 68.

75. The composition of claim 74, further comprising a hydrophobic polymer.

76. The composition of claim 74, further comprising an active agent.

77. The composition of claim 76, wherein the active agent is selected from bacteriostatic and bactericidal agents, antibiotic agents, pain-relieving agents, cytokines, topical vasodilators, proteolytic enzymes, and tissue-healing enhancing agents; and wherein the hydrogel is suitable for use as a wound dressing.

78. The composition of claim 74, which forms at least a portion of the body-contacting surface of a wound dressing, wherein the wound dressing comprises a laminated composite of a body facing layer having a body-contacting surface, and an outwardly facing backing layer.

79. The composition of claim 74, which forms at least one of the reservoir or the affixing means of a transdermal drug delivery device, wherein the transdermal drug delivery device comprises a drug reservoir, an outwardly facing backing layer, and a means for affixing the device to a body surface.

80. A water-insoluble, hydrophilic covalently crosslinked adhesive polymer blend prepared by polymerization of a hydrophilic water-soluble high molecular weight polymer or copolymer, a dual function crosslinker or multi-function crosslinker, and an optional plasticizer.

81. The polymer blend of claim 80, wherein the hydrophilic water-soluble high molecular weight polymer or copolymer is selected from poly(N-vinyl amides), poly(N-vinyl lactams), polyvinyl alcohols, poly vinyl amines, polyacrylic acids, polymethacrylic acids, polyhydroxyalkyl acrylates, polyhydroxyalkyl methacrylates, polyacrylamides, poly(N-alkylacrylamides), poly(N,N-dialkylacrylamides), poly(N-hydroxyalkylacrylamides), polymaleic acids, esters of polymaleic acids, polymaleic acid-co-methylvinyl ethers, esters of polymaleic acid-co-methylvinyl ethers, polysulfoalkylacrylates, polysulfoalkylmethacrylates, and combinations thereof.

82. The polymer blend of claim 81, wherein the hydrophilic water-soluble high molecular weight polymer or copolymer is a poly(N-vinyl lactam).

83. The polymer blend of claim 80, wherein the dual function crosslinker or multi-function crosslinker is selected from polyethyleneglycol diacrylate, dipentaerythritol pentaacrylate, trimethylolpropane triacrylate, and ethoxylated trimethylolpropane triacrylate.

84. The polymer blend of claim 80, wherein the plasticizer is included, and is selected from polyethyleneglycol, glycerol, 1,2-propylenglycol, 2-methyl-1,3-propanediol, and water.

85. A water-insoluble hydrogel composition for topical or intraoral application consisting essentially of the polymer blend of claim 80.

86. The composition of claim 85, further comprising a hydrophobic polymer.

87. The composition of claim 85, further comprising an active agent.

88. The composition of claim 87, wherein the active agent is selected from bacteriostatic and bactericidal agents, antibiotic agents, pain-relieving agents, cytokines, topical vasodilators, proteolytic enzymes, and tissue-healing enhancing agents; and wherein the hydrogel is suitable for use as a wound dressing.

89. The composition of claim 85, which forms at least a portion of the body-contacting surface of a wound dressing, wherein the wound dressing comprises a laminated composite of a body facing layer having a body-contacting surface, and an outwardly facing backing layer.

90. The composition of claim 85, which forms at least one of the reservoir or the affixing means of a transdermal drug delivery device, wherein the transdermal drug delivery device comprises a drug reservoir, an outwardly facing backing layer, and a means for affixing the device to a body surface.
